(19) United States
(12) Patent Application Publication
(10) Pub. No.: US 2015/0094865 A1
(43) Pub. Date: Apr. 2, 2015

(54) HEATING, VENTILATION, AND/OR AIR CONDITIONING CONTROLLER

(71) Applicants: Yonghyun CHOI, Changwon-si (KR); Hongku LEE, Changwon-si (KR); Byungku HWANG, Changwon-si (KR)

(72) Inventors: Yonghyun CHOI, Changwon-si (KR); Hongku LEE, Changwon-si (KR); Byungku HWANG, Changwon-si (KR)

(21) Appl. No.: 14/224,490

(22) Filed: Mar. 25, 2014

(30) Foreign Application Priority Data
Oct. 1, 2013 (KR) 10-2013-0117425

(51) Int. Cl. G05D 23/19; G06F 3/0488

(52) U.S. Cl. CPC G05D 23/1917; G06F 3/0488
USPC 700/278

(57) ABSTRACT

A heating, ventilation, or air conditioning (HVAC) controller for controlling one or more components of the HVAC system or monitoring a state thereof is provided. The HVAC controller may include a touch screen display configured to receive a parameter setting command input by a user's touch, and a controller connected with the touch screen display to display a screen on the touch screen display. The controller may display a first image having one or more parameters to be monitored in a monitoring region on the screen and display a second image having one or more parameters to be set in a main input region on the screen, and the controller may display a parameter selected on the touch screen display or delete the parameter by a user's selection on the touch screen display.

### CROSS-REFERENCE TO RELATED APPLICATION(S)

The present application claims priority under 35 U.S.C. 119 and 35 U.S.C. 365 to Korean Patent Application No. 10-2013-0117425, filed in Korea on Oct. 1, 2013, which is hereby incorporated by reference in its entirety.

### BACKGROUND

1. Field

A heating, ventilation and/or air conditioning (HVAC) (hereinafter, referred to as “HVAC”) system is used for convenience of interior space in a building or other sites. A lot of HVAC controllers are used to control one or more components of the HVAC system. An HVAC controller is disclosed herein.

2. Background

HVAC controllers are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a schematic diagram of an HVAC controller according to embodiments;

FIG. 2 is a block diagram of the HVAC controller according to embodiments;

FIG. 3 is a diagram schematically illustrating a touch screen display according to embodiments;

FIGS. 4 and 5 illustrate examples of a home screen which may be displayed in or on the HVAC controller according to embodiments;

FIGS. 6 to 12 illustrate screens for setting a parameter displayed on a touch screen display of the HVAC controller according to embodiments;

FIGS. 13 to 19 illustrate examples of the home screen in which some items are hidden on the HVAC controller according to embodiments;

FIG. 20 illustrates a screen displayed when a mode button is selected on a screen of FIG. 4;

FIG. 21 illustrates a screen displayed when a main button is selected on the screen of FIG. 4;

FIG. 22 illustrates a screen displayed when a wind button is selected on the screen of FIG. 21;

FIG. 23 illustrates a screen displayed when a fan speed button is selected in FIG. 22;

FIG. 24 illustrates a screen displayed when a wind direction button is selected in FIG. 22;

FIG. 25 illustrates a screen displayed when a vertical vane angle button is selected in FIG. 22;

FIG. 26 illustrates a screen displayed when a horizontal vane angle button is selected in FIG. 22;

FIG. 27 illustrates a screen displayed when a program button is selected on the home screen of FIG. 4;

FIG. 28 illustrates a screen displayed when a temporary button is selected on the screen of FIG. 27;

FIG. 29 illustrates a screen displayed when an override button is selected on the screen of FIG. 28;

FIGS. 30 to 41 illustrate examples of screens for monitoring an energy usage amount;

FIG. 42 illustrates a screen displayed when a set-up button is selected in FIG. 30 or 32;

FIG. 43 illustrates a screen displayed when an energy saving mode button is selected in FIG. 42;

FIG. 44 illustrates a screen displayed when an energy usage limit button is selected in FIG. 42;

FIG. 45 illustrates a screen for setting a weekly limit usage amount for an energy usage limit function;

FIG. 46 illustrates a screen displayed when an operating time limit button is selected in FIG. 42;

FIG. 47 illustrates a screen for setting a weekly limit time for an operating time limit function;

FIG. 48 illustrates a screen displayed when a time limit control button is selected in FIG. 42;

FIG. 49 illustrates a screen displayed when a pop-up alarm button is selected in FIG. 42;

FIG. 50 illustrates a screen on which alarm information pops up in a state where an alarm for the operating time limit function is on;

FIG. 51 illustrates a screen on which the alarm information pops up in a state where an alarm for the energy usage limit function is on;

FIGS. 52 to 89 illustrate screens for creating or changing a schedule;

FIGS. 90 to 92 illustrate examples of a screen for setting a holiday;

FIGS. 93 to 110 illustrate examples of a screen for setting an additional function;

FIG. 111 illustrates a screen displayed when a service button is selected on a screen including the service button;

FIG. 112 illustrates a screen displayed when a service contact button is selected on the screen of FIG. 111;

FIG. 113 illustrates a screen displayed when a model information button is selected on the screen of FIG. 111;

FIG. 114 illustrates a screen displayed when an error history button is selected on the screen of FIG. 111;

FIG. 115 illustrates a screen displayed when error history information is selected on the screen of FIG. 114;

FIGS. 116 and 117 illustrate examples of a screen displayed on a home screen when an error occurs;

FIG. 118 illustrates an example of a screen displayed on the home screen when a compressor error occurs;

FIGS. 119 to 121 illustrate a screen displayed when a sub mode button is selected on a screen including a sub mode button;

FIGS. 122 and 123 illustrate examples of a home screen which may be displayed in the HVAC controller according to embodiments;

FIG. 124 illustrates a screen displayed when a main button is selected on the home screen in FIG. 122 or 123;

FIG. 125 illustrates a screen displayed when a mode button is selected on the screen of FIG. 124; and

FIG. 126 illustrates a screen displayed when a sub operating button is selected on the screen of FIG. 124.

### DETAILED DESCRIPTION

Hereinafter, embodiments will be described with reference to the accompanying drawings. Regarding reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation.

Also, in the description of embodiments, terms such as first, second, A, B, (a), (b) or the like may be used herein when describing components. Each of these terminologies is not used to define an essence, order, or sequence of a corresponding component, but used merely to distinguish the corresponding component from other component(s). It should be noted that if it is described that one component is “connected,” “coupled” or “joined” to another component, the former may be directly “connected,” “coupled,” and “joined” to the latter or “connected”, “coupled”, and “joined” to the latter via another component.

Embodiments disclosed herein may include a controller for various systems including an HVAC system, a security system, a water heating system, a water softener system, a sprinkler system, an illumination system, or similar systems, and hereinafter, an HVAC controller for controlling an HVAC system will be described as one example.

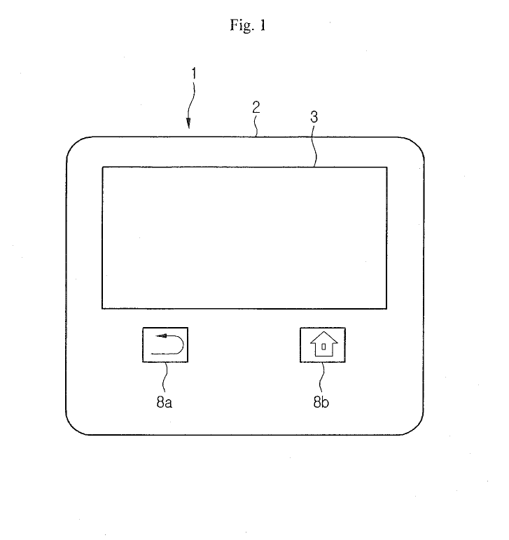

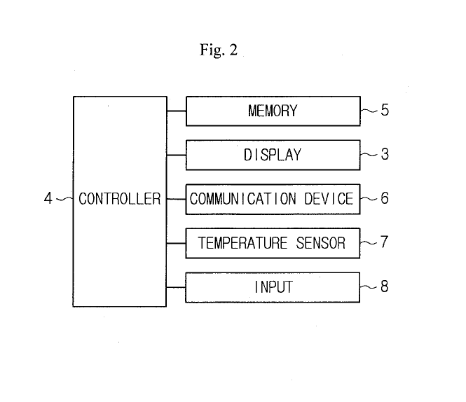

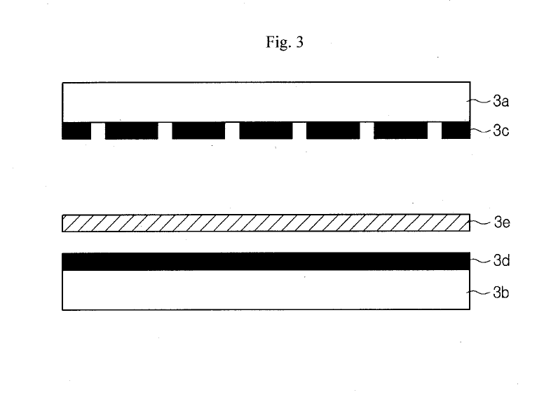

FIG. 1 is a schematic diagram of an HVAC controller according to embodiments. FIG. 2 is a block diagram of the HVAC controller according to embodiments. FIG. 3 is a diagram schematically illustrating a touch screen display according to embodiments.

Referring to FIGS. 1 to 3, an HVAC controller 1 may include a housing 2, a controller 4, a user interface, a memory 5, a communication unit or device 6, and a temperature sensor 7. The controller 4 may control one or more components of the HVAC system and acquire state information of the components. Further, the controller 4 may provide temperature information or time information.

The user interface may allow a user to input various data or a command. The user interface may include a capacitive touch screen display 3 into which a parameter setting command is input by a touch by the user and an input unit or input 8 including one or more mechanical buttons 8a and 8b. The controller 4 may be connected with the touch screen display 3 to display a screen on the touch screen display 3.

The buttons 8a and 8b may include a back button 8a and a home button 8b. When the back button 8a is pressed, the touch screen display 3 may display a previous screen. When the home button 8b is pressed, the touch screen display 3 may display a home screen.

The touch screen display 3 may include a transparent touch panel and an LCD module. The touch panel may be include a cover glass 3a and a film 3b that face each other. A transparent conductive film 3c (indium tin oxide) may be deposited on the cover glass 3a to form an X circuit pattern. Further, a transparent conductive film 3d may be formed on the film 3b to form a Y circuit pattern. In addition, the cover glass 3a may include an X-axis circuit pattern and a film including a. Y-axis circuit pattern may be bonded using an optical clear adhesive (OCA) 3e.

FIG. 3 illustrates one example of a touch screen display; however, embodiments are not limited to the touch screen display of FIG. 3, rather, the touch screen display may be configured in various forms.

The touch screen display 3 may serve as a keypad for input as well as a display.

The memory 5 may be electrically connected with the controller 4, and the memory 5 may store an algorithm for the control of the controller 4, a parameter input through the touch screen display 3, and parameters of one or more components of the HVAC system, for example. The controller 4 may store information in the memory 5 or search for information stored in the memory 5. The memory 5 may be various storage devices, including a ROM, a RAM, an EPROM, a flash drive, or a hard drive, for example.

The communication device 6 may communicate with the controller 4, and information may be uploaded to the controller 4 or downloaded from the controller 4 through the communication device 6. Further, the communication device 6 may communicate with the HVAC system through a wired or wireless network. However, the communication device 6 is not limited to a particular communication method.

The temperature sensor 7 may be installed in the housing 2 and sense a temperature of a space in which the HVAC controller 1 is installed. The controller 4 may control one or more components of the HVAC system or parameters of the components using the temperature sensed by the temperature sensor 7. Further, the controller 4 may display the temperature sensed by the temperature sensor 7 on the touch screen display 3.

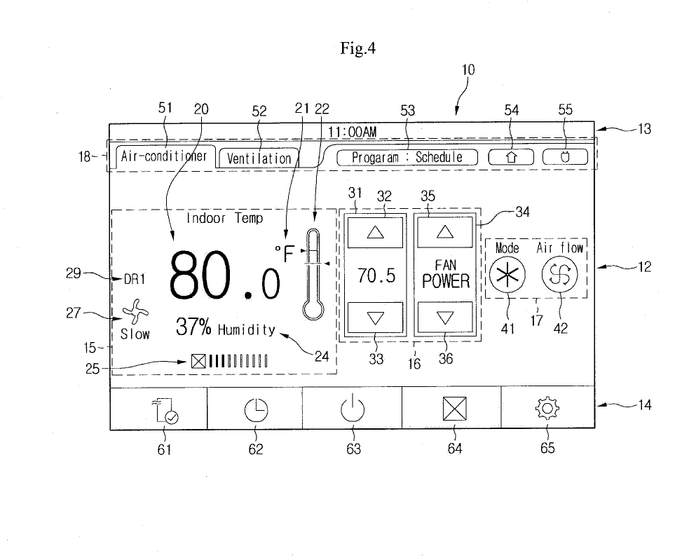

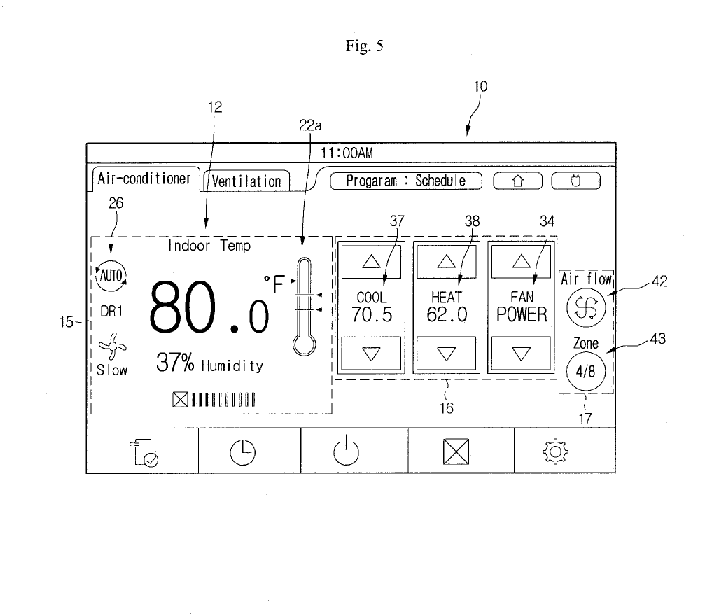

FIGS. 4 and 5 illustrate examples of a home screen which may be displayed in or on the HVAC controller according to embodiments. The HVAC controller 1 may operate in any one mode of a standard mode or a thermostat mode by input of a user command or automatically. A display mode displayed in or on the touch screen display 3 may vary depending on the mode of the HVAC controller 1.

The controller 4 may actuate the touch screen display 3 in a first display mode in the standard mode and actuate the touch screen display 3 in a second display mode in the thermostat mode. When the HVAC controller 1 is actuated in the thermostat mode, one or more components of the HVAC system may be subjected to a heating operation or a cooling operation automatically depending on an indoor or outdoor temperature or operation modes of one or more components may be converted.

FIG. 4 illustrates the home screen in a first display mode. FIG. 5 illustrates the home screen in a second display mode.

Referring to FIG. 4, a home screen 10 may include a first region 12, a second region 13, and a third region 14. The first to third regions 12 to 14 may be divided regions. The first region 12 may be placed or located between the second region 13 and the third region 14. For example, the second region 13 is placed or located above the first region 12, and the third region 14 may be placed or located below the first region 12. Alternatively, the second region 13 may be placed or located at any one side of left and right sides of the first region, and the third region 14 may be placed or located at the other side.

The controller 4 may change information displayed in the respective regions 12 to 14 on one or more screens among a plurality of screens that may be displayed in or on the touch screen display 3. Further, the controller 4 may allow the third region 14 to be removed from one or more screens among the plurality of screens, and the first region 12 to be extended or the third region 14 to be added to the first region 13.

The second region 13 as an indicator region may at least display a current time. A position and size of the second region 13 may be fixed on all screens that may be displayed in the touch screen display 3.

The first region 12 may include a monitoring region 15, a main input region 16, and a sub input region 17. The monitoring region 15 may display various kinds of information, and the main input region 16 and the sub input region 17 may receive a command for selecting or changing the parameter of the HVAC controller 1 or a command for selecting or changing the parameters of one or more components of the HVAC system.

The monitoring region 15 may display a first image, the main input region 16 may display a second image, and the sub input region 17 may display a third image. The controller 4 may vary a number or the type of information displayed in the first image or vary a number or types of parameters displayed in the second image.

The first image may include main information and sub information. In this case, the sub information may be deleted from the first image or added to the first image. That is, the first image may include one or more parameters for monitoring, and the second image may include one or more parameters for setting.

The main information may include temperature information. The temperature information may include an indoor temperature 20 sensed by the temperature sensor 7 and a temperature unit (Fahrenheit or centigrade) 21. Further, the temperature information may include an image 22 for comparing a current temperature (indoor temperature) and a target temperature. For example, the image 22 may have a thermometer shape and may have indicators indicating the target temperature and the current temperature, respectively, but embodiments are not limited thereto.

Further, the main information may include energy usage information 25. The controller 4 may change a shape, size, or color of the energy usage information 25 according to energy usage amounts of one or more components of the HVAC system. For example, the controller 4 may compare a target energy usage amount stored in the memory 5 and a current energy usage amount, and may change the shape, the size, or the color of the energy usage information 25 according to a comparison result.

Although not illustrated, the main information may include operation modes (cooling mode or heating mode) of one or more components of the HVAC system.

The sub information may include at least one of humidity 24, a fan speed 27, and energy saving operation information 29. The energy saving operation information 29 may be information displayed when a specific event occurs. Accordingly, the energy saving operation information 29 may be not displayed in the first image before the event occurs.

The main input region 16 may include a temperature set-up block 31 and a fan speed set-up block 34. The temperature set-up block 31 may be an up button 32 or a down button 33 for setting the target temperature in the cooling mode or heating mode of one or more components of the HVAC system. Further, the temperature set-up block 31 may include a set target temperature. When the up button 32 or the down button 33 is selected, the controller 4 may change a temperature displayed in the monitoring region 15.

In this case, a color of the set target temperature may vary depending on an operation mode of one or more components of the HVAC system. For example, in the case of the cooling mode, the color of the target temperature may be a blue color, and in the case of the heating mode, the color of the target temperature may be a red color.

The fan speed set-up block 34 may include an up button 35 and a down button 36 for setting a fan speed of one or more components of the HVAC system. Further, the fan speed set-up block 34 may include the set fan speed. When the fan speed is changed by the up button 35 or the down button 36, a fan speed 27 displayed in the monitoring region 15 may be changed. That is, the controller 4 may change a parameter displayed in the monitoring region 15 when a command for setting is input through the main input region 16.

The sub input region 17 may include a mode button 41 for selecting a mode of one or more components of the HVAC system and a wind direction button 42 for selecting a wind direction of a fan of one or more components of the HVAC system. The controller 4 may vary a number or a type of information displayed in the sub input region 17.

The first region 12 may include a navigation bar 18. A menu may be selected by using the navigation bar 18. The navigation bar 18 may be placed or located in an upper region of the second region 12. The navigation bar 18 may include an air conditioner button 51, a ventilation button 52, a program button 53, an occupation/inoccupation selection button 54, and an energy button 55.

The air conditioner button 51 and the ventilation button 52 are device selection buttons for selecting a type of device. In the case where the HVAC system includes two or more components, the controller 4 may display a device selection button for selecting each component on the home screen 10. For example, in the case where the HVAC system includes the air conditioner and the ventilation device, the controller 4 may display the air conditioner button 51 and the ventilation button 52 on the home screen 10. In contrast, in the case where the HVAC system includes only any one of the air conditioner or the ventilation device, a device selection button corresponding to the corresponding device may be displayed on the home screen 10 or a device button may not be displayed.

The controller 4 may display an image for controlling or monitoring the air conditioner in the first region 11 when the air conditioner button 51 is selected and displays an image for controlling or monitoring the ventilation device in the first region 11 when the ventilation button 52 is selected.

The third region 14 may include a main button 61, a schedule button 62, an on/off button 63, an energy button 64, and a set-up button 65. One or more components of the HVAC system may be turned on or off by the on/off button 63. In one embodiment, the on/off button 63 may be omitted or substituted with buttons for other functions.

When a power off command of one or more components of the HVAC system by input in the power button 63, the controller 4 may deactivate buttons for inputting parameters displayed in the touch screen display and activate the buttons when a power on command is input.

Next, referring to FIG. 5, the second region 12 may include a monitoring region 15, a main input region 16, and a sub input region 17 in the second display mode. Magnitudes of the main input region 16 and the sub input region 17 in the first display mode may be different from those of the main input region 16 and the sub input region 17 in the second display mode.

Mode information 26 that displays the mode of one or more components of the HVAC system or displays a display mode of the touch screen display may be displayed in addition to the information which may be displayed in the first display mode.

In addition, the monitoring region 15 may display an image 22a for comparing a present temperature, a target cooling temperature, and a target heating temperature. The image 22a may include a mark (including a first mark and a second mark) displaying the target cooling temperature and the target heating temperature, and a color, a magnitude, or a form of a mark of the target heating temperature may be different from the shape, magnitude, or form of a mark of the target cooling temperature.

The main input region 16 may include a cooling temperature set-up block 37 a heating temperature set-up block 38, and a fan speed set-up block 34. The cooling temperature set-up block 37 may include an up button and a down button for setting the cooling temperature and the set target cooling temperature. The heating temperature set-up block 38 may include an up button and a down button for setting the heating temperature and the set target heating temperature.

That is, in the first display mode, the main input region 16 displays a temperature set-up block 32 for setting the temperature in any one of the cooling or heating modes and in the second display mode, the main input region 16 displays both the cooling temperature set-up block 37 and the heating temperature set-up block 38. Of course, in the first display mode, the main input region 16 may display both the cooling temperature set-up block 37 and the heating temperature set-up block 38, but the controller 4 may activate one of the cooling temperature set-up block 37 or the heating temperature set-up block 38 and deactivate the other one based on one or more components of the HVAC system.

In the second display mode, the controller 4 may activate each of the cooling temperature set-up block 37 and the cooling temperature set-up block 38 when one or more components of the HVAC system are in the automatic mode. Further, in the second display mode, when one or more components of the HVAC system are in a mode other than an automatic mode, the controller 4 may deactivate each of the cooling temperature set-up block 37 and the cooling temperature set-up block 38 based on the mode.

Meanwhile, the controller 4 may control one or more components of the HVAC system to satisfy ranges of the target cooling temperature and the target heating temperature when the target cooling temperature and the target heating temperature are set. In this case, the target temperature may be higher than the target heating temperature.

The sub input region 16 may include a wind direction button 42 and a zone button 43. In this case, while the screen is displayed in the first display mode, when the second display mode is selected, the sub input region may delete the mode button 41 or deactivate the mode button 41.

The home screen 10 of FIG. 4 or 5 may be a main screen. That is, the controller 4 may display the home screen 10 of FIG. 4 or 5 among a plurality of screens which may be displayed on the touch screen display 3 when the HVAC controller 1 is turned on. Further, when the home button 4 is pressed, the controller 4 may display the home screen 10 of FIG. 4 or 5 on the touch screen display 3.

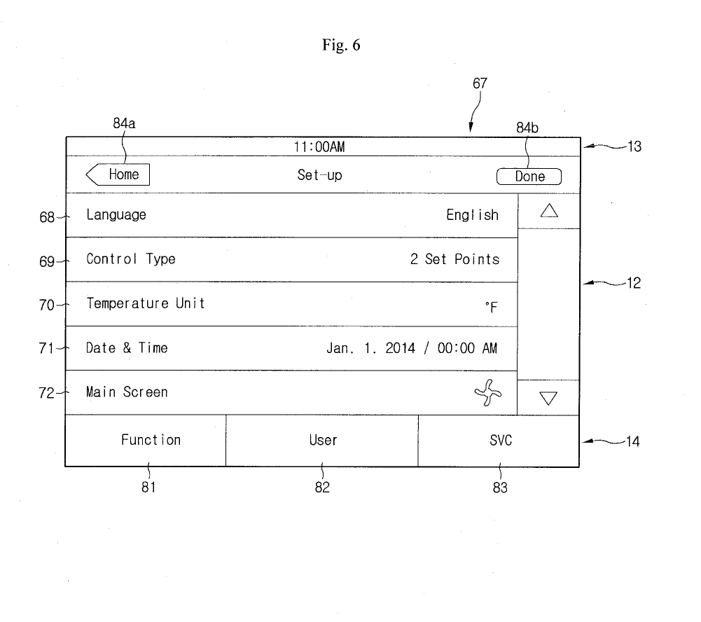

FIGS. 6 to 12 illustrate screens for setting a parameter displayed on a touch screen display of the HVAC controller according to embodiments. FIG. 6 illustrates a screen displayed when a set-up button is selected on the screen of FIG. 4, and screen 67 may include a first region 12, a second region 13, and a third region 14. The first region 12 may include a language button 68 for selecting a display language, a mode button 69 for selecting a control mode, a temperature unit button 70 for selecting a temperature unit, a date and time button 71 for displaying a date and a time, and a main screen button 72 for selecting an item displayed on the main screen. When all buttons are not displayed in the first region 12, the first region 12 may display a scroll button or a scroll bar for the non-displayed buttons.

When the language button 68 is touched, the controller 4 may display a language setting screen on the screen 67. The language button 68 may display a set language.

The third region 14 may include a function button 81, a user button 82, and a service button 83. The first region 12 may be displayed when the user button 82 is selected, for example.

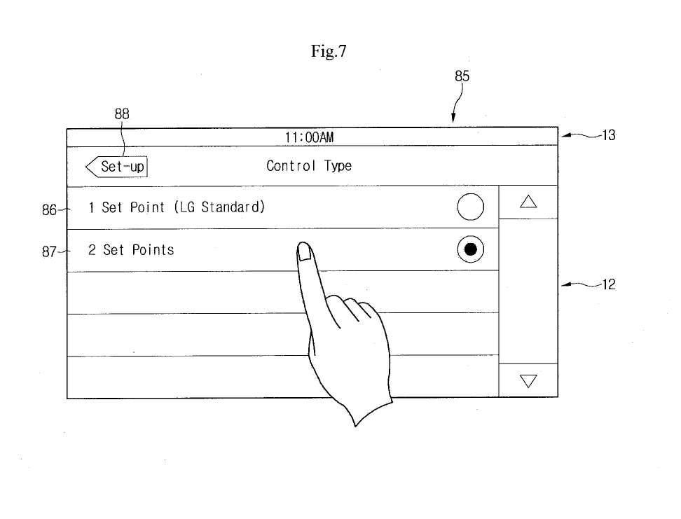

FIG. 7 illustrates a screen displayed when a mode button is selected on the screen of FIG. 6. When the mode button 69 is selected on the screen 67, the controller 4 may display a screen 85 for selecting the mode on the touch screen display 3 as illustrated in FIG. 7.

The screen 85 may include a standard button 86 for selecting the standard mode and a thermostat button 87 for selecting the thermostat mode. Further, the screen 85 may include a set-up button 88 for returning to the screen of FIG. 6. When mode selection is complete in FIG. 7 and the set-up button 88 may be selected, the present screen may be switched to the screen of FIG. 6. The mode button 69 may display the selected mode on the screen 67 of FIG. 6.

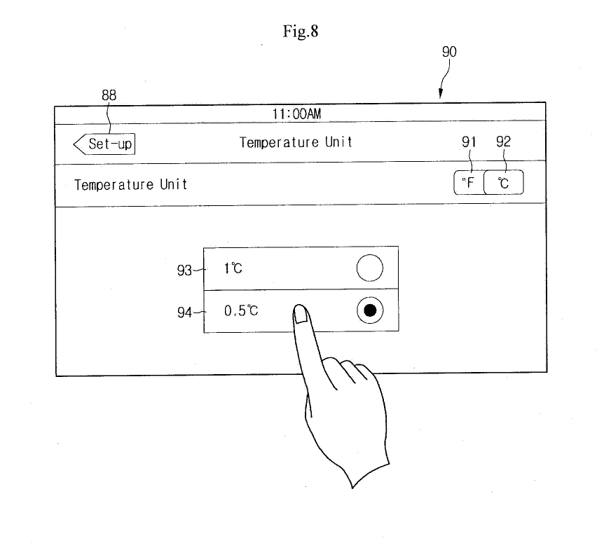

FIG. 8 illustrates a screen displayed when a temperature unit button is selected on the screen of FIG. 6. When the temperature unit button 70 is selected on the screen 67, the controller 4 may display a screen 90 for selecting a temperature unit on the touch screen display 3 as illustrated in FIG. 8.

The screen 90 may include a Fahrenheit button 91 and a centigrade button 92 for selecting the temperature unit. The user may select one of the Fahrenheit button 91 and the centigrade button 92. Alternatively, the screen 90 may include a single button for selecting the temperature unit and select Fahrenheit or centigrade by sliding a button. Further, the screen 90 may include the set-up button 88.

The screen 90 may include a button for selecting a temperature range changed when the up button or the down button for changing a temperature is selected in FIG. 4 or 5. The button may include, for example, a first button 93 for selecting 1 degree Fahrenheit and a second button 94 for selecting 0.5 degrees centigrade; however, embodiments are not so limited. Alternatively, although not illustrated, the button may include, for example, a first button for selecting 2 degrees Fahrenheit and a second button for selecting 1 degree Fahrenheit.

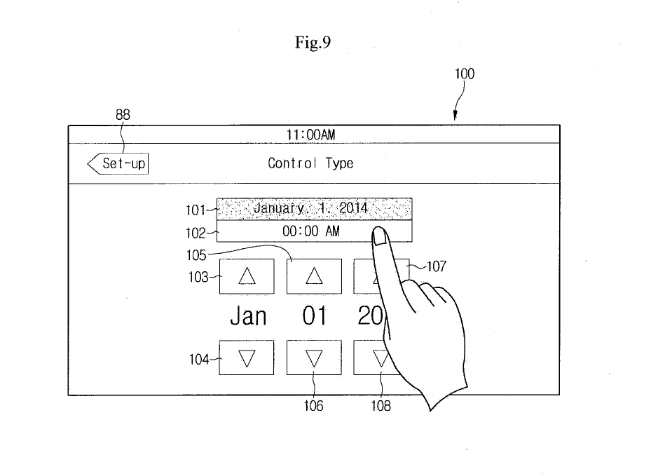

FIG. 9 illustrates a screen displayed when date and time button is selected on the screen of FIG. 6. When the date and time button is selected on the screen 67, the controller 4 may display a screen 100 for setting a date and a time as illustrated in FIG. 9.

The screen 100 may include a date button 101 and a time button 102. When the date button 102 is selected, the screen 100 may display month buttons 103 and 104 for selecting a month, day buttons 105 and 106 for selecting a day, and year buttons 107 and 108 for selecting a year. Of course, before the date button 102 is selected, the screen 100 may display the month buttons 103 and 104, the date buttons 105 and 106, and the year buttons 107 and 108. Each of the month buttons 103 and 104, the day buttons 105 and 106, and the year buttons 107 and 108 may include an up button and a down button.

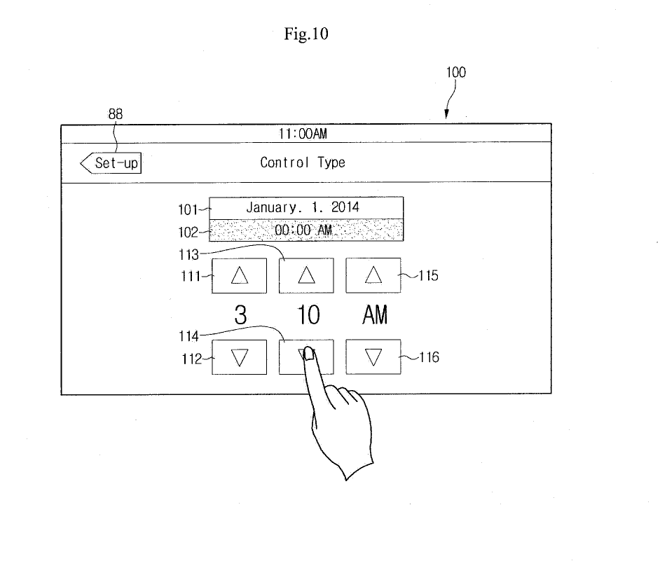

FIG. 10 illustrates a screen displayed when the time button is selected on the screen of FIG. 9. When the time button 102 is selected on the screen of FIG. 9, the screen 100 may display hour buttons 111 and 112, minute buttons 113 and 114, and AM/PM buttons 115 and 116 for AM/PM. Each of the hour buttons 111 and 112 and the minute buttons 113 and 114 may include an up button and a down button.

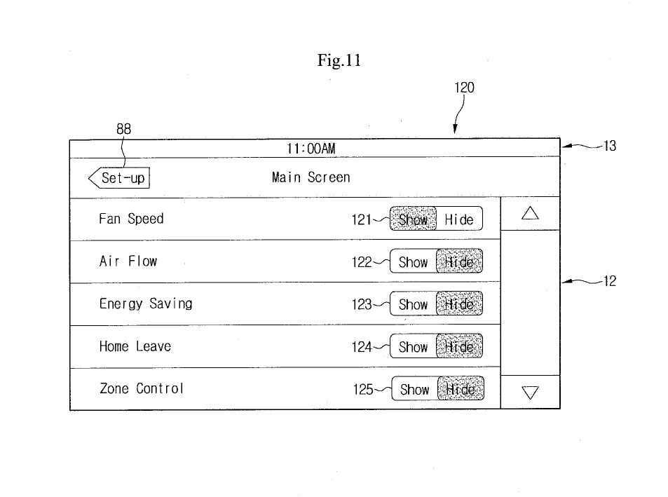

FIG. 11 illustrates a screen displayed when a main screen button is selected on the screen of FIG. 6. The screen in the first display mode is illustrated in FIG. 11.

When the main screen button 72 is selected on the screen 67, the controller 4 may display a screen 120 for selecting an item to be displayed on the main screen as illustrated in FIG. 11. The screen 120 may include a button 121 for selecting whether a fan speed is displayed, a button 122 for selecting whether an air volume is displayed, a button 123 for selecting whether energy saving is displayed, a button 124 for selecting whether home leave is displayed, and a button 125 for selecting whether a zone control is displayed.

Each of the buttons 121 to 125 may include a show button and a hide button. Alternatively, each of the buttons 121 to 125 may include one button which is slidable and showing or hiding may be selected by sliding the button. Alternatively, the screen 120 may further include a button (not illustrated) for selecting humidity.

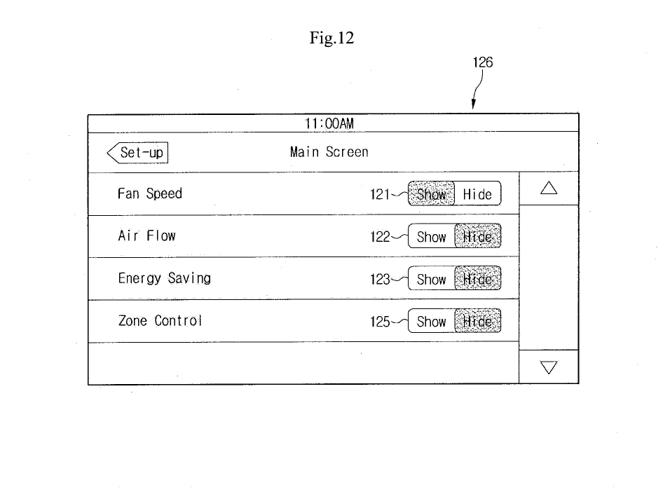

FIG. 12 illustrates a screen displayed when the main screen button is selected on the screen of FIG. 6. The screen in the second display mode is illustrated in FIG. 12.

When the main screen button 72 is selected on the screen 67 of FIG. 6, the controller 4 may display a screen 126 for selecting an item to be displayed on the main screen as illustrated in FIG. 12. The screen 126 may include a button 121 for selecting whether fan speed is displayed, a button 122 for selecting whether air volume is displayed, a button 124 for selecting whether energy saving is displayed, and a button 125 for selecting whether zone control is displayed.

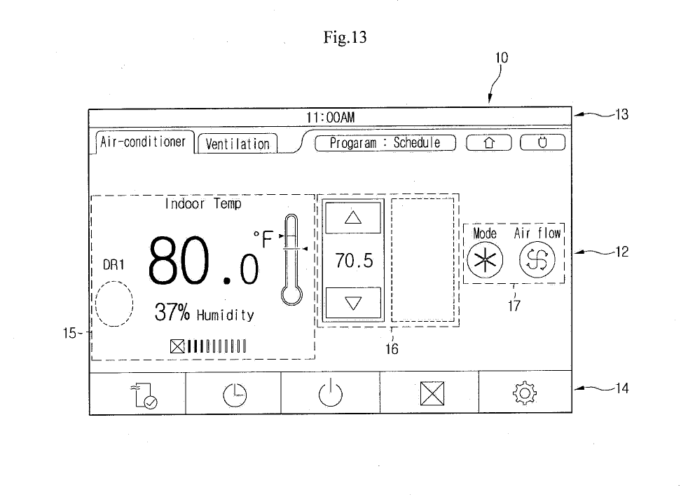

FIGS. 13 to 19 illustrate examples of the home screen in which some items are hidden. A position of the hidden item is marked with dotted lines in FIGS. 13 to 19.

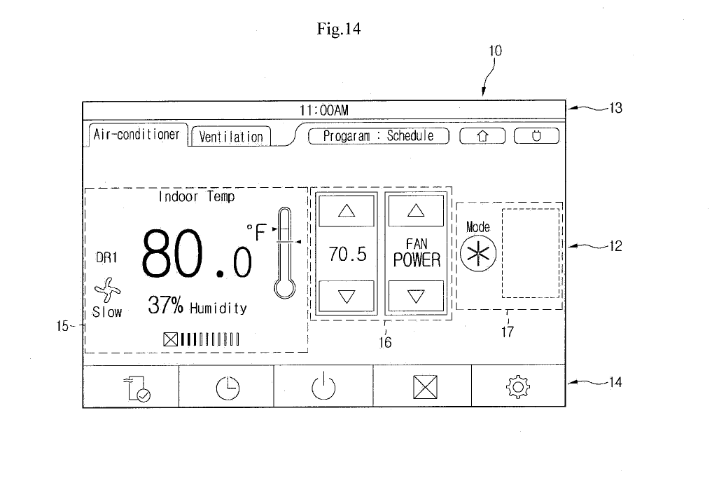

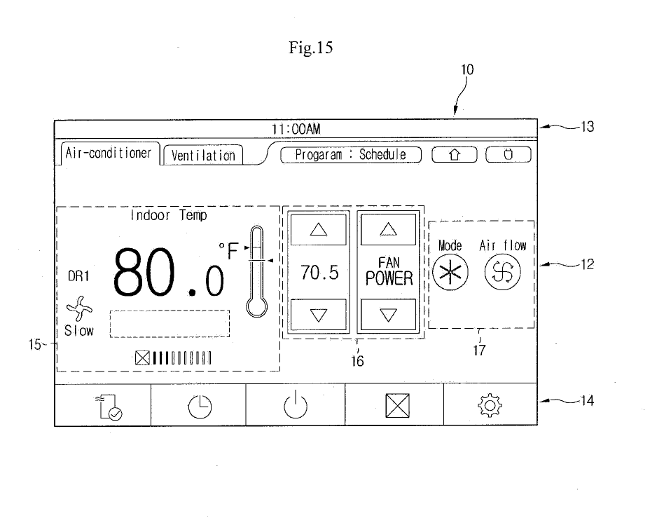

Referring to FIGS. 4 and 13, when hiding the fan speed is selected, the fan speed 27 is not displayed in the monitoring region 15 of the home screen 10 and the fan speed set-up block 34 may not be displayed in the main input region 16. Referring to FIGS. 4 and 14, when hiding the wind direction is selected, the wind direction button 42 may be displayed in the sub input region 17. Referring to FIGS. 4 and 15, when hiding the humidity is selected, the humidity 27 may not be displayed in the monitoring region 17 of the home screen 10.

In FIGS. 13 to 15, one item is not displayed on the home screen 10; however, when hiding a plurality of items is selected, the plurality of items may not be displayed on the home screen 10.

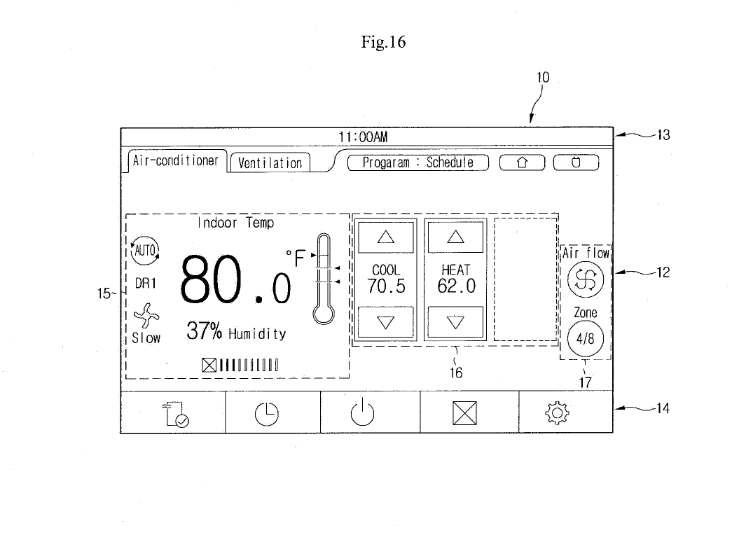

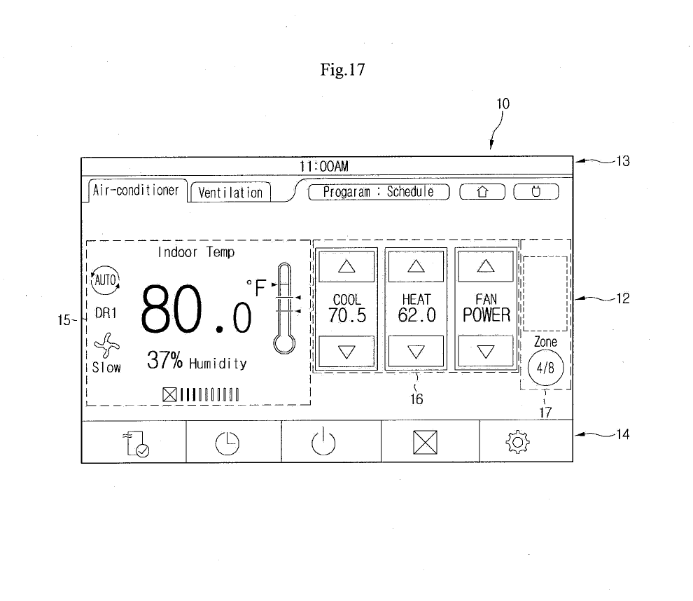

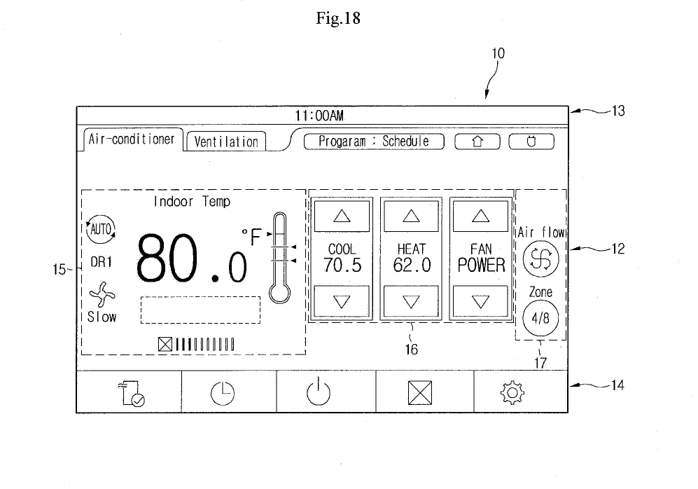

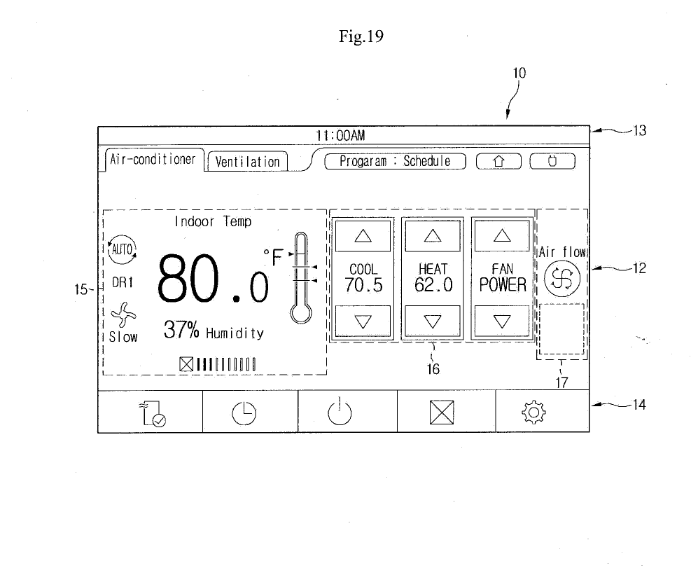

Referring to FIGS. 5 and 16, when hiding the fan speed is selected, the fan speed set-up block 34 may not be displayed in the main input region 16 of the home screen 10. Referring to FIGS. 5 and 17, when hiding the wind direction is selected, the wind direction button 42 may not be displayed in the sub input region 17. Referring to FIGS. 5 and 18, when hiding the humidity is selected, the humidity 27 may not be displayed in the monitoring region 17 of the home screen 10. Referring to FIGS. 5 and 19, when hiding the zone control is selected, the zone button 43 may not be displayed in the sub input region 17 of the home screen 10.

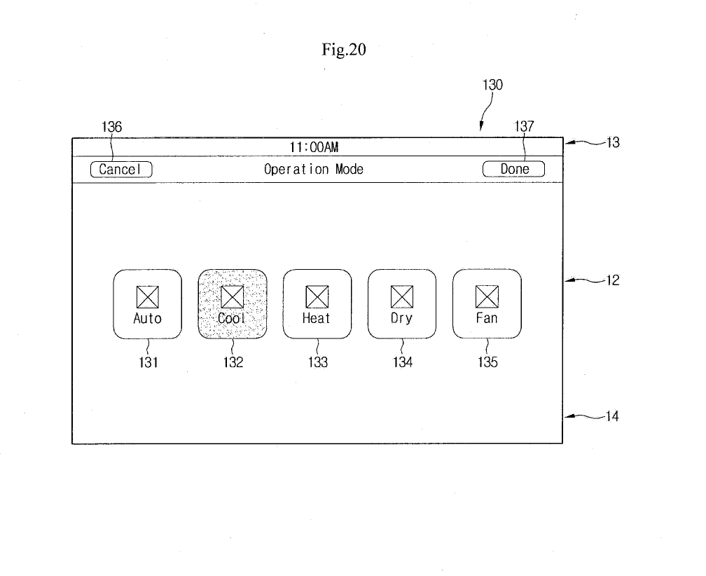

FIG. 20 illustrates a screen displayed when the mode button is selected on the screen of FIG. 4. Referring to FIG. 20, when the mode button 41 is selected on the screen of FIG. 4, the controller 4 may display a screen 130 for selecting operation modes of one or more components of the HVAC system on the touch screen display 3.

The screen 130 may include an automatic button 131, a cooling button 132, a heating button 133, a dehumidification button 134, and a blowing button 135. Further, the screen 130 may further include a cancel button 136 and a done button 137.

The controller 4 may change a number of buttons displayed on the screen 130. That is, the controller 4 may display buttons for selecting the mode on the screen 130 to correspond to a number of modes in which one or more components of the HVAC system are operable.

An array of the buttons may be changed depending on the number of buttons displayed on the screen 130. In this case, an array method of the buttons when the buttons are odd is different from an array method of the buttons when the buttons are even.

For example, when a plurality of buttons to be displayed is an even number, the plurality of option buttons may be vertically oriented in a plurality of rows, in which as button may be placed in each row. In addition, the plurality of rows may be an even number.

When the plurality of buttons to be displayed is an odd number, the plurality of option buttons may be vertically oriented in a plurality of rows, in which a button may be placed in each row. In addition, the plurality of rows may be an odd number.

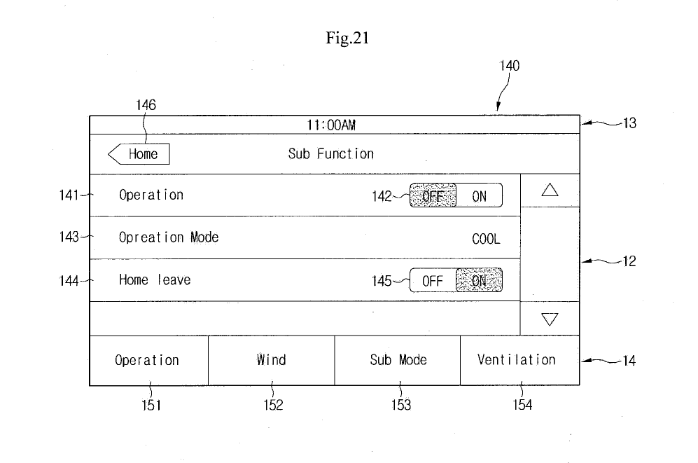

FIG. 21 illustrates a screen displayed when a main button is selected on the screen of FIG. 4. Referring to FIG. 21, when the main button 61 is selected on the home screen 10 of FIG. 4, the controller 4 may display a screen 140 for selecting a sub function on the touch screen display 3.

The screen 140 may include a first region 12, a second region 13, and a third region 14. The first region 12 may include an operation on/off button 141 for selecting on/off of one or more components of the HVAC system, an operation mode button 143 for selecting an operation mode, and a home leave button 144 for selecting home leave.

The operation on/off button 141 may include a button 142 for selecting on/off. For example, the button 142 may include an on button and an off button.

When the operation mode button 143 is selected, the controller 4 may display the screen 130 of FIG. 20 on the touch screen display 3. The operation mode button 140 may include information on the selected mode.

The home leave button 144 may include a button 145 for selecting on/off. For example, the button 145 may include an on button and an off button.

Further, the first region 12 may include a home button 146. When the home button 146 is selected, the controller 4 may display the home screen 10 of FIG. 4 or 5 on the touch screen display 3.

The third region 14 may include an operation button 151, a wind button 152, a sub mode button 153, and a ventilation button 154.

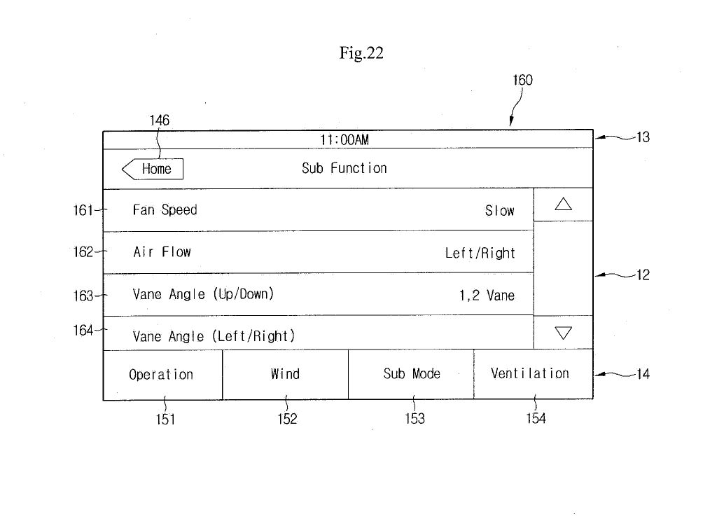

FIG. 22 illustrates a screen displayed when a wind button is selected on the screen of FIG. 21. Referring to FIG. 22, when the wind button 152 is selected on the screen 140 of FIG. 21, the controller 21 mat display a screen 160 for setting a parameter associated with a wind on the touch screen display 3.

The screen 160 may include a fan speed button 161 for setting fan speed, a wind direction button 162 for setting wind direction, a vertical vane angle button 162 for setting vane angle, and a horizontal vane angle button 163 for setting a horizontal vane angle. Further, the screen 160 may include the home button 146.

The fan speed button 161 may include set fan speed information, and the wind direction button 162 may include set wind direction information.

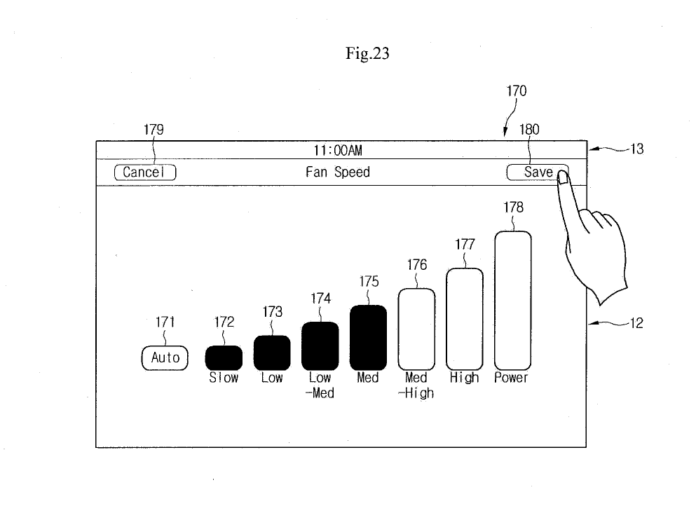

FIG. 23 illustrates a screen displayed when a fan speed button is selected in FIG. 22. Referring to FIG. 23, when the fan speed button 161 is selected on the screen 160 of FIG. 22, the controller 4 may display a screen 170 for setting the fan speed on the touch screen display 3.

The screen 170 may include an automatic button 171, a slow button 172, a low button 173, a low-medium (mid) button 174, a medium (med) button 175, a medium (med)-high button 176, a fast button 177, and a power button 178. The screen 170 may further include a cancel button 179 and a save button 180. The controller 4 may change a number of buttons displayed on the screen 170 depending on a number of fan speeds which may be selected in one or more components of the HVAC system.

When the save button 180 is selected after a specific button is selected, the fan speed 27 of the monitoring region 15 and the fan speed information of the fan speed set-up block 34 of the main input region 16 may be changed on the home screen 10 of FIG. 4.

When the save button 180 or the cancel button 179 is selected on the screen 170, the controller 4 may display the home screen 10 of FIG. 4 or 5 or the screen 160 of FIG. 22 on the touch screen display 3.

Alternatively, the screen 170 may include two set-up buttons for selecting fan speeds of a plurality of steps. At least one of the fan speeds of the plurality of steps may be selected using two set-up buttons.

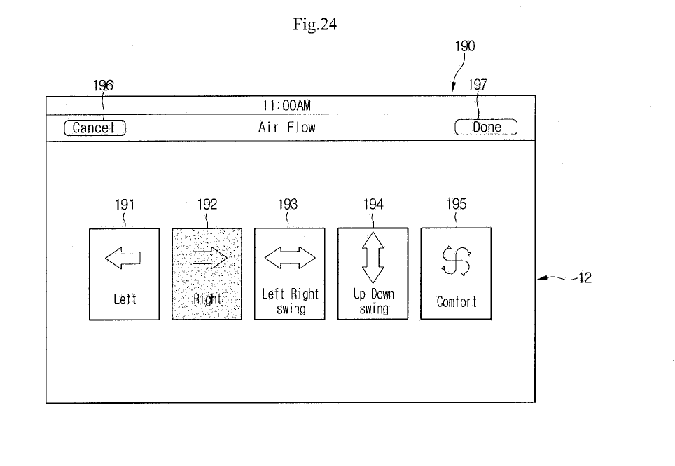

FIG. 24 illustrates a screen displayed when a wind direction button is selected in FIG. 22. Referring to FIG. 24, when the wind direction button 162 is selected on the screen 160 of FIG. 22, the controller 4 may display a screen 190 for setting the wind direction on the touch screen display 3. Alternatively, when the wind direction button 42 is selected on the home screen 10 of FIG. 4, the controller 4 may display the screen 190 for setting the wind direction on the touch screen display 3.

The screen 190 may include a left button 191, a right button 192, a left-right swing button 193, an up-down swing button 194, and a comfort button 195. Further, the screen 190 may include a cancel button 196 and a done button 197. The controller 4 may change a number of buttons displayed on the screen 190 depending on a number of wind directions which may be selected in one or more components of the HVAC system.

When the done button 197 is selected after a specific button is selected, an image of the wind direction 42 of the sub input region 17 may be changed on the home screen of FIG. 4.

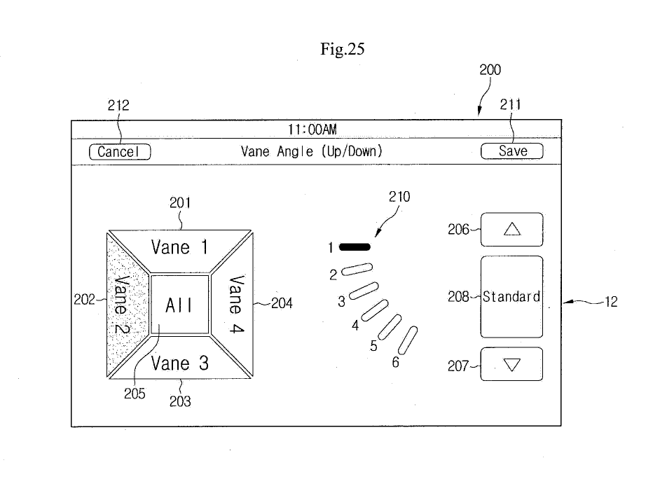

FIG. 25 illustrates a screen displayed when a vertical vane angle button is selected in FIG. 22. Referring to FIG. 25, when the vertical vane angle button 163 is selected on the screen 160 of FIG. 22, the controller 4 may display a screen 200 for setting the vertical vane angle on the touch screen display 3.

The screen 200 may include a first vane button 201, a second vane button 202, a third vane button 203, and a fourth vane button 204 for selecting a plurality of vanes, respectively, and an all button 205 for selecting all of the plurality of vanes. Accordingly, the user may individually set a vertical angle for each vane and set the vane angles simultaneously by selecting two or more vane buttons.

The controller 4 may change a number of vane buttons displayed on the screen 200 depending on a number of vanes for which vertical angles may be controlled in one or more components of the HVAC system. Alternatively, all vane buttons may be displayed with the number of vanes of which angles are controllable, in which only vane buttons corresponding to the vanes for which angles are controllable may be activated.

The screen 200 may include an up button 206 and a down button 207 for setting an angle of a selected vane, and a standard button 208 for selecting a standard angle. The standard angle may be automatically selected in a range of, for example, 30 to 60°. For example, the vane angle may be set by a unit of 15° using the up button 206 and the down button 207; however, embodiments are not limited thereto.

The screen 200 may further include an image 210 for the user to intuitively verify the selected vane angle. The image 210 may include a plurality of bars which is placed at different angles. In this case, the plurality of bars may be placed at a predetermined interval within a range of approximately 90° and a color of a bar corresponding to the selected angle may be different from colors of remaining bars.

The screen 200 may further include a cancel button 212 and a save button 211.

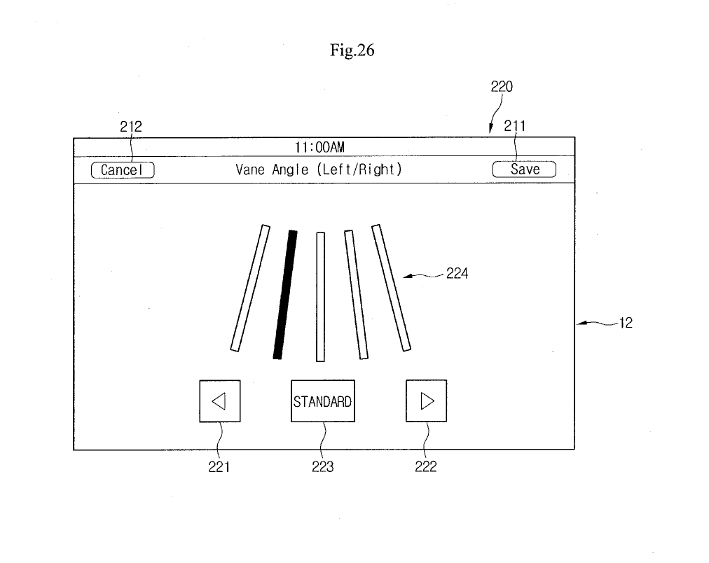

FIG. 26 illustrates a screen displayed when a horizontal vane angle button is selected in FIG. 22. Referring to FIG. 26, when the horizontal vane angle button 164 is selected on the screen 160 of FIG. 22, the controller 4 may display a screen 220 for setting the horizontal vane angle on the touch screen display 3.

The screen 200 may include a left button 221 and a right button 222 for selecting the angle of the selected vane, and a standard button 223 for selecting a standard angle. Further, the screen 220 may further include an image 224 for the user to intuitively verify the selected vane angle. The image 224 may include a plurality of vertical bars which is placed at different angles. In this case, the plurality of vertical bars may be placed at a predetermined interval within a predetermined range and a color of a vertical bar corresponding to the selected angle may be different from colors of remaining vertical bars.

The screen 200 may further include a cancel button 212 and a save button 211.

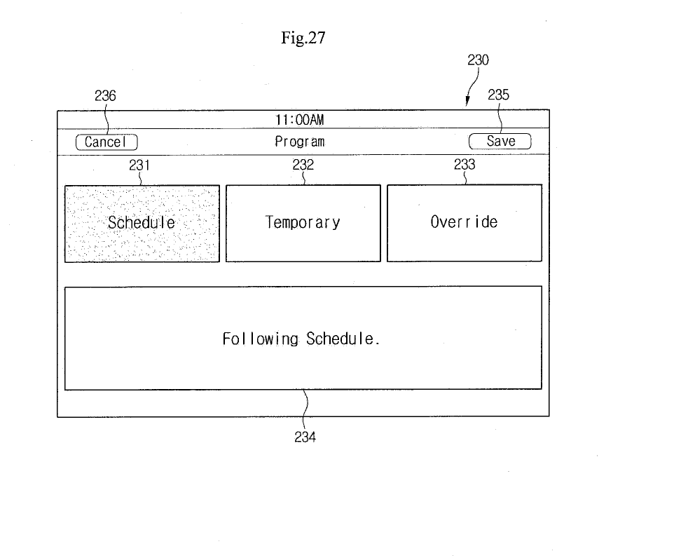

FIG. 27 illustrates a screen displayed when a program button is selected on the home screen of FIG. 4. Referring to FIG. 27, when a program button 53 is selected on the home screen 10 of FIG. 4, the controller 4 may display a screen 240 for selecting an operation program on the touch screen display 3.

The screen 240 may include a schedule button 231 for following a set schedule, a temporary button 232 for arbitrary control by the user, and an override button 233 for temporarily switching an occupied or unoccupied state by the schedule. Further, the screen 240 may further include a cancel button 236 and a done button 235.

The screen 240 may display a text message 234 when the schedule button 231 is selected. The text message 234 may be, for example, “following schedule”.

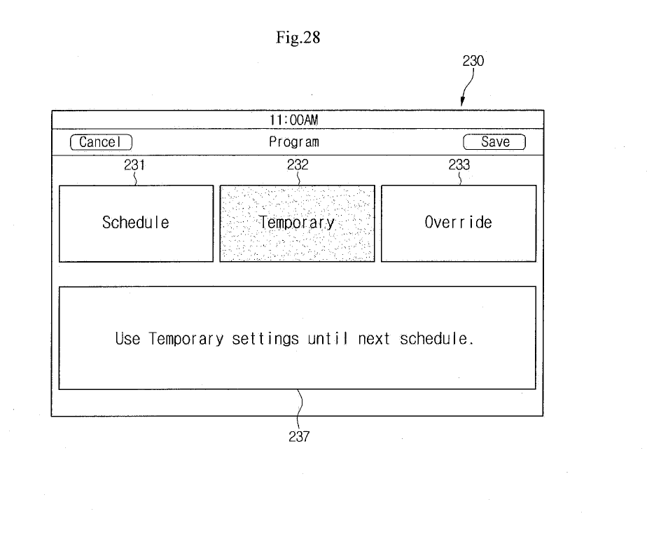

FIG. 28 illustrates a screen displayed when a temporary button is selected on a screen of FIG. 27. Referring to FIG. 28, when the temporary button 232 is selected on the screen 230 of FIG. 27, the screen 230 may display a text message 237. The text message 237 may be “use temporary settings next schedule”.

The controller 4 may control one or more components of the HVAC system by using temporary settings until a next schedule. The temporary settings may be input by the user.

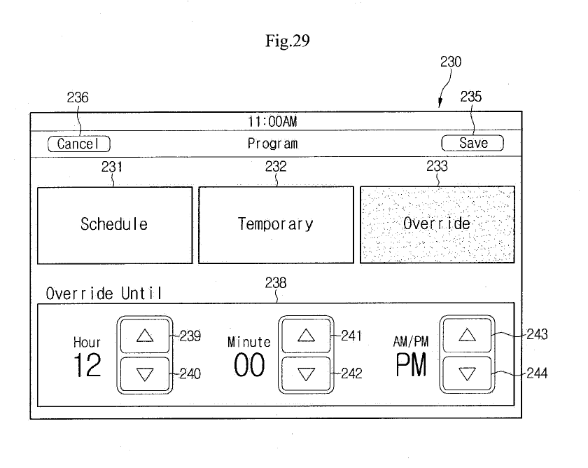

FIG. 29 illustrates a screen displayed when an override button is selected on the screen of FIG. 28. Referring to FIG. 29, when the override button 234 is selected on the screen 230 of FIG. 28, the screen 230 may display an hour set-up block 238 for setting a state switching done time.

The hour set-up block 238 may include hour buttons 239 and 240 for selecting an hour, minute buttons 241 and 242 for selecting a minute, and AM/PM button 243 and 244 for selecting AM/PM. When the state switching done time is input in the time set-up block 238 while one or more components of the HVAC system are subjected to an occupied operation, the controller 4 may allow the one or more components of the HVAC system to be subjected to an unoccupied operation and vice versa. However, when an event start schedule is reached earlier before the state switching done time is reached, the controller 4 may control the one or more components of the HVAC system according to the event start schedule. When the one or more components of the HVAC system is operated according to the schedule, the controller 4 may activate the override button 234.

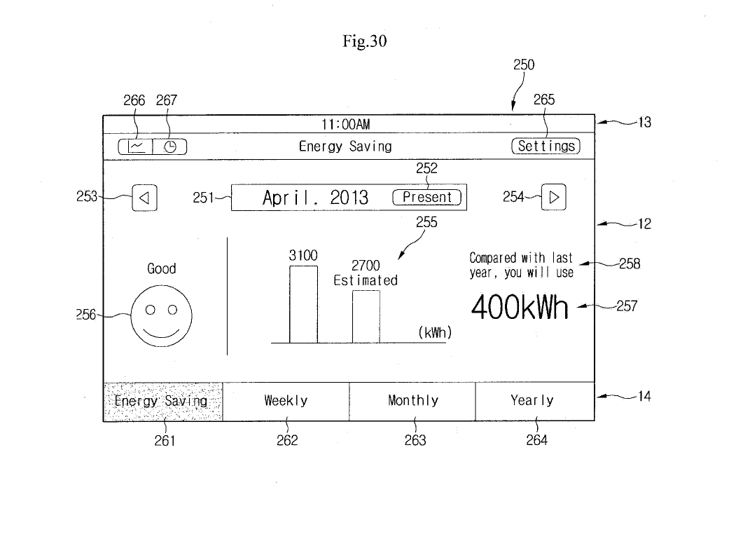

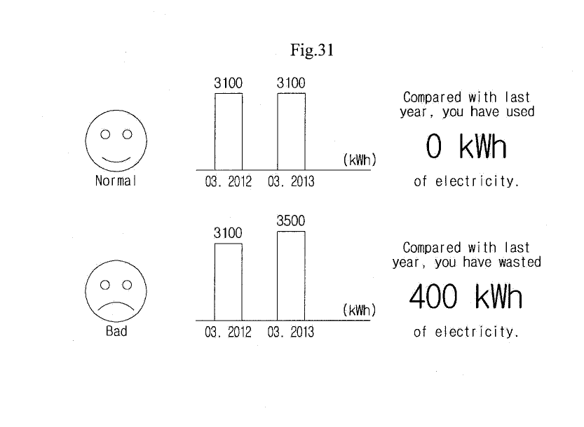

FIGS. 30 to 41 illustrate examples of screens for monitoring an energy usage amount. FIG. 30 illustrates a screen displayed when an energy button 55 is selected on the screen of FIG. 4 or 5. FIG. 31 illustrates various images which may be displayed on a screen for monitoring.

When the energy button 55 is selected on the screen of FIG. 4 or 5, the controller 4 may display the screen 250 for monitoring the energy usage amount on the touch screen display 3. That is, the controller 4 may display the screen 250 for monitoring the energy usage amount on the touch screen display 3 when a command for verifying the energy usage amount is received.

The screen 250 may include a first region 12, a second region 13, and a third region 14. The third region 14 may include a plurality of buttons for verifying energy usage amount information. The third region 14 may include a weekly button 262, a monthly button 263, and a yearly button 264. Therefore, the third region 14 may be called a button region on the screen 250. Further, the third region 13 may further include an energy saving button 261. Therefore, the third region 14 may be called a selection region for selecting information to be displayed.

The first region 12 may display energy usage amount information corresponding to a selected button among buttons 261 to 263 of the third region 14. Therefore, the first region 12 may be called a display region for displaying information.

However, while the buttons 261 to 263 are not selected, the screen 250 may display one or more images 255 and 256 for comparing an energy usage amount of a present month and an energy usage amount of the same method of a previous year, and month information 251.

That is, the controller 4 may acquire energy usage amounts of one or more components of the HVAC system during a first period and acquire energy usage amounts of one or more components of the HVAC system during a second period which is a previous period to the first period. In addition, the controller 4 may compare the respective acquired energy usage amounts, and generate the result information to display the generated result information on the screen 250. Further, the controller 4 may display an energy usage amount during a predetermined period on the screen 250 by acquiring the energy usage amount information.

The image 255 may include a plurality of bar graphs showing the energy usage amount during the first period and the energy usage amount during the second period, at the same time. The plurality of respective bar graphs may display the energy usage amounts with relative lengths or heights. Accordingly, the user may intuitively compare the energy usage amounts during two periods.

Alternatively, the image 255 may include a plurality of bar graphs showing a target energy usage amount and the energy usage amount during the first period. The target energy usage amount may be set by the user.

The image 256 (representing the result information) may be an icon. A shape, a form, or a color of the icon may be changed depending on a result of the comparison of the energy usage amounts. For example, when the energy usage amount during the first period is smaller than the energy usage amount during the second period by a predetermined amount or more, the icon may be a smiling face shape. In contrast, when the energy usage amount during the first period is larger than the energy usage amount during the second period by a predetermined amount or more, the icon may be a frowning face shape.

The first region 12 may include change buttons 253 and 254 for changing a month (period) to be verified. The month information 251 may display a month selected by the change buttons 253 and 254. In addition, the month information 251 may include a present button 252 for selecting a present month.

The first region 12 may display a difference value 257 (representing the result information) between the energy usage amount during the first period and the energy usage amount during the second period by numerical figures. Further, the first region 12 may display the comparison result of the energy usage amount during the first period and the energy usage amount during the second period by a text 258.

In this case, a color of the image 256, a color of the bar graph displaying the energy usage amount during the first period, and a color of the numerical figure displaying the difference value 257 in the energy usage amount may be the same as each other.

The first region 12 may further include an energy usage amount button 266 selected for viewing the energy usage amount and a usage time button 267 selected for viewing a used time. Further, the first region 12 may include a set-up button 265.

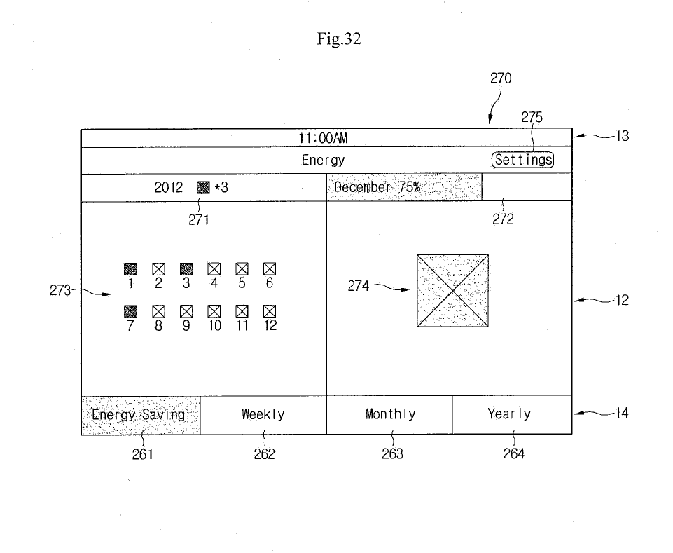

FIG. 32 is another example of a screen for monitoring the energy usage amount. Referring to FIG. 32, when the energy button 55 is selected on the screen of FIG. 4 or 5, the controller 4 may display a screen 270 for monitoring the energy usage amount on the touch screen display 3.

The screen 270 may include a first region 12, a second region 13, and a third region 14. The third region 14 may include a plurality of buttons for verifying energy usage amount information. The third region 14 may include a weekly button 262, a monthly button 263, and a yearly button 264. Therefore, the third region may be called a button region on the screen 270. Further, the third region 13 may further include an energy saving button 261.

The first region 12 may display energy usage amount information corresponding to a selected button among buttons 261 to 263 of the third region 14. However, while the buttons 261 to 263 are not selected, the screen 270 may display energy usage amount information 272 or 274 of a present month. The energy usage amount information 272 or 274 may be a bar graph 272 or an icon 274; however, embodiments are not limited thereto.

Further, the screen 270 may display monitoring information 273 for each month (second period) that belongs to a present year (first period). For example, the monitoring information 273 may include 12 divided months. A color of each monitoring information 273 may be changed according to the energy usage amount and a reference usage amount. In this case, the reference usage amount may be a manually or automatically set target energy usage amount or an energy usage amount in the same month of a previous year.

The monitoring information 273 is result information generated when the controller 4 compares the energy usage amounts of one or more components of the HVAC system and the reference usage amount. The reference usage amount may be a usage amount set by the user or an energy usage amount in each month of a previous year.

Further, the screen 270 may display number information 271 of a month among months that belong to a preset year, in which the energy usage amount is smaller than the reference usage amount. For example, it is illustrated that energy usage amounts in three months of 2012 are smaller than the reference usage amount.

Further, the screen 270 may include a set-up button 275.

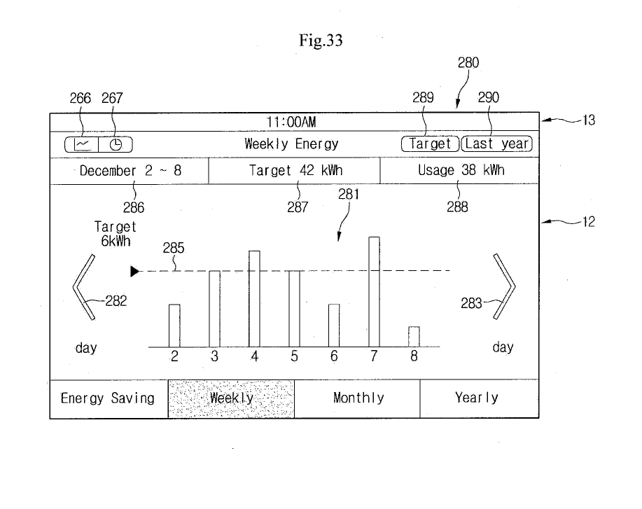

FIG. 33 illustrates a screen displayed when a weekly button is selected on the screen of FIG. 30. Referring to FIG. 33, when the weekly button 262 is selected on the screen 250 of FIG. 30, the controller 4 may display a screen 280 for showing an energy usage amount during one week on the touch screen display 3. The screen 280 may display a weekly usage amount image 281 showing the energy usage amount during one week for each day and a display line 285 displaying a daily target usage amount.

The weekly usage amount image 281 may include a plurality of bar graphs displaying an energy usage amount for each day or date. The bar graphs may be vertically oriented, and a height, length, or size of the bar graphs may be changed according to the energy usage amount for each day. The display line 285 may be a horizontal line. The color of the bar graphs may be changed according to a result of comparison of the daily target usage amount and the energy usage amount for each day. That is, the controller 4 may compare the energy usage amount for each day and the daily target usage amount, and may differently display the color, the size, or the length of the energy usage amount for each day according to the comparison result.

The screen 250 may display a plurality of energy usage amounts for each day. Therefore, the screen 250 may display energy usage amounts of a plurality of respective sections, and the weekly button 262, the monthly button 263, and the yearly button 264 may be buttons for changing the length of the section.

The screen 280 may include change buttons 282 and 283 for changing a week or a day to be displayed. For example, when a right button 283 is selected, the week may be changed or bar graphs of two days may disappear and bar graphs of nine days may appear.

Further, the screen 280 may include information 286 displaying the week, a weekly target energy usage amount 287, and a weekly actual energy usage amount 288. The information is text information (representing a concept including numerical figures). The screen 280 may further include an energy usage amount button 266 selected for viewing the energy usage amount and a usage time button 267 selected for viewing a usage time. The screen 280 may further include a target button 289 for selecting a screen for comparing a target usage amount and an actual accumulated usage amount, and a last year button 290 for comparing a past usage amount and the actual accumulated usage amount. For example, a screen displayed when the target button 289 is selected is illustrated in FIG. 33.

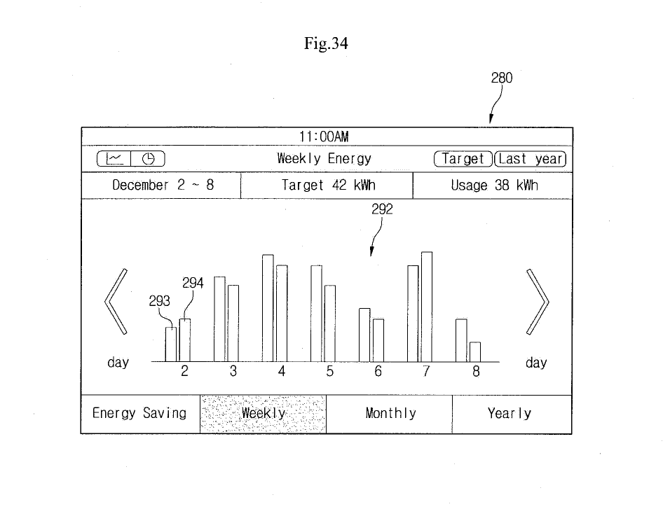

FIG. 34 illustrates a screen displayed when a last year button is selected on the screen of FIG. 33. Referring to FIG. 34, when the last year button 290 is selected on the screen 280 of FIG. 33, the controller 4 may display an image 292 for showing a preset energy usage amount and a last-year energy usage amount on the screen 280 at the same time.

The image 292 may include a plurality of present bar graphs 294 displaying the energy usage amount for each day and a plurality of past bar graphs 293 displaying an energy usage amount in the same week of a previous year. That is, both the present bar graph 294 and the past bar graph 293 may be displayed for each day. In this case, the display line 285 displaying the target usage amount may disappear on the screen 280 of FIG. 34.

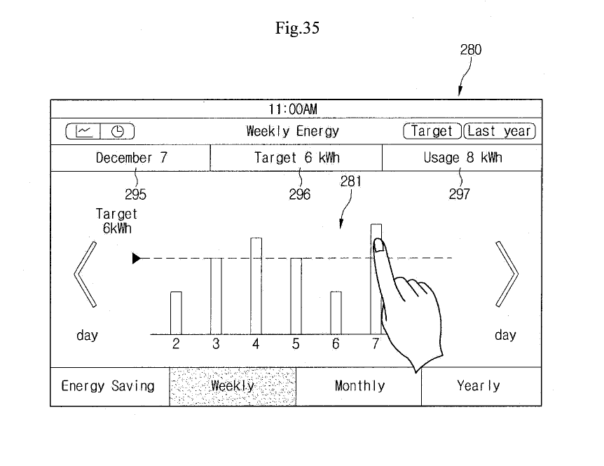

FIG. 35 illustrates a screen displayed when a specific day is touched on the screen displayed in FIG. 33. As the first image 281 is an image for comparing the target usage amount and the actual accumulated usage amount on the screen of FIG. 33, the user may touch the specific day on the screen 280 in order to accurately verify the energy usage amount of the specific day.

When the specific day (for example, a seventh day) is selected on the screen 280 displayed in FIG. 33, the screen 280 may display a selected day 295, a target energy usage amount 296, and an actual accumulated usage amount 297 of the selected day.

In FIGS. 33 to 35, the screen 280 may display the images 281 and 292 including the bar graphs, but alternatively, may display an image including a broken-line graph. Further, in FIG. 33, if the target usage amount and the energy usage amount for each day during a specific period may be intuitively compared with each other, a type of the image is not limited. In FIG. 34, if a past energy usage amount and the energy usage amount for each day during the specific period may be intuitively compared with each other, the type of the image is not limited.

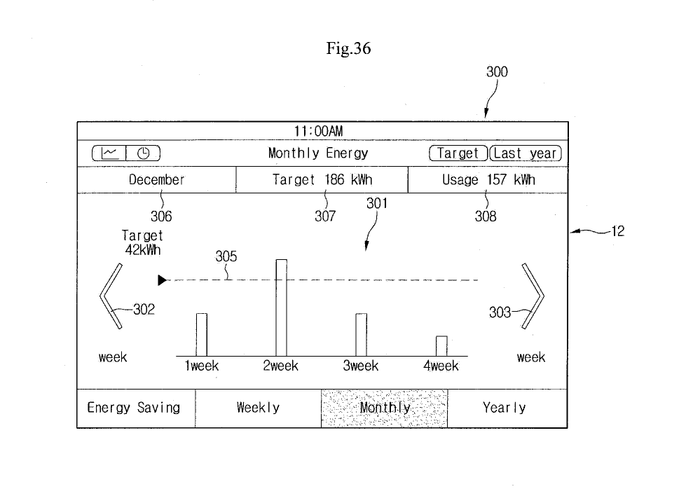

FIG. 36 illustrates a screen displayed when a monthly button is selected on the screen of FIG. 33. Referring to FIG. 36, when the monthly button 263 is selected on the screen of FIG. 33, the controller 4 may display a screen 300 for monitoring a monthly energy usage amount on the touch screen display 3. The screen 300 may display a monthly usage amount image 301 showing the energy usage amount for each week and a display line 305 displaying a weekly target usage amount.

The monthly usage amount image 301 may include a plurality of bar graphs displaying an energy usage amount for each week or for each period selected by the user. The bar graphs may be vertically oriented, and a height, the length, or size of the bar graphs may be changed according to the energy usage amount for each week. The display line 305 may be a horizontal line. The color of the bar graphs may be changed according to a result of comparison of the weekly target usage amount and the energy usage amount for each week. The controller 4 may compare the energy usage amount for each week and the weekly target usage amount, and may differently display the color, the size, or the length of the energy usage amount for each week according to the comparison result.

The screen 300 may include change buttons 302 and 303 for changing a week or a day to be displayed. For example, when a right button 303 is selected, the month may be changed or bar graphs of four weeks may disappear and bar graphs of five weeks or one week of a next month may appear.

Further, the screen 300 may include information 306 displaying the month, a monthly target energy usage amount 307, and a monthly actual energy usage amount 308.

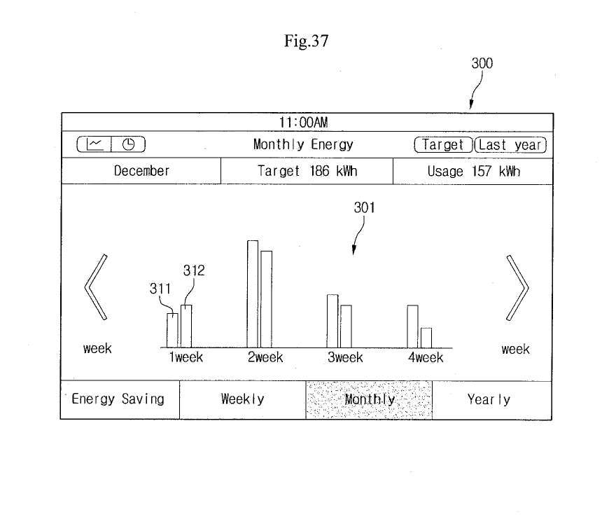

FIG. 37 illustrates a screen displayed when a last year button is selected on the screen of FIG. 36. Referring to FIG. 37, when the last year button 290 is selected on the screen 300 of FIG. 36, the controller 4 may display an image 310 for showing a preset energy usage amount and a last year energy usage amount on the screen 300 at the same time.

The image 310 may include a plurality of present bar graphs 312 displaying the energy usage amount for each week and a plurality of past bar graphs 311 displaying an energy usage amount in the same week of a previous year. That is, both the present bar graph 312 and the past bar graph 311 may be displayed for each week. In this case, the display line 305 displaying the target usage amount may disappear on the screen 300 of FIG. 37.

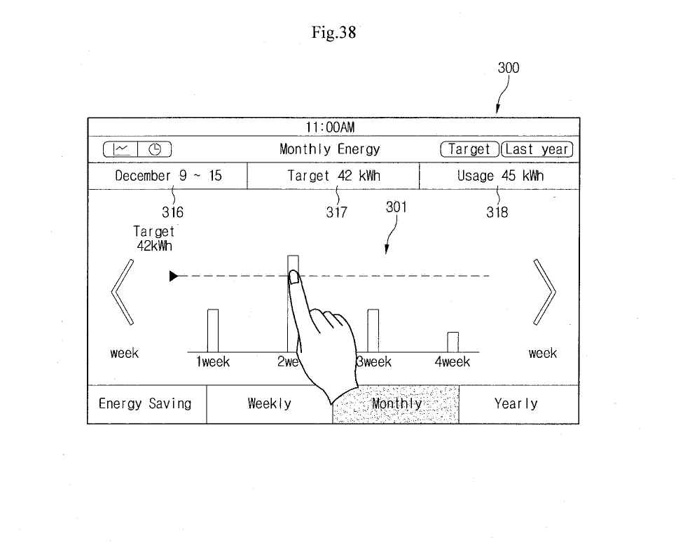

FIG. 38 illustrates a screen displayed when a specific day is touched on the screen displayed in FIG. 36. As the first image 301 is an image for comparing the target usage amount and the actual accumulated usage amount on the screen of FIG. 36, the user may touch the specific week on the screen 300 in order to accurately verify the energy usage amount of the specific week.

When the specific week (for example, a second week) is selected on the screen 300 displayed in FIG. 36, the screen 300 may display a selected week 306, a target energy usage amount 317, and an actual accumulated usage amount 318 of the selected week.

In FIGS. 36 to 38, the screen 300 may display the images 301 and 310 including the bar graphs, but alternatively, may display an image including a broken-line graph. Further, in FIG. 36, if the target usage amount and the energy usage amount for each week during a specific period may be intuitively compared with each other, a type of a displayed image is not limited. In FIG. 37, if the past energy usage amount and the energy usage amount for each week during the specific period may be intuitively compared with each other, the type of the displayed image is not limited.

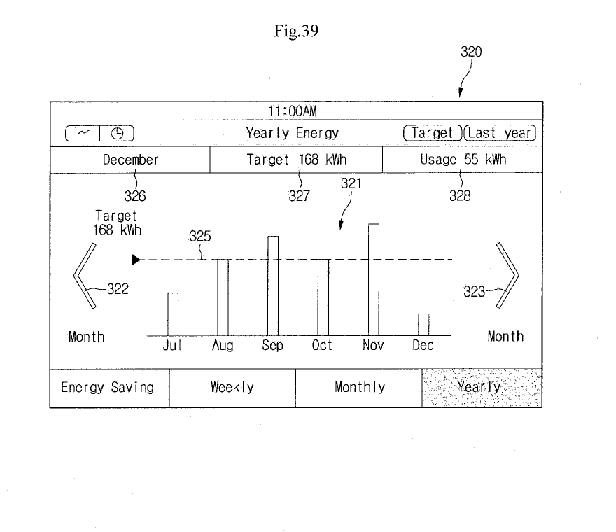

FIG. 39 illustrates a screen displayed when a yearly button is selected on the screen of FIG. 33. Referring to FIG. 39, when the yearly button 264 is selected on the screen of FIG. 33, the controller 4 may display a screen 320 for showing a yearly energy usage amount on the touch screen display 3. The screen 320 may display a yearly usage amount image 301 showing the yearly energy usage amount and a display line 325 displaying a monthly target usage amount.

The yearly usage amount image 321 may show an energy usage amount for 6 months in recent years. Of course, energy usage amounts for 12 months may be shown according to a size or configuration of the screen 320.

The yearly usage amount image 321 may include a plurality of bar graphs displaying an energy usage amount for each month. The bar graphs may be vertically oriented, and a height, length, or size of the bar graphs may be changed according to the energy usage amount for each month. The display line 325 may be a horizontal line. The color of the bar graphs may be changed according to a result of comparison of the monthly target usage amount and the energy usage amount for each month.

The controller 4 may compare the energy usage amount for each month and the monthly target usage amount, and may differently display the color, the size, or the length of the energy usage amount for each month according to the comparison result.

The screen 320 may include change buttons 322 and 323 for changing a year or a month to be displayed. For example, when a right button 323 is selected, the year may be changed or a bar graph of July may disappear and a bar graph of January may appear.

Further, the screen 320 may include information 326 displaying the month, a monthly target energy usage amount 327, and a monthly actual energy usage amount 328. For example, if the month is not changed by the change buttons 322 and 323, the information 326 displaying the month may display a present month.

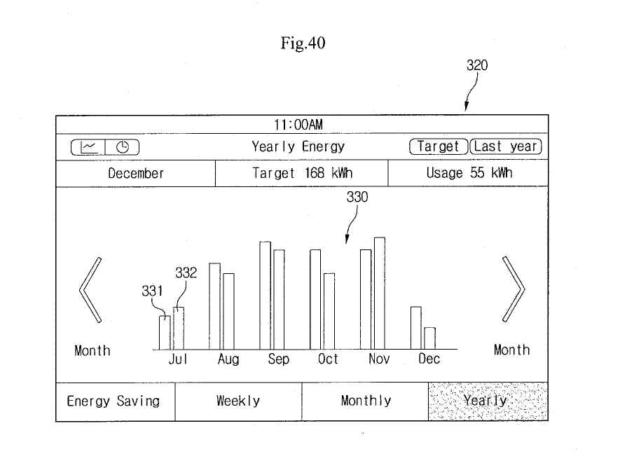

FIG. 40 illustrates a screen displayed when a last year button is selected on the screen of FIG. 39. Referring to FIG. 40, when the last year button 290 is selected on the screen 320 of FIG. 39, the controller 4 may display an image 330 for showing a preset energy usage amount and a last year energy usage amount on the screen 320 at the same time.

The image 330 may include a plurality of present bar graphs 332 displaying the energy usage amount for each month and a plurality of past bar graphs 331 displaying an energy usage amount in the same month of a previous year. That is, both the present bar graph 332 and the past bar graph 331 may be displayed for each month. In this case, the display line 325 displaying the target usage amount may disappear on the screen 320 of FIG. 40.

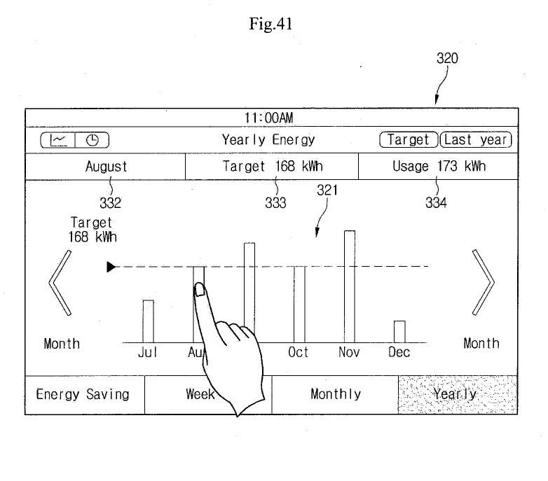

FIG. 41 illustrates a screen displayed when a specific day is touched on the screen displayed in FIG. 39. The user may touch a specific month on the screen 320 in order to accurately verify energy usage amounts of remaining months other than the present month. When the specific month (for example, August) is selected on the screen 320 displayed in FIG. 39, the screen 320 may display a selected month 332, a target energy usage amount 333, and an actual accumulated usage amount 334 of the selected week.

In FIGS. 39 to 41, the screen 320 displays the images 321 and 330 including the bar graphs, but alternatively, may display an image including a broken-line graph. Further, in FIG. 39, if the target usage amount and the energy usage amount for each month during a specific period may be intuitively compared with each other, the type of the displayed image is not limited. In FIG. 40, if the past energy usage amount and the energy usage amount for each month during the specific period may be intuitively compared with each other, the type of the displayed image is not limited.

FIGS. 33 to 41 illustrates a screen for showing the energy usage amount, but even when the usage time button 267 is selected, a screen for showing a usage time in the same pattern as FIGS. 33 to 41 may be displayed on the touch screen display. Accordingly, information including the energy usage amount and the usage time may be called usage information, and each of the energy usage amount and the usage time may be called a usage value.

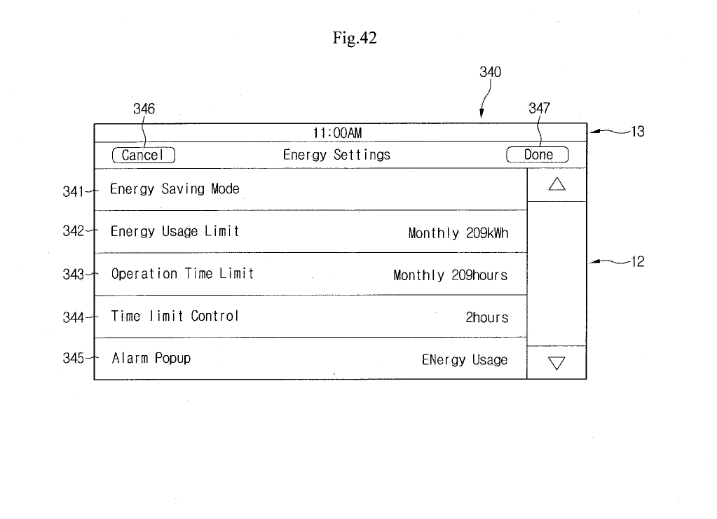

FIG. 42 illustrates a screen displayed when a set-up button is selected in FIG. 30 or 32. Referring to FIG. 42, when the set-up buttons 265 or 275 are selected on the screen 250 of FIG. 30 or the screen 270 of FIG. 32, respectively, the controller 4 may display a screen 340 for setting energy on the touch screen display 3.

The screen 340 may include an energy saving mode button 341 for selecting an energy saving mode, an energy usage limit button 342 for selecting or setting an energy usage limit function, an operation time limit button 343 for selecting or setting an operation time limit function, a time limit control button 344 for selecting or setting a time limit control function, and an alarm popup button 344 for selecting an alarm popup.

The energy saving mode is a mode for saving energy. When the energy saving mode is turned on, one or more components of the HVAC system may be controlled by a control parameter set for energy saving. That is, when the energy saving mode is turned on, as one or more components of the HVAC system are operated within a limited control parameter range, the energy usage limit function may be achieved.

The energy usage limit function is a function for limiting energy usage. When the energy usage limit function is turned on, an alarm may occur on the touch screen display 3 in the case where the energy usage amounts of one or more components of the HVAC system reach a set energy usage amount.

The operation time limit function is a function for limiting an operation time of one or more components of the HVAC system. When the operation time limit function is turned on, the alarm may occur on the touch screen display 3 in the case where the operation time of one or more components of the HVAC system reach a set operation time.

The time limit control function is a function for setting an off time of one or more components of the HVAC system. When the time limit control function is turned on, the controller 4 turns off one or more components of the HVAC system in the case where one or more components are turned on and a set limited time elapses.

The screen 340 may further include a cancel button 346 and a done button 347.

The energy usage limit button 342 may display a set limited usage amount, and each of the operation time limit button 343 and the time limit control button 344 may include a set limit time. The alarm popup button 344 may include a type of a popup-on function. A function which may pop up is the energy usage limit function or the operation time limit function.

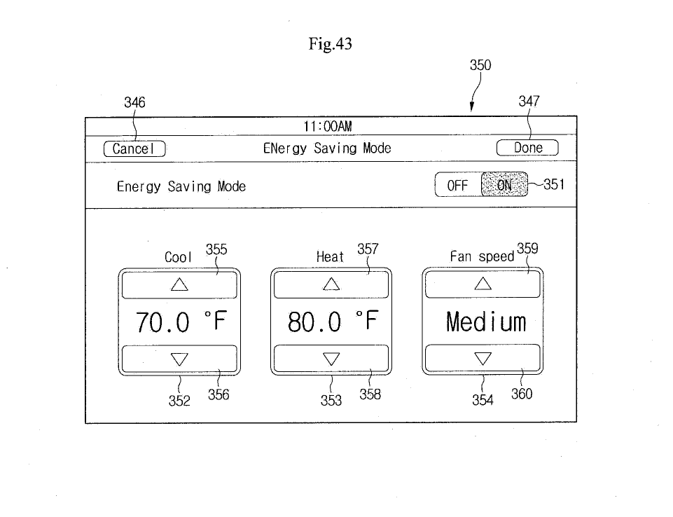

FIG. 43 illustrates a screen displayed when an energy saving mode button is selected in FIG. 42. Referring to FIG. 43, when the energy saving mode button 341 is selected on the screen 340 of FIG. 42, the controller 4 may display a screen 350 for setting a control parameter for the energy saving mode on the touch screen display 3. The screen 350 may include an on/off button 351 for turning on or off the energy saving mode.

The screen 350 may include a cooling temperature set-up block 352 for setting a temperature in a cooling mode, a heating temperature set-up block 353 for setting a temperature in a heating mode, and a fan speed set-up block 354 for setting a fan speed. The set-up blocks 352, 353, and 354 may include up buttons 355, 357, and 359 and down buttons 356, 358, and 360, respectively.

The screen 350 may display the respective set-up blocks 352, 353, and 354 when the energy saving mode is turned on by the on/off button 351. When the energy saving mode is turned off by the on/off button 351, the screen 350 may not display the respective set-up blocks 352, 353, and 354 or may display the respective set-up blocks 352, 353, and 354, but may inactivate the respective set-up blocks 352, 353, and 354.

While one or more components of the HVAC system are cooling-operated, when the energy saving mode is turned on, one or more components of the HVAC system may be operated to satisfy a set cooling temperature and a set fan speed in the cooling temperature set-up block 352.

Further, while one or more components of the HVAC system are heating-operated, when the energy saving mode is turned on, one or more components of the HVAC system are operated to satisfy a set heating temperature and a set fan speed in the heating temperature set-up block 353.

The screen 350 may further include a cancel button 346 and a done button 347. When the cancel button 346 is selected, the screen 350 may be switched to the screen 340 of FIG. 42. When the done button 347 is selected, the set control parameter may be stored in the memory 5 and the screen 350 may be switched to the screen 340 of FIG. 42.

The temperature and the fan speed set on the screen of FIG. 43 may be limit parameters.

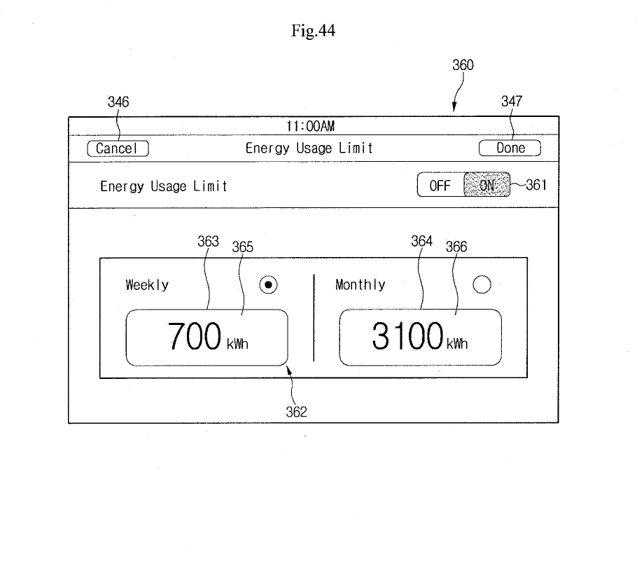

FIG. 44 illustrates a screen displayed when an energy usage limit button is selected in FIG. 42. Referring to FIG. 44, when the energy usage limit button 342 is selected on the screen 342 of FIG. 42, the controller 4 may display a screen 360 for setting a control parameter for the energy usage limit function on the touch screen display 3.

The screen 360 may include an on/off button 361 for turning on or off the energy usage limit function. The screen 360 may further include a limit usage amount set-up button 362 for setting an energy usage amount. The limit usage amount set-up button 362 may include a weekly set-up button 363 (first section button) for setting a weekly limit usage amount and a monthly set-up button 364 (second section button) for setting a monthly limit usage amount. The weekly set-up button 363 may include a weekly limit setting amount 365 and the monthly set-up button 364 includes a monthly limit setting amount 366.

The screen 360 may display the usage amount set-up button 362 when the energy usage limit function is turned on by the on/off button 361. The screen 360 may not display the usage amount set-up button 362, or may display the usage amount set-up button 362, but may inactivate the usage amount set-up button 362 when the energy usage limit function is turned off by the on/off button 361.

After any one of the weekly set-up block 363 or the monthly set-up button 364 is selected, the usage amount may be set by selecting the usage amount in the corresponding button.

The screen 360 may further include a cancel button 346 and a done button 347. When the cancel button 346 is selected, the screen 360 may be switched to the screen 340 of FIG. 42. When the done button 347 is selected, the set control parameter may be stored in the memory 5 and the screen 360 may be switched to the screen 340 of FIG. 42.

A limit setting amount set in FIG. 44 may be called a limit parameter.

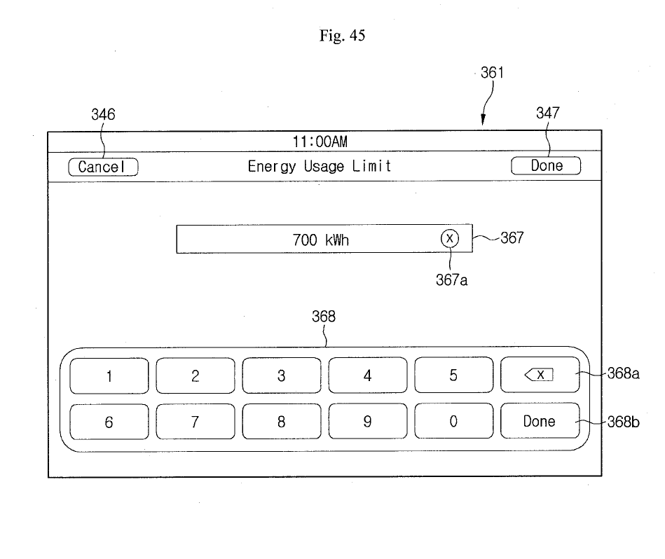

FIG. 45 illustrates a screen for setting a weekly limit usage amount for an energy usage limit function. Referring to FIG. 45, when, for example, the weekly limit usage amount 365 is selected on the screen of FIG. 44, the controller 4 may display a screen 361 for inputting a limit usage amount on the touch screen display 3.

The screen 361 may display a keypad 368 for setting the weekly limit usage amount and usage amount information 367 displaying the limit usage amount input by the keypad 368. The keypad 368 may include a plurality of number buttons, a modification button 368a, and an input done button 368b. The usage amount information 367 may include a deletion button 367a for deleting the set limit usage amount.

When the monthly limit setting amount 366 is selected on the screen of FIG. 44, the screen 360 may display a keypad for the monthly limit usage amount and usage amount information displaying the limit usage amount input by the keypad.

The screen 361 may further include a cancel button 346 and a done button 347. When the cancel button 346 is selected, the screen 361 may be switched to the screen 360 of FIG. 44. When the done button 347 is selected, the set limit usage amount may be stored in the memory 5 and the screen 361 may be switched to the screen 360 of FIG. 44.

The limit setting amount set in the screens of FIGS. 44 and 45 may be called a limit parameter.

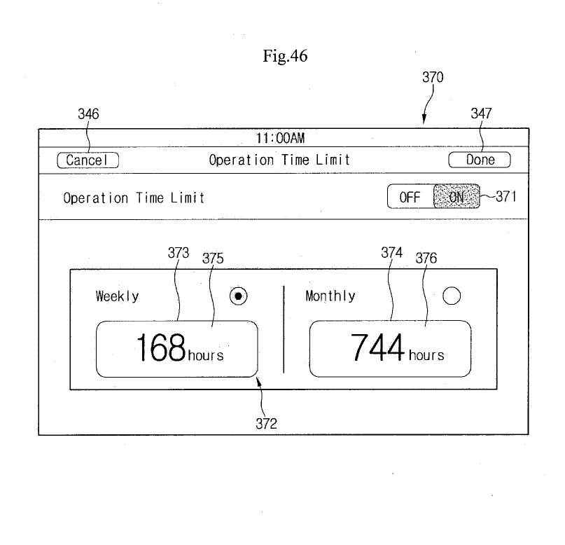

FIG. 46 illustrates a screen displayed when an operating time limit button is selected in FIG. 42. Referring to FIG. 46, when the operation time limit button 343 is selected on the screen 340 of FIG. 42, the controller 4 may display a screen 370 for setting a control parameter for the energy usage limit function on the touch screen display 3.

The screen 370 may include an on/off button 371 for turning on or off the operation time limit function. The screen 370 may further include a limit time set-up button 372 for setting a limit time. The limit time set-up button 372 may include a weekly set-up button 373 (first section button) for setting a weekly limit time and a monthly set-up button 374 (second section button) for setting a monthly limit time. The weekly set-up button 373 may include a weekly limit time 375, and the monthly set-up button 364 may include a monthly limit time 376.

The screen 370 may display the limit time set-up button 372 when the operation time limit function is turned on by the on/off button 371. The screen 370 may not display the limit time set-up button 372, or may display the limit time set-up button 372, but may inactivate the limit time set-up button 372 when the operation time limit function is turned off by the on/off button 371.

After any one of the weekly set-up block 373 or the monthly set-up button 374 is selected, the limit time may be set by selecting the time in the corresponding button.

The screen 370 may further include a cancel button 346 and a done button 347.

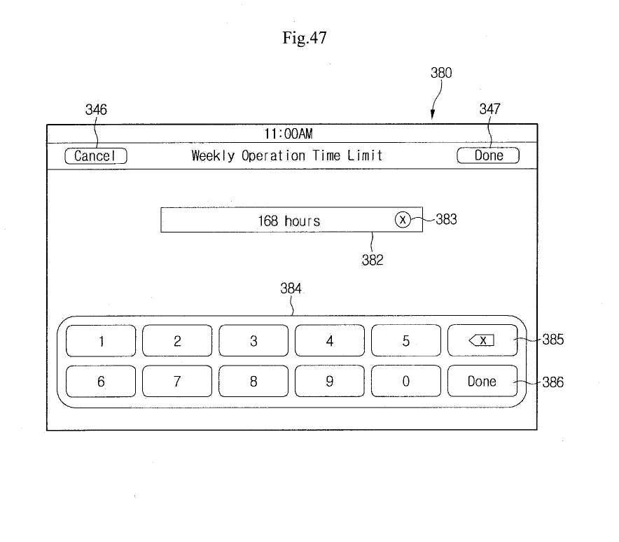

FIG. 47 illustrates a screen for setting a weekly limit time for an operation time limit function. Referring to FIG. 47, when, for example, the weekly limit time 375 is selected on the screen of FIG. 46, the controller 4 may display a screen 380 for inputting a limit time on the touch screen display 3.

The screen 380 may display a keypad 384 for setting the weekly limit time and limit time information 382 displaying the limit time input by the keypad 384. The keypad 384 may include a plurality of number buttons, a modification button 385, and an input done button 386b. The usage limit information 382 may include a deletion button 383 for deleting a set usage amount.

When the monthly limit setting amount 376 is selected on the screen of FIG. 46, the screen 380 may display a keypad for setting the limit time and limit time information displaying the limit time input by the keypad.

The screen 380 may further include a cancel button 346 and a done button 347. When the cancel button 346 is selected, the screen 380 may be switched to the screen 370 of FIG. 46. When the done button 347 is selected, the set limit time may be stored in the memory 5 and the screen 370 may be switched to the screen 370 of FIG. 46.

The limit time set in the screens of FIGS. 46 and 47 may be called a limit parameter.

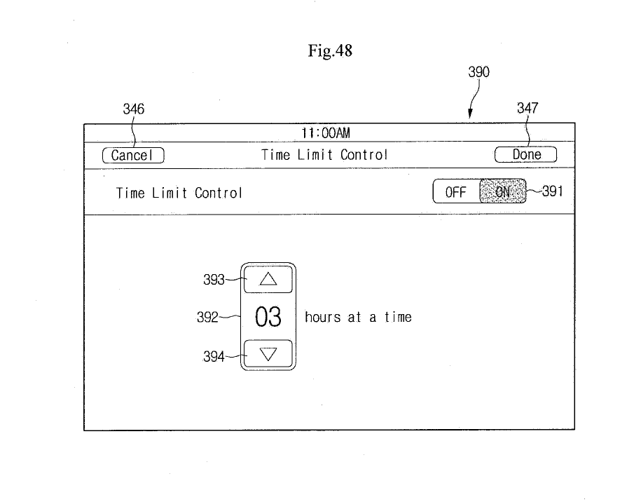

FIG. 48 illustrates a screen displayed when a time limit control button is selected in FIG. 42. Referring to FIG. 48, when the time limit control button 344 is selected on the screen 340 of FIG. 42, the controller 4 may display a screen 390 for setting a control parameter for the time limit control function on the touch screen display 3.

The screen 390 may include an on/off button 391 for turning on or off the time limit control function. The screen 390 may further include a time set-up button 392 for setting an off time. The time set-up button 392 may include an up button 393 and a down button 394. When the up button 393 may be touched, the time is increased and when the down button 394 is touched, the time may be decreased.

The screen 390 may display the time set-up button 392 when the time limit control function is turned on by the on/off button 391. The screen 390 may not display the time set-up button 392, or may display the time set-up button 392, but may inactivate the time set-up button 392 when the time limit control function is turned off by the on/off button 391.

The screen 390 may further include a cancel button 346 and a done button 347. When the cancel button 346 is selected, the screen 390 may be switched to the screen 340 of FIG. 42. When the done button 347 is selected, a set off time may be stored in the memory 5 and the screen 390 may be switched to the screen 340 of FIG. 42.

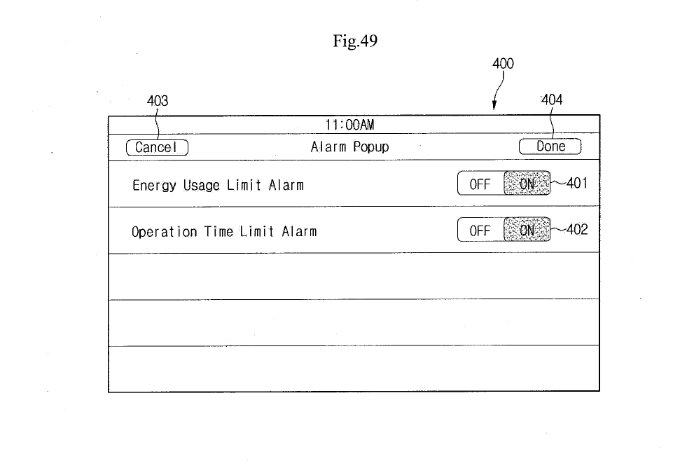

FIG. 49 illustrates a screen displayed when a pop-up alarm button is selected in FIG. 42. Referring to FIG. 49, when the pop-up alarm button 345 is selected on the screen 340 of FIG. 42, the controller 4 may display a screen 400 for setting a pop-up alarm function on the touch screen display 3.

The screen 400 may include an on/off button 401 for turning on/off an alarm for the energy usage limit function and an on/off button 410 for turning on/off an alarm for the operation time limit function. The respective alarms may be simultaneously turned on or off and only any one alarm may be turned on.

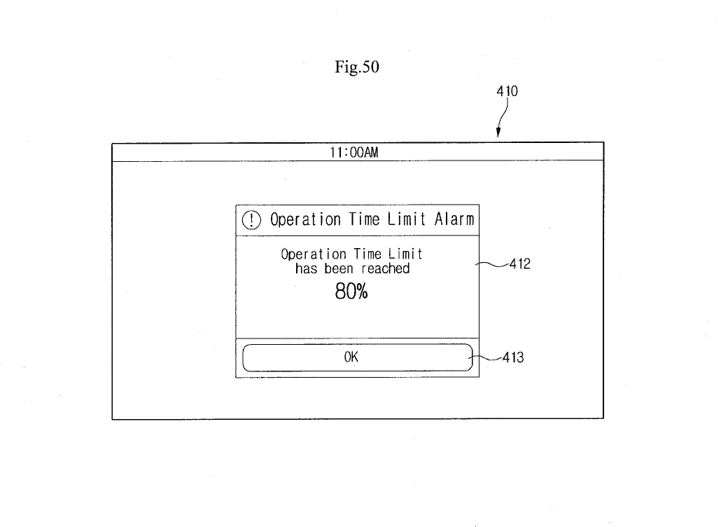

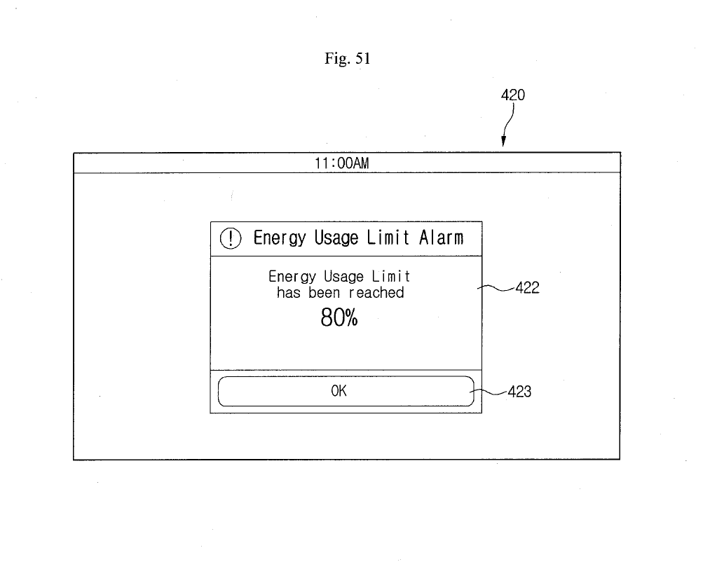

FIG. 50 illustrates a screen on which alarm information pops up in a state where an alarm for the operating time limit function is on. FIG. 51 illustrates a screen on which the alarm information pops up in a state where an alarm for the energy usage limit function is on.

Referring to FIG. 50, when the operation time limit function is turned on and an alarm function is turned on, the controller 4 may compare an actual usage time of one or more components of the HVAC system and a set limit time. In addition, when a ratio of the actual usage time to the set limit time reaches a reference ratio, the controller 44 may display a screen 410 including the pop-up information 412. The pop-up information 412 may include a text message.

Further, the pop-up information 412 may include an OK button 413. When the OK button 413 is selected, the screen 410 may be switched to a previously displayed screen. Alternatively, when a predetermined time during which the screen 410 including the pop-up information 412 is displayed elapses, the screen 410 may be switched to the previously displayed screen. In this case, as only the pop-up information 412 pops up on the previously displayed screen, only the pop-up information may disappear.

In this case, the reference ratio may include one or a plurality of ratios. When the plurality of reference ratios are set, whenever the ratio of the actual usage time to the set limit time reaches each reference ratio, the controller 4 may display the screen 410 including the pop-up information 412.

Next, referring to FIG. 51, when the energy usage limit function is turned on and the alarm function is turned on, the controller 4 may compare actual usage amounts time of one or more components of the HVAC system and a limit usage amount. In addition, when a ratio of the actual usage amount to the set limit usage amount reaches a reference ratio, the controller 4 may display a screen 422 including the pop-up information 422. The pop-up information 422 may include a text message.

Further, the pop-up information 422 may include an OK button 423. When the OK button 423 is selected, the screen 420 may be switched to a previously displayed screen. Alternatively, when a predetermined time during which the screen 420 including the pop-up information 422 is displayed elapses, the screen 420 may be switched to the previously displayed screen. In this case, as only the pop-up information 422 pops up on the previously displayed screen, only the pop-up information may disappear.

In this case, the reference ratio may include one or a plurality of ratios. When the plurality of reference ratios are set, whenever the ratio of the actual usage amount to the set limit usage amount reaches each reference ratio, the controller 4 may display the screen 4202 including the pop-up information 422.

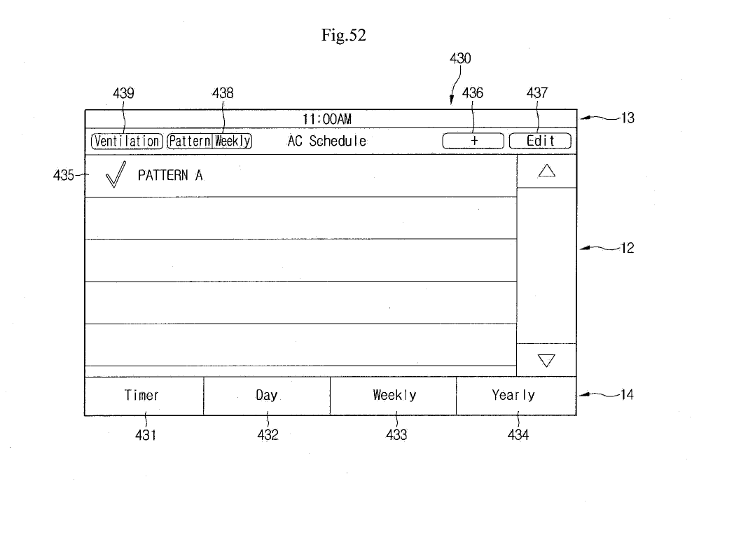

FIGS. 52 to 89 illustrate screens for creating or changing a schedule.

FIG. 52 illustrates a screen displayed when a schedule button is selected on the screen of FIG. 4 or 5. Referring to FIG. 52, when the schedule button 62 is selected on the screen 10 of FIG. 4 or 5, the controller 4 may display a screen 430 for creating or changing the schedule on the touch screen display 3.

The screen 430 may include a first region 12, a second region 13, and a third region 14. The first region 12 may display a pattern button 435 for selecting a schedule pattern. Further, the first region 12 may display an add button 436 for creating the schedule pattern and an edit button 437 for changing the created schedule pattern. Further, the first region 12 may display a button 438 for selecting the schedule pattern and a weekly schedule, and a ventilation button 439 for setting a schedule for a ventilation device.

The third region 14 may include a timer button 431 for providing a timer function, a daily button 432 for setting a schedule for each day, a weekly button 433 for setting a weekly schedule, and a yearly button 434 for setting a yearly schedule. The buttons displayed in the third region 14 may be buttons for selecting a schedule type.

When all of the pattern buttons are not displayed in the first region 12, the first region 12 may display a scroll button or a scroll bar for the non-displayed pattern button.

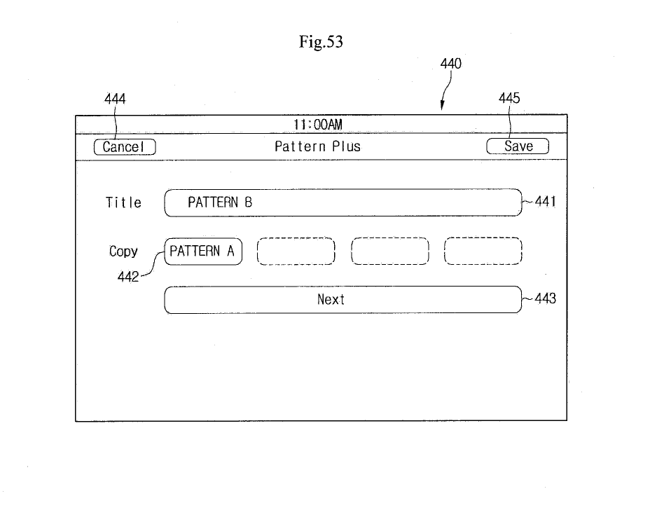

FIG. 53 illustrates a screen displayed when the add button is selected on a screen of FIG. 52. Referring to FIG. 53, when the add button 436 is selected on the screen 430 of FIG. 52, the controller 4 may display a screen 440 for adding a pattern on the touch screen display 3.

The screen 440 may display pattern name information 441, stored pattern name information 442, and a next button 443 for moving to a next step. Further, the screen 440 may further include a cancel button 444 and a save button 445.

When the screen 430 is switched to the screen 440 of FIG. 53, the controller 4 may automatically create a pattern name of a next sequence based on the stored pattern name information 442 and display the created pattern name in the pattern name information 441. For example, when the stored pattern name is “Pattern A”, the controller 4 may display “Pattern B” which is a next sequence based on an alphabet in the pattern name information 441.

When the user selects any one of the stored pattern name information 442, a set parameter may be copied to the selected pattern name information 442 to be just applied to a pattern to be newly created. For example, when the stored pattern name information 442 is selected and the save button 445 is selected, “Pattern B” displayed in the pattern name information 441 may be stored in the memory 5 and the same content as the parameter set in the set pattern name information 442 set in the past may be matched to “Pattern B” to be stored.

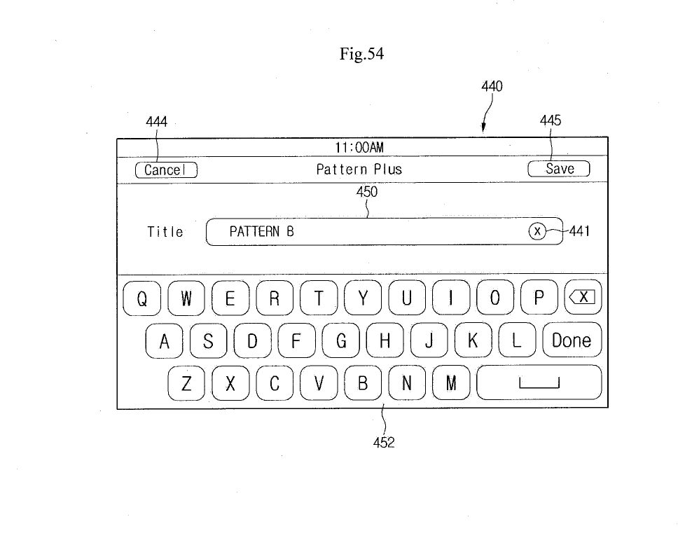

FIG. 54 illustrates an example of a screen for inputting a pattern name. Referring to FIG. 54, when the pattern name 441 is selected on the screen 440 of FIG. 53, the screen 440 may display a keypad 452 for inputting a pattern name.

The screen 440 may display pattern name information 450 displaying information on the input pattern name. The pattern name information 450 may include a deletion button 441 for deleting the input pattern name.

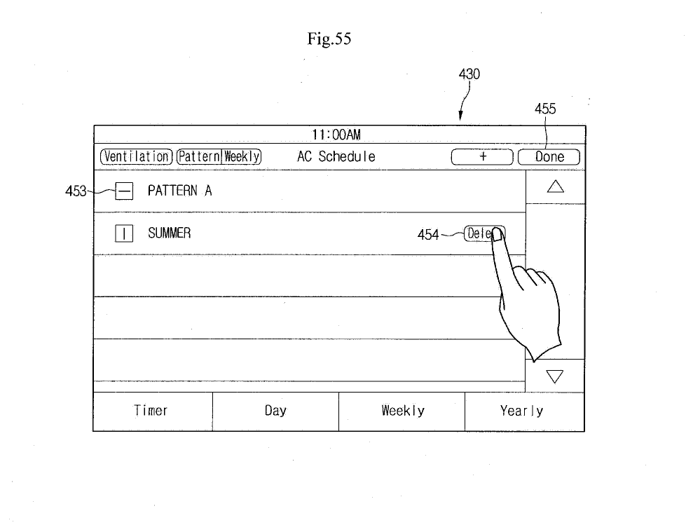

FIG. 55 illustrates an example of a screen for deleting a stored pattern. Referring to FIG. 55, the user may select the edit button 437 on the screen of FIG. 52 in order to delete any one of one or more buttons displayed on the screen 430.

When the edit button 437 is selected, the screen 430 may display a select button 453 for selecting deletion for each pattern button. When the user touches the select button 453, the touched pattern button may display a delete button 454. In addition, when the user selects the delete button 454, a parameter set in the selected pattern button may be deleted from the memory 5 and disappear on the screen 430.

The screen 430 may further display a done button 455.

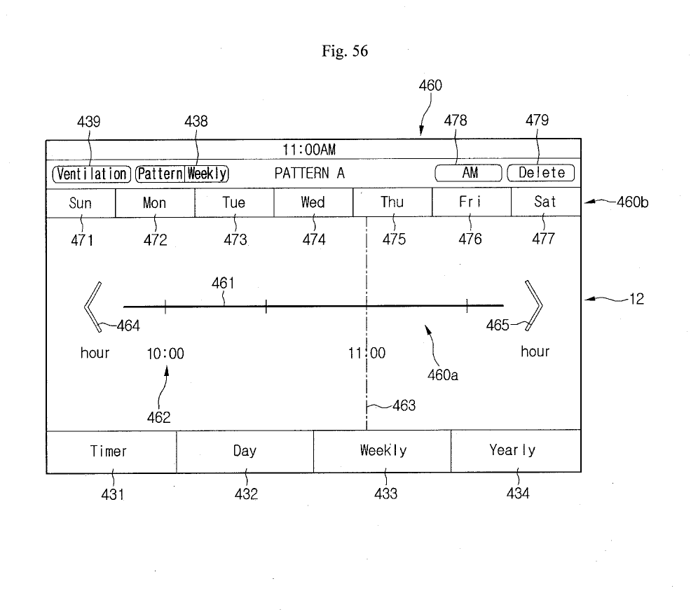

FIGS. 56 to 66 illustrate a screen for setting a weekly schedule in a first display mode.

FIG. 56 illustrates an example of the screen for setting the weekly schedule. Referring to FIG. 56, although not limited thereto, when the weekly button 433 is selected on the screen 430 of FIG. 52 or the next button 443 is selected on the screen 440 of FIG. 53, the controller 4 may display a screen 460 for setting the weekly schedule on the touch screen display 3.

The screen 460 may include a first region 12, a second region 13, and a third region 14. The screen 460 may display a first image 460a for selecting a time for setting the schedule in the first region 12. Further, the screen 460 may display a second image 460b for selecting a day of the week and a date in the first region 12.

The first region 12 may display the first image 460a in a first display region and display the second image 460b in a second display region. The screen 460 may further display change buttons 464 and 464 for changing a time.

The first image 460a may include a time axis 461, time information 462, and a present time 463. The present time 463, which may be in the form of a time line, may be displayed on the time axis 461. That is, the first image 460a may display the time axis 461 and the time information 462 including the present time. For example, the time information may be displayed every 1 hour in the first image 460a, but embodiments are not limited thereto, and a display interval of the time information may be set by the user. The time information 462 may include an hour, a date, a day of the week, or a month.

The second image 460b may be positioned on or at an upper side of the first image 460a, but embodiments are not limited thereto, and the second image 460B may be positioned on or at any one side of a lower side and left and right sides. The second image 460b may include a Sunday button 471, a Monday button 472, a Tuesday button 473, a Wednesday button 474, a Thursday button 475, a Friday button 476, and a Saturday button 477. The plurality of day-of-the week buttons may be arranged in parallel to the time axis, for example. Further, an arrangement direction of the plurality of day-of-the week buttons and the time line displaying the present time may cross each other. However, an arrangement order and arrangement positions of the buttons 471 to 477 displayed in the second image 460b are not limited thereto.

The screen 460 may be provided to individually set a schedule for each day of the week. That is, the schedule may be set similarly or differently for each day of the week.

The screen 460 may further display an AM/PM button 478 for selecting AM/PM and a delete button 479 for deleting the schedule.

The controller 4 may display the first image 460a when the day of the week is selected in the second image 460b. Alternatively, the controller 4 may display both the first image 460a and the second image 460b, but may display the present day of the week in the first image 460b and the present time in the first image 460b.

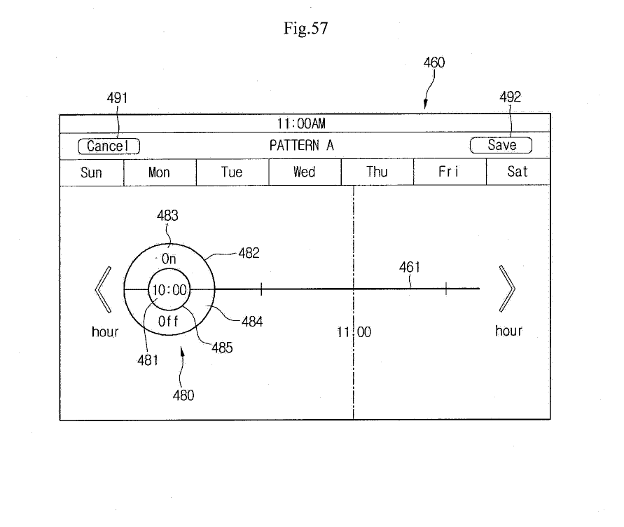

FIG. 57 is a diagram illustrating a screen displayed when a specific time is selected in FIG. 56. FIG. 57 illustrates a screen for setting a start schedule as an event occurrence schedule.

Referring to FIG. 57, when the specific time is selected on the screen 460 of FIG. 56, the screen 460 may additionally display a setting image 480 (may referred to as the second image) for setting an event in a selected time on the first image 460a. The user may select a specific point on the time axis 461 in order to select the specific time.

The setting image 480 may be displayed on the time axis 461. The setting image 480 may include a first setting region 481, and a second setting region 482 surrounding the first setting region 481, for example. Each of the first setting region 481 and the second setting region 482 may have a circular shape.

Alternatively, the first setting region 482 may have a circular shape and the first setting region 481 may have a non-circular shape. Alternatively, each of the first setting region 481 and the second setting region 482 may have a non-circular shape.

The first setting region 481 may display a parameter in a present step among a series of steps for setting the parameter. In FIG. 57, an hour (10 o'clock) may be displayed in the first setting region 481, for example.

When the user intends to complete setting the parameter displayed in the first setting region 481, the user may touch the first setting region 481. Then, a parameter required to be set in a next step may be displayed in the first setting region 481.

The second setting region 482 enables a value of the parameter to be changed, on/off to be determined, or a type of the parameter to be changed, for example. The second setting region 482 may include two divided selection regions 483 and 484. The second setting region 482 may be divided vertically or horizontally according to the type of the parameter. When the second setting region 482 is vertically divided, the second setting region 482 may be divided by the time axis.

The first selection region 483 may be used to select ON and the second selection region 484 may be used to select OFF. When an on or off event is set in a previously set time during setting the schedule, any one region between two selection regions may be activated and the other one region may be deactivated. Of course, both selection regions may be activated. In addition, colors of an on text and an off text on the selection region may be changed depending on a user's selection.

For example, when on is selected, the on text may have a first color and the off text may have a second color. In contrast, when off is selected, the off text may have the first color and the on text may have the second color.

A boundary region 485 between the first setting region 481 and the second setting region 482 may have a color that varies depending on the type of the parameter displayed in the first setting region 481 or disappears on the screen 460, or may be divided into two or more regions.

The screen 460 may further include a cancel button 491 and a save button 492.

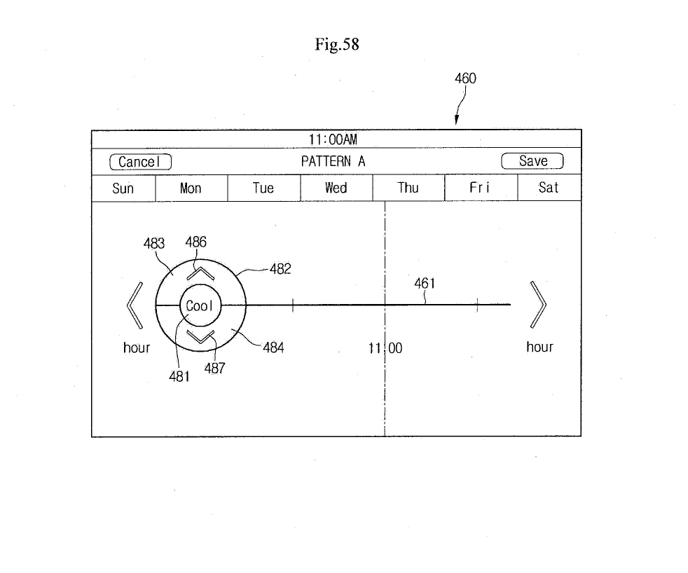

FIG. 58 illustrates a screen for setting a next parameter after time setting is completed in FIG. 57. Referring to FIG. 58, when the time setting is completed on the screen of FIG. 57, that is, when the first setting region 481 is touched, the screen 460 may display operation modes (for example, operation modes of an air conditioner) of one or more components of the HVAC system in the first setting region 481.

Further, the screen 460 may change buttons 486 and 487 for changing a mode in the respective selection regions 483 and 484 of the second setting region 482. The user may change the mode by selecting the change buttons 486 and 487. Alternatively, the screen 460 may display an arrow for guiding selection in order to change the mode in the respective selection regions 483 and 484 of the second setting region 482. In this case, although the user selects a region other than the arrow in the selection regions 483 and 484, the mode may be changed.

A type of the mode which may be displayed in the first setting region 481 depends on the types of one or more components of the HVAC system and may include cooling, heating, blowing, and dehumidifying, for example. In addition, the boundary region 485 may display a color corresponding to the selected mode. In this case, the color of the boundary region 485 and the color of the time axis 461 may be the same as each other. When the color of the time axis 461 varies depending on the mode, the user may intuitively recognize a set mode by verifying only the color of the time axis 461.

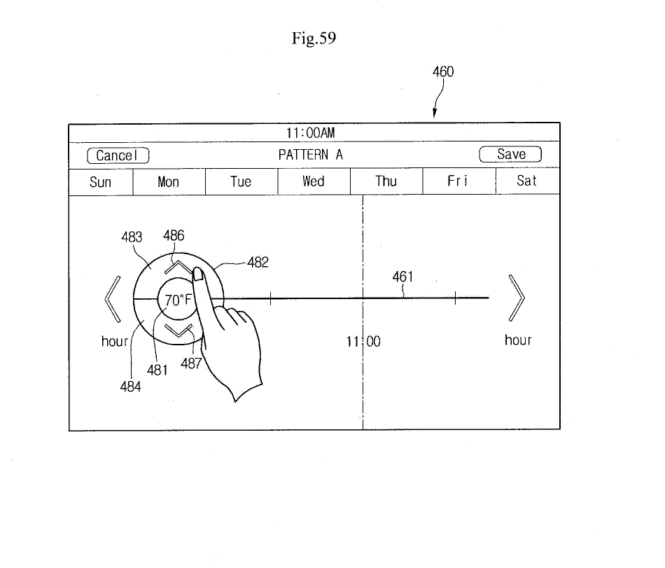

FIG. 59 illustrates a screen for setting a next parameter after the time setting is completed in FIG. 58. Referring to FIG. 59, when the mode setting is completed on the screen of FIG. 58, that is, when the first setting region 481 is touched, the screen 460 may display a target temperature in the first setting region 481.

Further, the screen 460 may display change buttons 486 and 487 for changing the mode in the respective selection regions 483 and 484 of the second setting region 482. The user may change a temperature by selecting the change buttons 486 and 487. Alternatively, the screen 460 may display an arrow for guiding selection in order to change the mode in the respective selection regions 483 and 484 of the second setting region 482. In this case, although the user selects a region other than the arrow in the selection regions 483 and 484, the temperature may be changed.

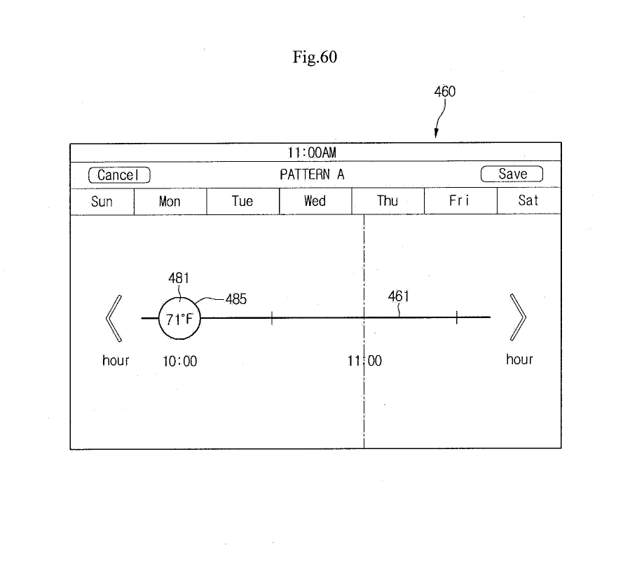

FIG. 60 is a screen displayed when setting the event occurrence schedule is completed in FIG. 59. Referring to FIG. 60, when the setting of the event occurrence schedule is completed, the screen 460 may display the first setting region 481 and the boundary region 485 on the time axis 461. That is, the second setting region 482 may not be displayed on the screen 460. The set target temperature may be displayed in the first setting region 481.

In this case, when schedule setting is completed, the first setting region 481 and the boundary region 485 displayed in the first image 460a may be event display images. The event display image of FIG. 60 is a schedule start image. In addition, as the boundary region 485 may have a color that varies depending on the set mode, the boundary region 485 on the event display image may serves as a mode display region.

Next, the user may set an end schedule as the event occurrence schedule.

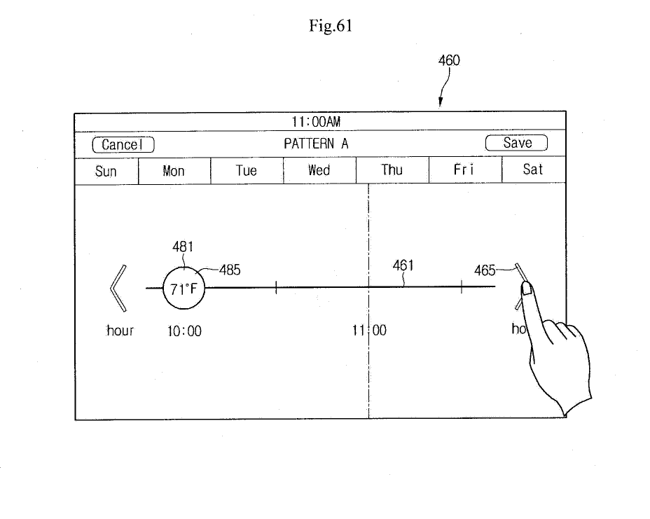

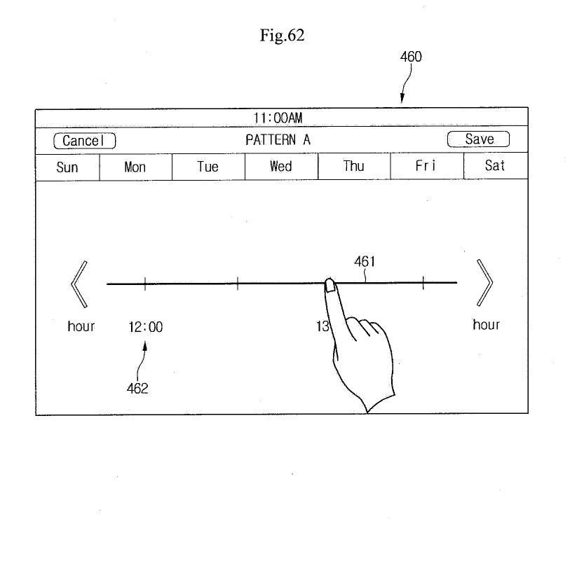

FIGS. 61 and 62 illustrate an example of a screen for setting the end schedule as the event occurrence schedule. Referring to FIGS. 61 and 62, the right change button 465 may be selected in order to change the time, for example. Then, changed time information 462 may be displayed on the screen 460. In this case, time information which is not displayed before selecting the change button 465 may be displayed on the screen 460.

For example, in the case where 10 o'clock and 11 o'clock are displayed on the screen 460 as the time information in FIG. 61, when the change button 465 is selected, the screen 460 may display 12 o'clock and 13 o'clock. In addition, the user may select a specific point on the time axis 461 to select an event end time.

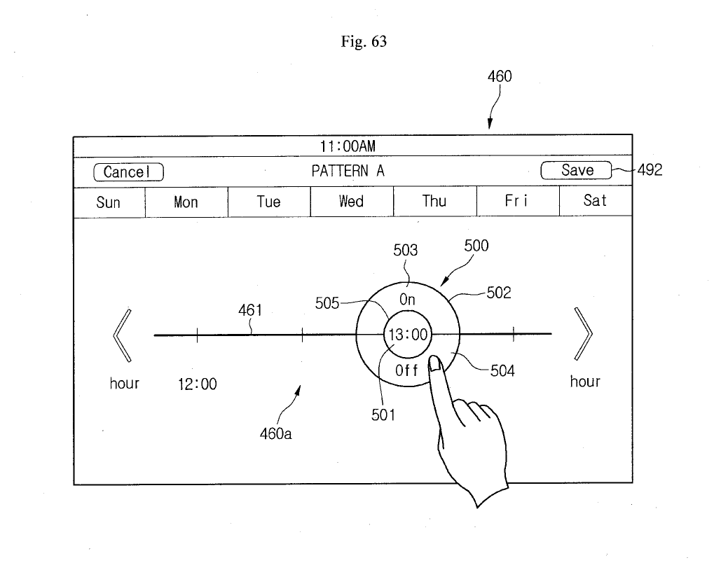

FIG. 63 is a diagram illustrating a screen displayed when a specific time is selected in FIG. 62. Referring to FIG. 63, when a specific time is selected on the screen 460, the screen 460 may display a setting image 500 for setting an event in a selected time on the first image 460a.

The setting image 500 may be displayed on the time axis 461. The setting image 500 may include a first setting region 501 and a second setting region 502 surrounding the first setting region 501, for example. The first setting region 501 may display a parameter in a present step among a series of steps for setting the parameter. In FIG. 63, an hour (13 o'clock) may be displayed in the first setting region 501, for example. Alternatively, when setting one parameter is required, the first setting region 501 may display the time.

When the user intends to complete setting the parameter displayed in the first setting region 501, the user may touch the first setting region 501. The second setting region 502 may enable a value of the parameter to be changed, on/off to be determined, and a type of the parameter to be changed, for example.

The second setting region 502 may include two divided selection regions 503 and 504. The second setting region 504 may be divided vertically or horizontally according to the type of the parameter. The first selection region 503 may be used to select ON and the second selection region 504 may be used to select OFF.

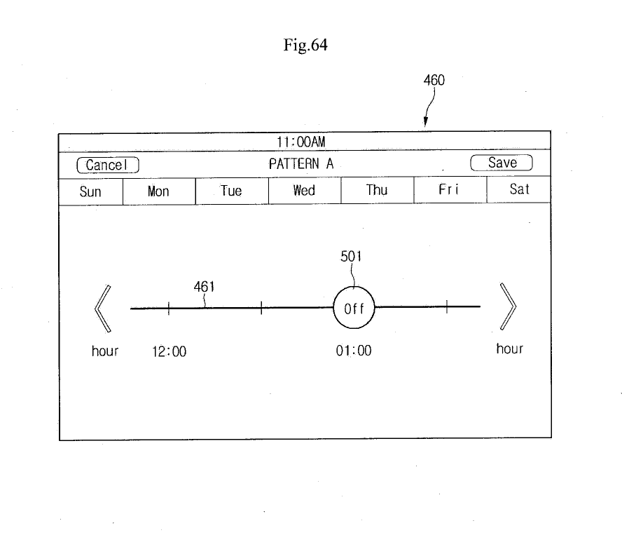

FIG. 64 is a screen displayed when setting the event occurrence schedule is completed in FIG. 63. Referring to FIG. 64, after on/off setting is completed, when the save button 492 may be selected, the setting of the event occurrence schedule may be completed. When the setting of the event occurrence schedule is completed, the screen 460 may display the first setting region 510 on the time axis 461. That is, the second setting region 502 and the boundary region may not be displayed on the screen 460. Off may be displayed in the first setting region 501.

In this case, the first setting region 501 and the boundary region displayed on the screen 460 may be an event display image when the schedule setting is completed and the event display image of FIG. 64 is a schedule type image.

In summary, the event occurrence schedule includes an event start schedule and an event end schedule and the respective schedules may be displayed on the time axis as an event star image and an event end image.

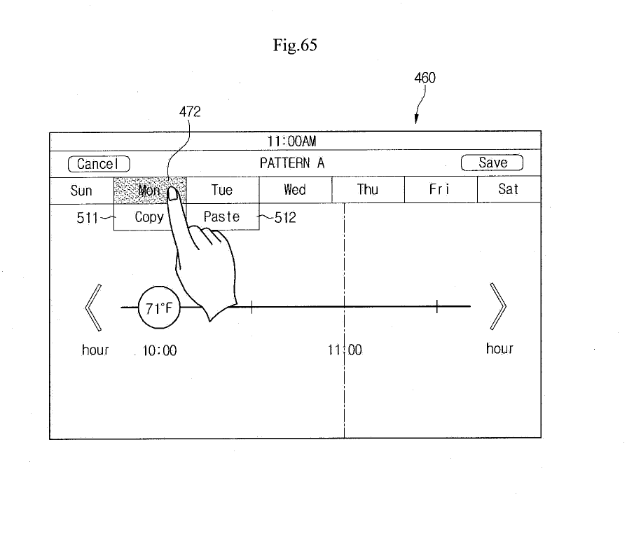

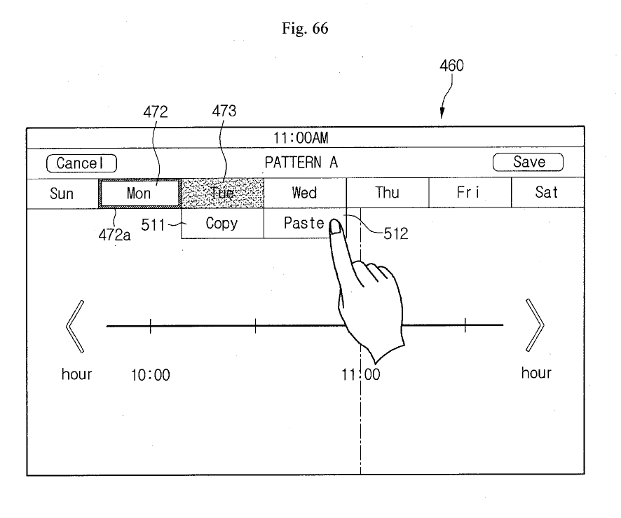

FIGS. 65 and 66 illustrate an example of a screen that copies a day of the week in which schedule setting is completed and applies the copied day to a screen for application to another day of the week. Referring to FIG. 65, in the state where schedule setting of a specific day of the week is completed, the user may select a button of a corresponding day of the week during a predetermined time. For example, when the Monday button 472 is pressed during the predetermined time, the screen 460 may display a copy button 511 for copying a schedule for the corresponding day of the week and a paste button 512 for pasting the copied schedule. When the user selects the copy button 511, schedule copying may be completed.

In this case, information 472a for notifying the copied state may be displayed in the button 472 of the day of the week having the copied schedule.

Referring to FIG. 66, the user may select a day of the week for applying the copied schedule. For example, when the user selects the Wednesday button 473, the screen 460 may display a copy button 511 for copying a schedule set for the corresponding day of the week and a paste button 512 for pasting the copied schedule. In addition, when the user selects the paste button 512, the copied schedule is applied to Wednesday. That is, a schedule set for Monday is similarly applied to Tuesday.

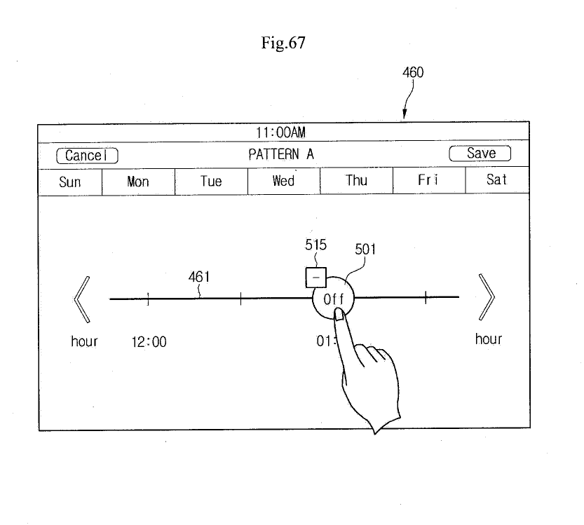

FIG. 67 illustrates an example of a screen for deleting the set schedule. Referring to FIG. 67, in the state where one or more first setting regions 501 are displayed on the screen 460, the user may press the first setting region 501 displayed to delete the schedule. Then, the screen 460 may display a delete button 515 for deleting the corresponding schedule. In addition, when the user selects the delete button 515, the selected schedule may be deleted from the memory 5 and the selected schedule may disappear on the screen 460.

As described above, the schedule may include a start schedule and an end schedule, and when one of the start schedule and the end schedule is deleted, the other one may be automatically deleted. Alternatively, the user may delete one of the start schedule or the end schedule, and although any one of the start schedule or the end schedule is deleted, the other one may be maintained.

The end schedule may be selected after the start schedule is set as above, or the start schedule may be set after the end schedule is set as above. Alternatively, one complete schedule may be set by adding the end schedule between two start schedules after setting two start schedules.

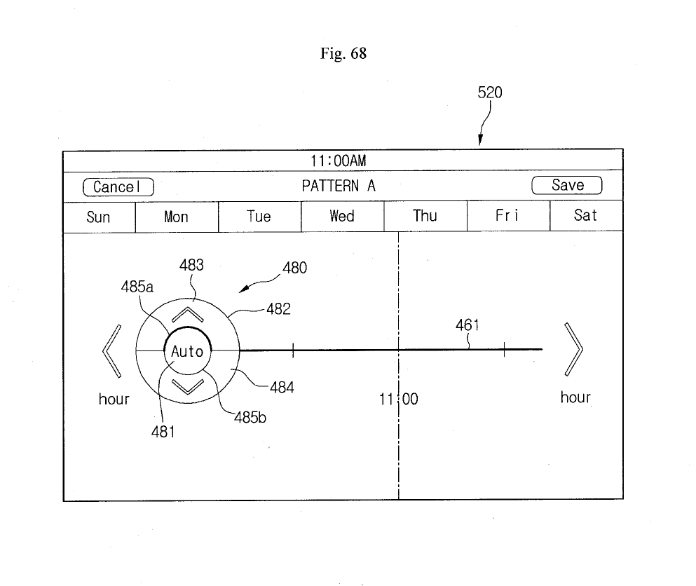

FIGS. 68 to 72 illustrate a screen for setting a weekly schedule in a second display mode.

FIG. 68 illustrates a screen displayed when a specific time is selected on the screen of FIG. 56. Referring to FIG. 68, when the specific time is selected on the screen 460 of FIG. 56, the controller 4 may display a screen 520 for selecting the event occurrence schedule on the touch screen display 3.

The screen 520 may display a setting image 480 for event setting in a time selected on the time axis 461 in the first image 460a. The setting image 480 may include a first setting region 481 and a second setting region 482 surrounding the first setting region 481 as described above.

The first setting region 481 may display a parameter in a present step among a series of steps for setting the parameter. In FIG. 68, a mode may be displayed in the first setting region 481, for example. The mode may include cooling, heating, automatic, blowing, and dehumidifying modes in the second display mode and hereinafter, a case of setting the automatic mode will be described.

When the automatic mode is displayed in the first setting region 481, the first setting region 481 and the second setting region 482 may be divided into two regions 485a and 485b. In the case of the automatic mode, as the user may set each of a cooling temperature and a heating temperature, the boundary region may be divided into two regions to allow the user to separately set the cooling temperature and the heating temperature. In addition, the two boundary regions 485a and 485b may have different colors.

The cooling temperature and the heating temperature included in the second setting region 482 may be divided by the time axis. The second setting region 482 may enable a value of the parameter to be changed, on/off to be determined, and a type of the parameter to be changed, for example. The second setting region 482 may include two divided selection regions 483 and 484. The second setting region 482 may be divided vertically or horizontally according to the type of the parameter.

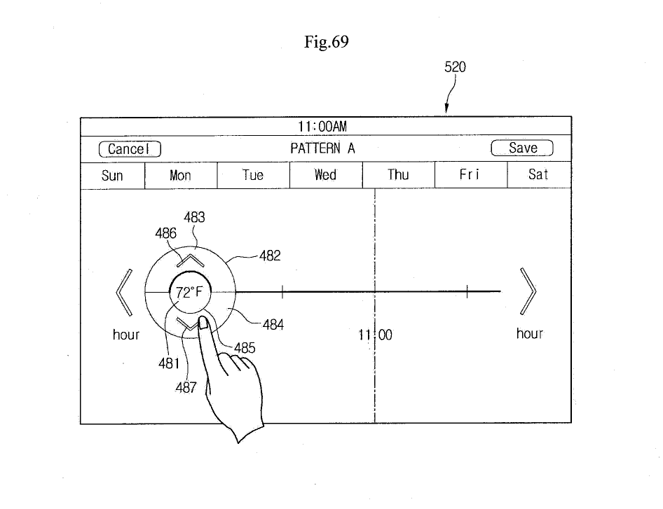

FIG. 69 illustrates a screen for setting a next parameter after the mode setting is completed in FIG. 68. Referring to FIG. 69, when the mode setting is completed on the screen of FIG. 68, that is, when the first setting region 481 is touched, the screen 520 may display a target cooling temperature in the first setting region 481.

Further, the screen 520 may display change buttons 486 and 487 for changing the mode in the respective selection regions 483 and 484 of the second setting region 482. Further, the screen 520 may display one boundary region 485 having a first color. The first color may be a blue color, for example, but embodiments are not limited thereto.

Further, the user may change the cooling temperature by selecting the change buttons 486 and 48T Alternatively, the screen 520 may display an arrow for guiding selection in order to change the mode in the respective selection regions 483 and 484 of the second setting region 482. In this case, although the user selects a region other than the arrow in the selection regions 483 and 484, the cooling temperature may be changed.

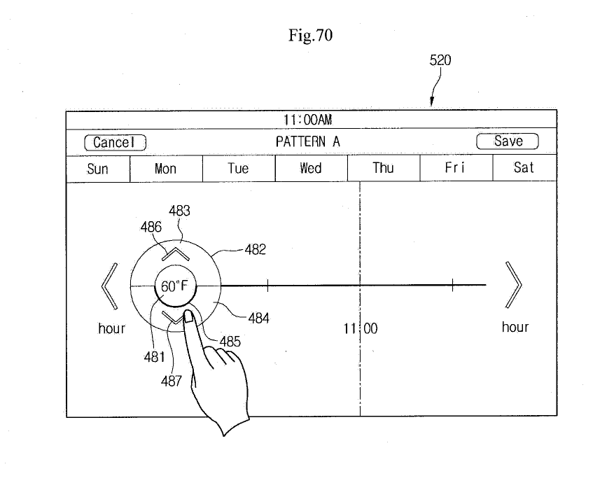

FIG. 70 illustrates a screen for setting a next parameter after cooling temperature setting is completed in FIG. 69. Referring to FIG. 70, when the cooling temperature setting is completed on the screen of FIG. 69, that is, when the first setting region 481 is touched, the screen 520 may display a target heating temperature in the first setting region 481.

Further, the screen 520 may display change buttons 486 and 487 for changing the mode in the respective selection regions 483 and 484 of the second setting region 482. Further, the screen 520 may display one boundary region 485 having a second color. The second color may be a red color, for example, but embodiments are not limited thereto.

Further, the user may change the heating temperature by selecting the change buttons 486 and 487. Alternatively, the screen 520 may display an arrow for guiding selection in order to change the mode in the respective selection regions 483 and 484 of the second setting region 482. In this case, although the user selects a region other than the arrow in the selection regions 483 and 484, the heating temperature may be changed.

The heating temperature may be set after the cooling temperature is set in FIGS. 69 and 70 and vice versa.

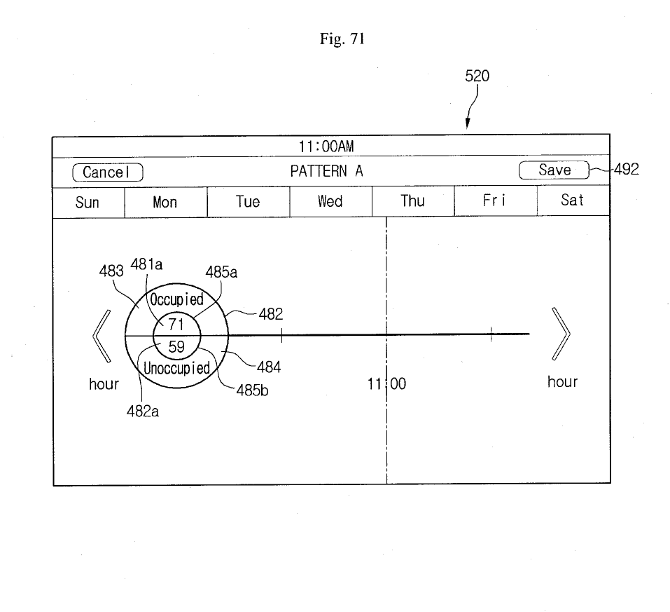

FIG. 71 illustrates a screen for setting a next parameter after heating temperature setting is completed in FIG. 70. Referring to FIG. 71, when the user touches the first setting region 481 in order to complete the heating temperature setting, the screen 520 may display both the cooling temperature and the heating temperature set by dividing the first setting region into two temperature regions. That is, the first setting region 481 may include a cooling temperature region 481a and a heating temperature region 481a. Each of the temperature regions 481a and 481b may have a semi-circular shape; however, embodiments are not limited thereto.

The screen 520 may display a first boundary region 485a having a first color and a second boundary region 485b having a second color. The first boundary region 485a may surround the cooling temperature region 481a, and although embodiments are not limited thereto, the first boundary region 485a may have a semi-circular shape. The second boundary region 485b may surround the heating temperature region 481b, and although embodiments are not limited, the second boundary region 485b may have a semi-circular shape.

The screen 520 may display two selection regions 483 and 484 to select occupied and unoccupied. For example, the first selection region 483 may enable occupied to be selected and the second selection region 483 may enable unoccupied to be selected.

In addition, when the save button 492 is selected on the screen 520 of FIG. 71, setting the start schedule may be completed.

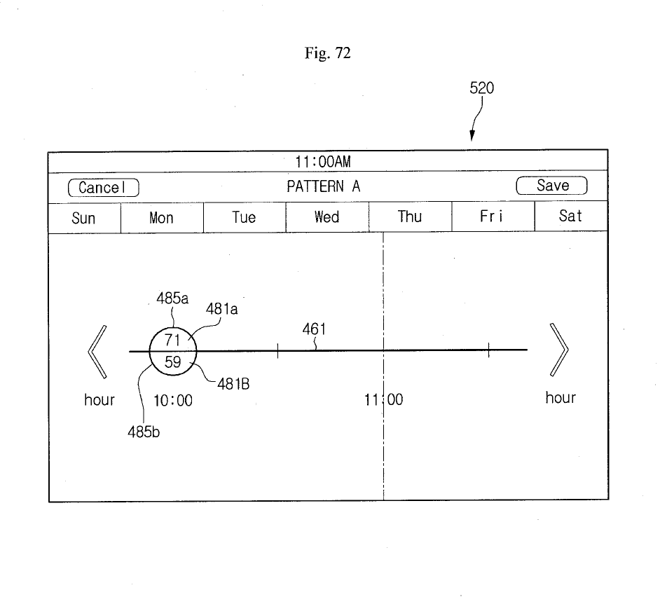

FIG. 72 is a screen displayed when setting the event occurrence schedule is completed in FIG. 71. Referring to FIG. 72, when the setting of the event occurrence schedule is completed, the screen 520 may display two temperature regions 481a and 481b and two boundary regions 485a and 485b. That is, the second setting region 482 may not be displayed on the screen 520.

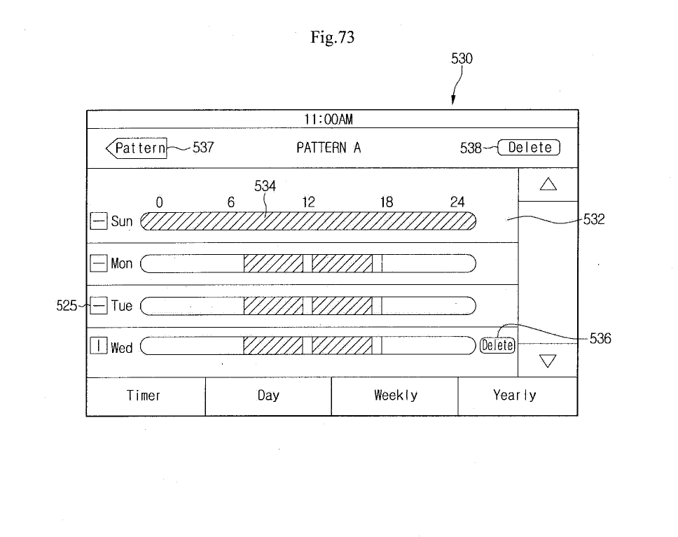

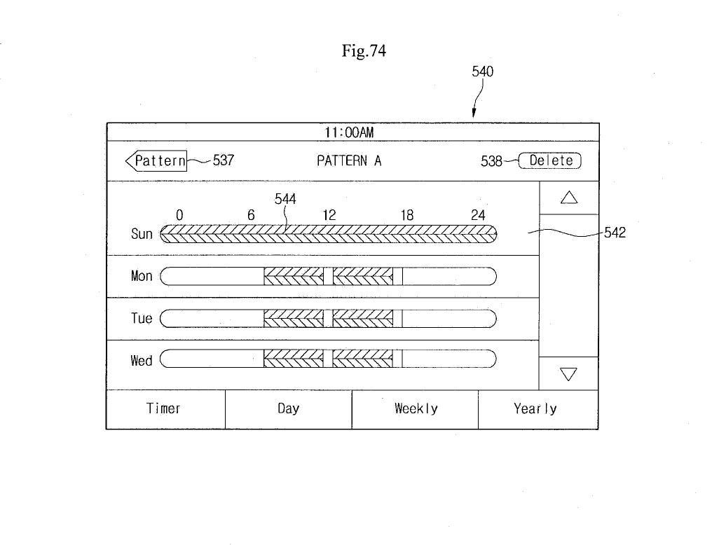

FIGS. 73 and 74 illustrate an example of a screen for verifying a set schedule. FIG. 73 illustrates a screen for verifying the schedule set in the first display mode. FIG. 74 illustrates a screen for verifying the schedule set in the second display mode.

First, referring to FIG. 73, when the pattern button is selected in FIG. 55, the screen 530 for verifying the schedule may be displayed. The screen 530 may display a day-of-the week schedule button 532. The day-of-the week schedule button 532 may be displayed as a bar including a predetermined period, and a set schedule 534 may be displayed on the bar.

For example, in FIG. 73, the schedule may be applied to Sunday for all of 24 hours and two schedules may be applied to Monday, Tuesday, and Wednesday for a predetermined time interval within 24 hours. In this case, a color of the set schedule may vary depending on the mode. For example, the schedule set in Monday may be displayed with a first color in the cooling mode and the schedule set in Tuesday may be displayed with a second color in the case of the heating mode.

The screen 530 may display a delete button 538 for deleting a schedule for one or more days of the week. When the user touches the delete button 538, the screen 530 may display a select button 525 for selecting one or more days-of-the week among the day-of-the week schedule buttons.

When the user touches the select button 525, an additional deletion button 536 for deleting the corresponding day-of-the week button is displayed. In addition, when the user selects the deletion button 536, the schedule of the selected day-of-the week is deleted.

Further, the screen 530 may include a pattern button 537 for returning to the screen of FIG. 55 which is a previous screen.

Next, referring to FIG. 74, when the pattern button is selected in FIG. 55, the screen 540 for verifying the schedule may be displayed.

The screen 540 may display a day-of-the week schedule button 542. The day-of-the week schedule button 542 may be displayed as a bar including a predetermined period, and a set schedule 544 may be displayed on the bar.

For example, in FIG. 73, the schedule may be applied to Sunday for all of 24 hours and two schedules may be applied to Monday, Tuesday, and Wednesday for a predetermined time interval within 24 hours. In this case, if the set schedule is for the automatic mode, the set schedule 544 may be divided by two colors, and two colors may be simultaneously displayed.

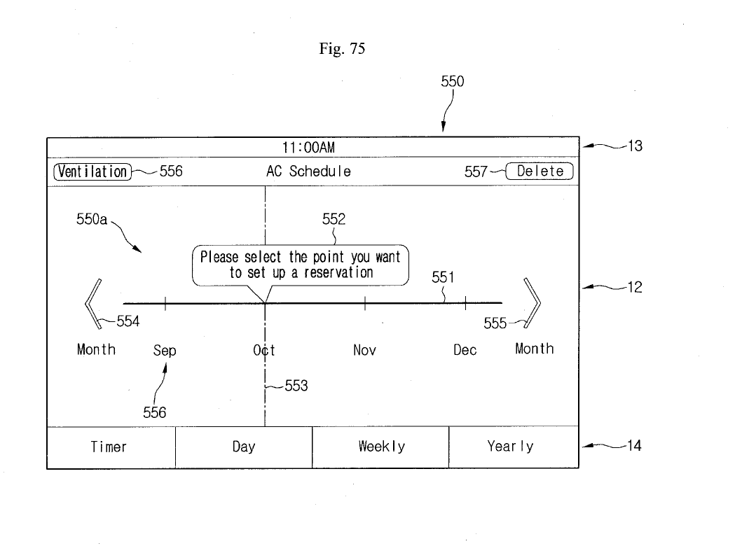

FIGS. 75 to 80 illustrate an example of a screen for setting the yearly schedule. FIG. 75 illustrates an example of a screen for setting the yearly schedule. Referring to FIG. 75, when the yearly button 434 is elected on any one screen of screens including the yearly button 434, the controller 4 may display a screen 550 for setting the yearly schedule on the touch screen display 3.

The screen 550 may include a first region 12, a second region 13, and a third region 14. The screen 550 may display a time setting image 550a for selecting a time for setting the schedule in the first region 12. The screen 550 may further display change buttons 554 and 555 for changing the month.

The time setting image 550a may include a time axis 551, month information 556, and a present month 553. The present month 553, which may be in the form of time line, may be displayed on the time axis 551. That is, the time setting image 550a may display the time axis 551 and the month information 556 including the present month.

The time setting image 550a may display a text message 552 to guide a user's month selection. Further, the screen 550 may include a ventilation button 556 and a delete button 557 for setting a schedule for the ventilation device.

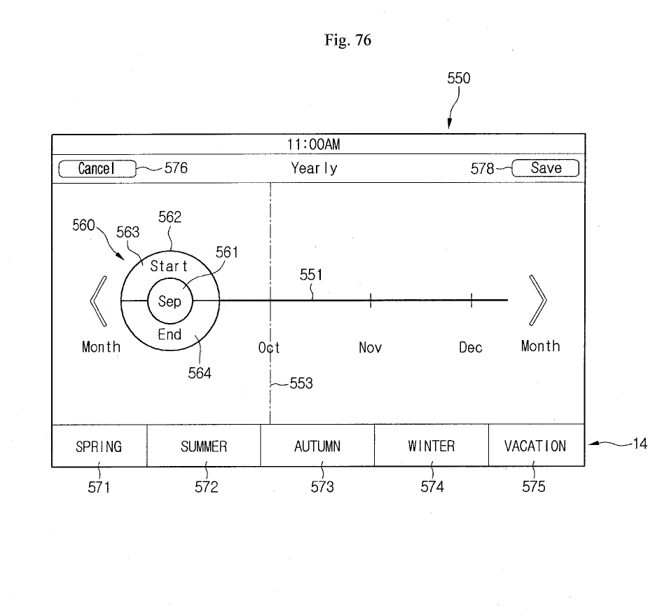

FIG. 76 illustrates a screen displayed when a specific month is selected in FIG. 75. Referring to FIG. 76, when the specific month is selected on the screen 550 of FIG. 75, a setting image 560 for setting the event in the selected month may be displayed in the time setting image 550a. The user may select a specific point on the time axis 551 in order to select the specific month.

Further, the screen 550 may display a button for selecting the pattern in the third region 14. A spring button 571, a summer button 572, an autumn button 573, a winter button 574, and a vacation button 575 may be displayed in the third region 14.

The setting image 560 may be displayed on the time axis 551. The setting image 560 may include a first setting region 561 and a second setting region 562 surrounding the first setting region 561, for example. Each of the first setting region 561 and the second setting region 562 may have a circular shape.

Alternatively, the first setting region 561 may have a circular shape and the second setting region 562 may have a non-circular shape. Alternatively, each of the first setting region 561 and the second setting region 562 may have a non-circular shape.

The first setting region 561 may display a selected month or pattern name. The first setting region 561 may display the selected month, and thereafter, when a pattern is selected, the selected pattern may be displayed.

The second setting region 562 may enable start/end to be selected. The second setting region 562 may include two divided selection regions 563 and 564. The second setting region 562 may be divided vertically or horizontally according to the type of the parameter.

The first selection region 563 may be used to select the start, and the second selection region 564 may be used to select the end. When there no yearly schedule which has been previously set, the first selection region 563 may be activated and the second selection region 564 may be deactivated.

Further, the screen 550 may further include a cancel button 576 and a save button 578.

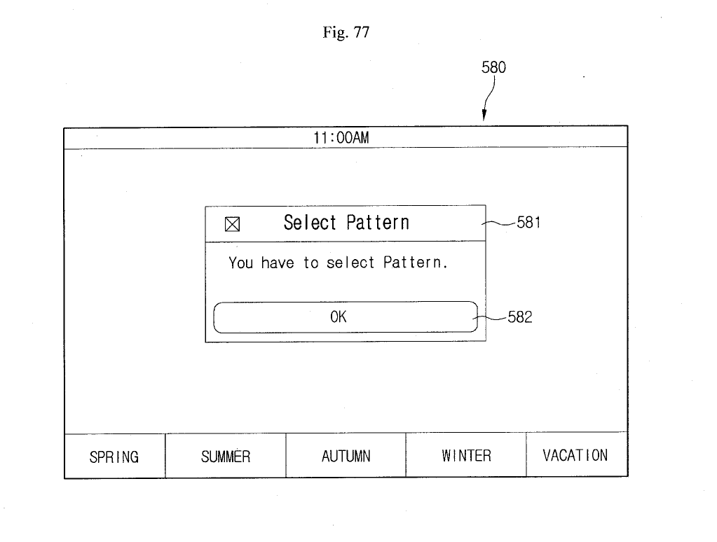

FIG. 77 illustrates a screen for notifying that pattern selection is required. Referring to FIG. 77, when the save button 578 is selected in the state where the month is selected, but the pattern is not selected on the screen of FIG. 76, the controller 4 may display a screen 580 including pop-up information 581 for guiding the pattern selection.

The pop-up information 581 may include a text message You have to select pattern.” The pop-up information 581 may include an OK button 582.

When the OK button 582 is selected, the screen 580 may be switched to a screen (for example, the screen of FIG. 76) which is previously displayed. Alternatively, when a predetermined time when the screen 582 including the pop-up information 580 is displayed elapses, the screen 580 may be switched to the screen which is previously displayed. In this case, after only the pop-up information 581 pops up on the screen which is previously displayed, only the pop-up information may disappear. After the screen 580 including the pop-up information 582 is switched to the screen of FIG. 76, the user may select one of the buttons 571 to 575 for selecting the pattern.

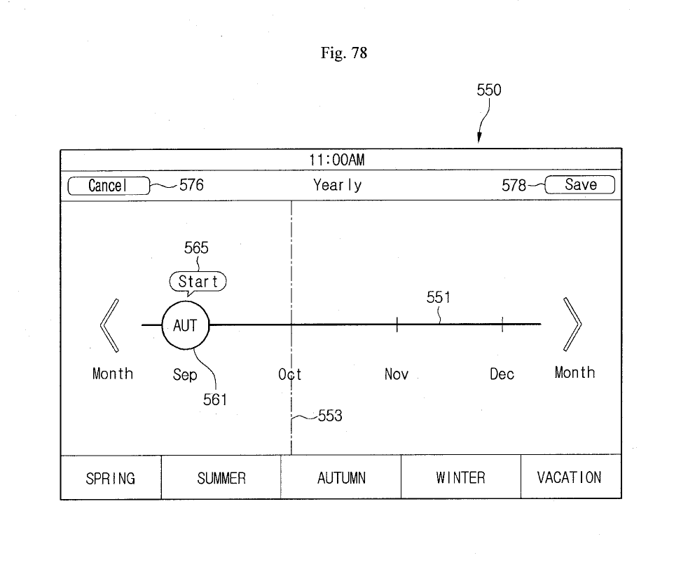

FIG. 78 illustrates a screen displayed when the schedule setting is completed in FIG. 76. Referring to FIG. 78, when the schedule setting is completed on the screen of FIG. 76, the screen 550 may display the first setting region 561 on the time axis 551. In this case, the first setting region 561 may include the pattern name. Further, the screen 550 may display information 565 for notifying that the first setting region 561 is a start event.

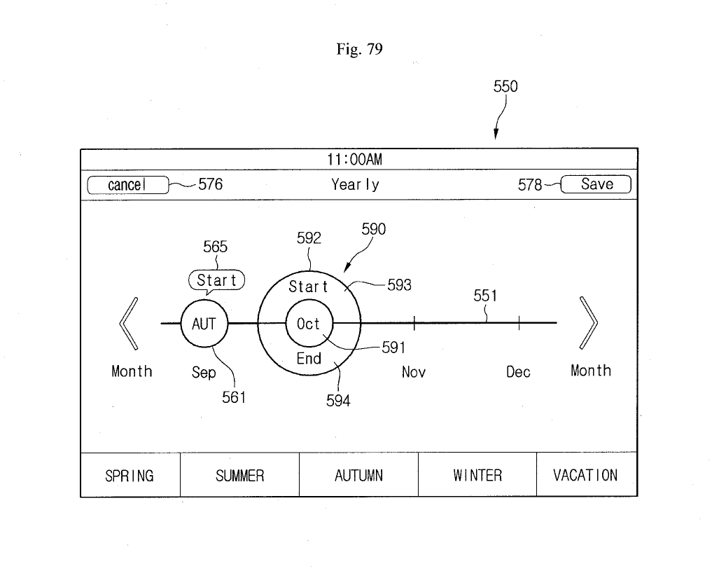

FIG. 79 illustrates an example of a screen for setting the end schedule as the event occurrence schedule. Referring to FIG. 79, the user may select a specific point on the time axis 551 to select an event end month.

When a specific month is selected on the screen 550, the screen 550 may display a setting image 590 for setting the event in the selected month. The setting image 590 may be displayed on the time axis 551. The setting image 590 may include a first setting region 591 and a second setting region 592 surrounding the first setting region 591, for example.

The first setting region 591 may display a selected month or pattern name. The first setting region 591 may display the selected month, and thereafter, when a pattern is selected, the selected pattern may be displayed.

The second setting region 592 may enable start/end to be selected. The second setting region 592 may include two divided selection regions 593 and 594. The second setting region 592 may be divided vertically or horizontally according to the type of the parameter.

The first selection region 593 may be used to select the start, and the second selection region 594 may be used to select the end. When a yearly schedule which is previously set includes the start schedule, the first selection region 593 may be deactivated and the second selection region 594 may be activated.

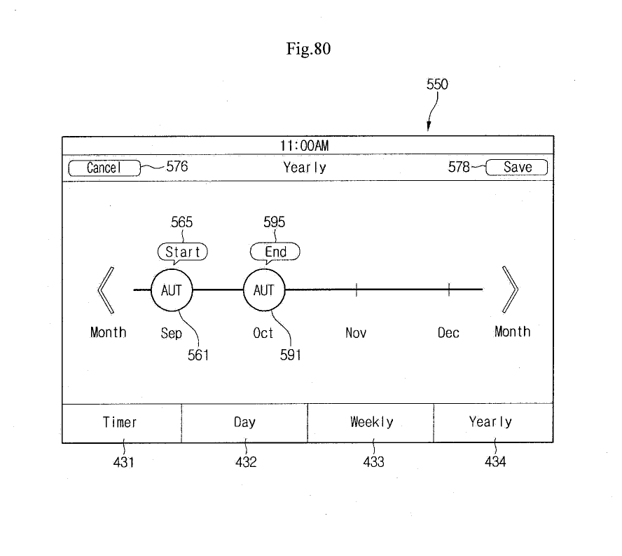

FIG. 80 illustrates a screen displayed when the schedule setting is completed in FIG. 79. Referring to FIG. 80, when the schedule setting is completed on the screen of FIG. 79, the screen 550 may display the first setting region 591 on the time axis 551. In this case, the first setting region 591 may include the pattern name. Further, the screen 550 may display information 595 for notifying that the first setting region 595 is an end event.

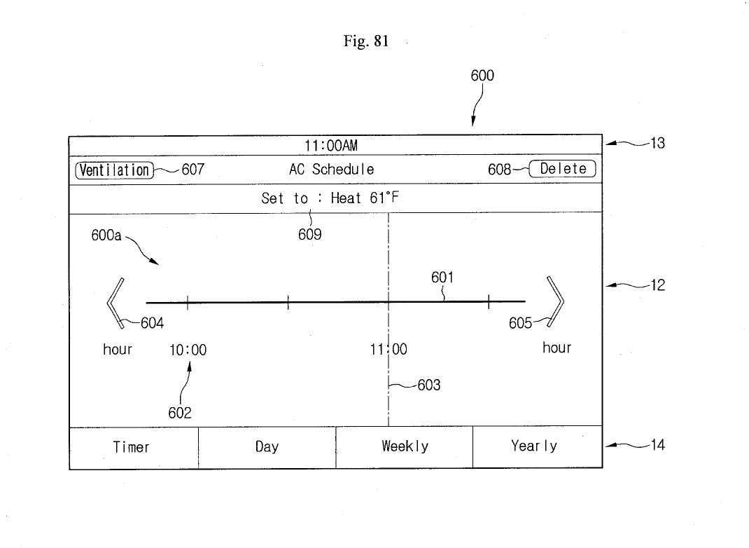

FIGS. 81 to 84 illustrate an example of a screen for setting the daily schedule.

FIG. 81 illustrates the screen for setting the daily schedule. Referring to FIG. 81, when the daily button 432 is selected on any one screen of screens including the daily button 432, the controller 4 may display a screen 600 for setting the daily schedule on the touch screen display 3.

The screen 600 may include a first region 12, a second region 13, and a third region 14. The screen 600 may display a time setting image 600a for selecting a time for setting the schedule in the first region 12. The screen 600 may further display change buttons 604 and 605 for changing the time.

The time setting image 600a may include a time axis 601, time information 602, and a present time 603. The present time 603, which may be in the form of a time line, may be displayed on the time axis 601. That is, the time setting image 600a may display the time axis 601 and the time information 602 including the present time.

The screen 600 may further display a setting button 609 that displays a selected mode and a set temperature. The user may set the time through the time setting image 600a and set the mode and the temperature by selecting the setting button 609.

Further, the screen 600 may include a ventilation button 607 and a delete button 608 for setting the schedule for the ventilation device.

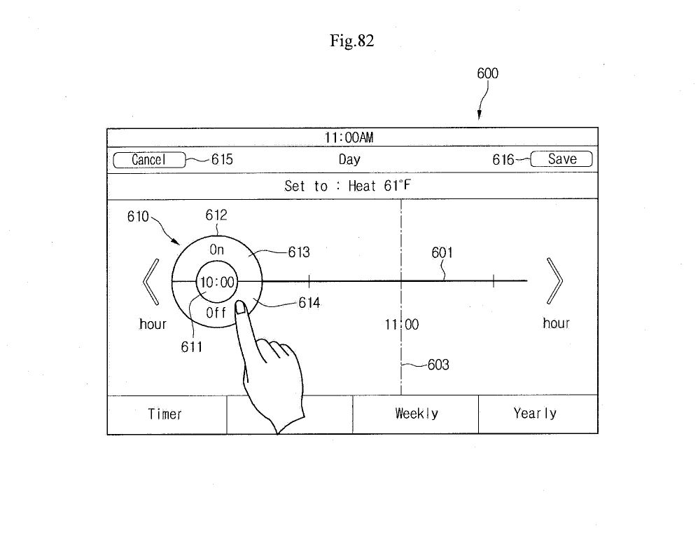

FIG. 82 illustrates a screen displayed when a specific time is selected on the screen of FIG. 81. Referring to FIG. 82, when the specific time is selected on the screen 600 of FIG. 81, the screen 600 may display a setting image 610 for setting the event in the selected time in the time setting image 600a. The user may select a specific point on the time axis 461 in order to select the specific time.

The setting image 610 may be displayed on the time axis 601. The setting image 610 may include a first setting region 611 and a second setting region 612 surrounding the first setting region 611, for example. Each of the first setting region 611 and the second setting region 612 may have the circular shape, but embodiments are not limited thereto.

The first setting region 611 may display the time. The second setting region 612 may enable on/off to be selected or the time displayed in the first setting region 611 to be changed. The second setting region 612 may include two divided selection regions 613 and 614. The second setting region 612 may be divided vertically or horizontally according to the type of the parameter.

In FIG. 82, the first selection region 613 may enable the on to be selected, and the second selection region 614 may enable the off to be selected. When the user touches the first setting region 611 after selecting the first selection region 613 and the second selection region 614, on or off setting may be completed.

The screen 600 may further include a cancel button 515 and a save button 616.

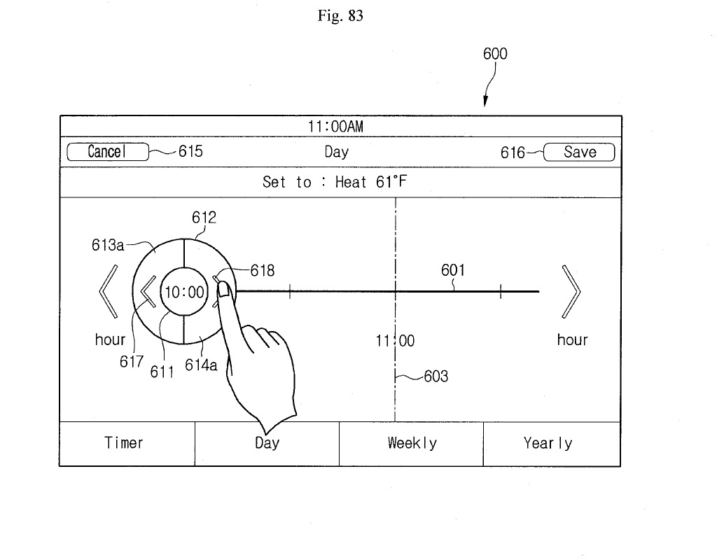

FIG. 83 illustrates a screen displayed when on or off selection is completed in FIG. 82. Referring to FIG. 83, when the on or off selection is completed on the screen of FIG. 82, the screen 600 may display two setting regions 613a and 614a which may be horizontally divided in the second setting region 682. Change buttons 617 and 618 for changing the time by the unit of minute may be displayed in each of the setting regions 613a and 614a. Alternatively, the time displayed in the first setting region 611 may be changed by the unit of 5 minutes by the change buttons 617 and 618.

Alternatively, the screen 60 may display an arrow for guiding selection in order to change the time in the respective selection regions 613a and 614a of the second setting region 612. In this case, although the user selects a region other than the arrow in the selection regions 613a and 614a, the time may be changed. The user may complete time setting by touching the first setting region 611.

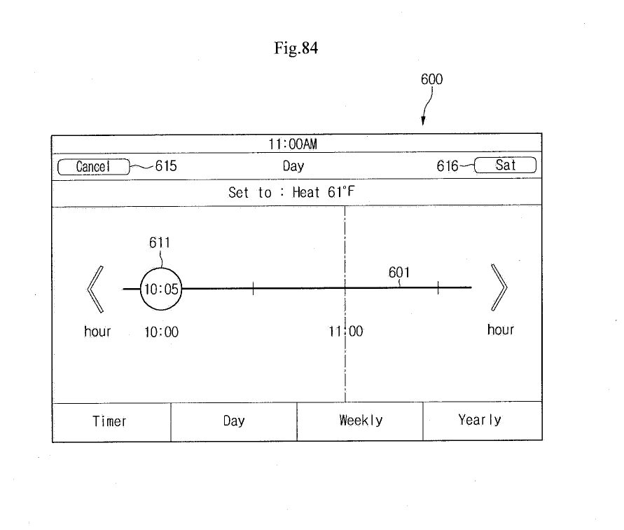

FIG. 84 illustrates a screen displayed when the time setting is completed in FIG. 83. Referring to FIG. 84, when the time setting is completed on the screen 600 of FIG. 83, the screen 600 may display the first setting region 611 on the time axis 601.

In FIGS. 81 to 84, the start schedule may be set as the event occurrence schedule, for example, but as the end schedule may also be set in the same method, a detailed description thereof has been omitted.

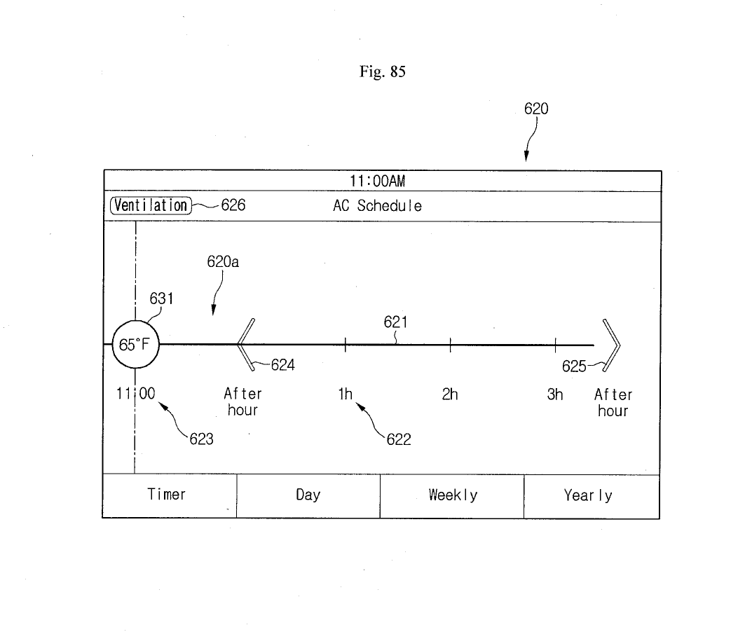

FIGS. 85 to 89 illustrate as example of a screen for setting a timer.

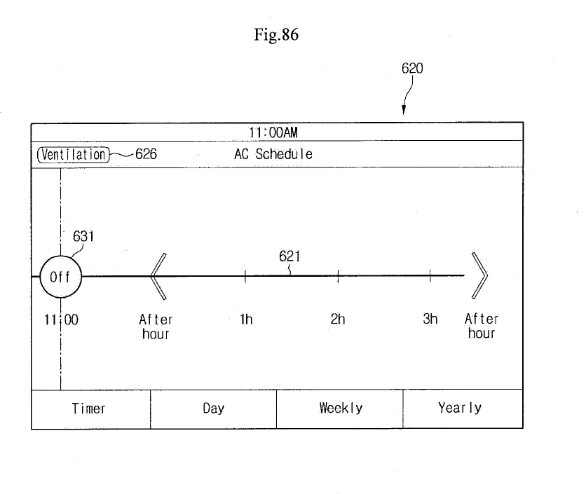

FIGS. 85 and 86 illustrate the screen for setting the timer. Referring to FIGS. 85 and 86, when a timer button 431 is selected on any one screen of screens including the timer button 431, the controller 4 may display a screen 620 for setting the timer on the touch screen display 3.

The screen 620 may include a first region 12, a second region 13, and a third region 14. The screen 600 may display a time setting image 620a for selecting the time for setting the timer in the first region 12. The screen 620 may further display change buttons 624 and 625 for changing the time.

The time setting image 620a may include a time axis 621, time information 622, and a present time 623. The present time 623 may include a time line displayed on the time axis 621. That is, the time setting image 620a may display the time axis 621 and the time information 622 including the present time. In this case, the time information 622 may display a time after the present time based on the present time.

The change buttons 624 and 625 may be displayed on the time axis 621.

When one or more components of the HVAC system are operated, the screen 620 may display a state display region 631 including a present mode or a set temperature on the time axis 621. The display region 631 may have a circular shape, for example, but embodiments are not limited thereto. When one or more components of the HVAC system are in an off state, the screen 620 may display a display region 631 including off information on the time axis 621. Further, the screen 620 may include a ventilation button 626 for setting the schedule for the ventilation device.

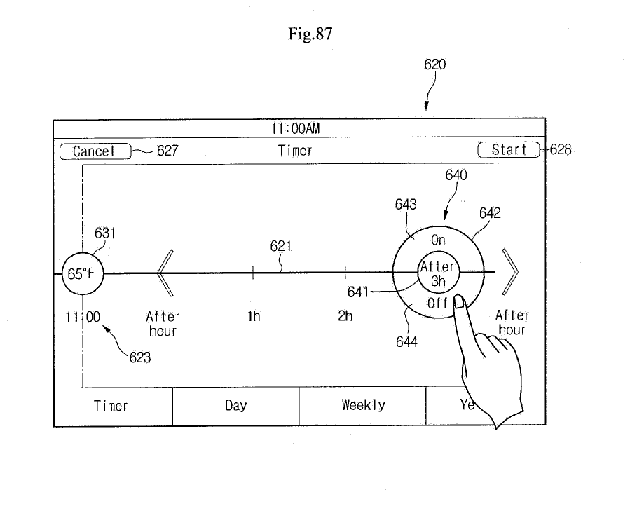

FIG. 87 illustrates a screen displayed when a specific time is selected on the screen of FIG. 86. Referring to FIG. 87, when the specific time is selected on the screen 620 of FIG. 86, the screen 620 may display a setting image 640 for setting the event in the time selected in the time setting image 620a. The user may select a specific point on the time axis 640 in order to select the specific time.

The setting image 640 may be displayed on the time axis 621. The setting image 640 may include a first setting region 641, and a second setting region 642 surrounding the first setting region 641, for example. Each of the first setting region 641 and the second setting region 642 may have a circular shape, but embodiments are not limited thereto.

The first setting region 641 may display the time. For example, time information such as “AFTER 3 h” may be displayed in the first setting region 641.

The second setting region 642 may enable the on/off to be selected. The second setting region 642 may include two divided selection regions 643 and 644. The second setting region 612 may be divided vertically or horizontally according to the type of the parameter.

In FIG. 87, the first selection region 643 may enable the on to be selected, and the second selection region 644 may enable the off to be selected.

When one or more components of the HVAC system are operated, the first selection region 643 may be deactivated and the second selection region 644 may be activated. When one or more components of the HVAC system are in the off state, the first selection region 643 may be activated and the second selection region 644 may be activated.

The screen 620 may further include a cancel button 627 and a start button 628.

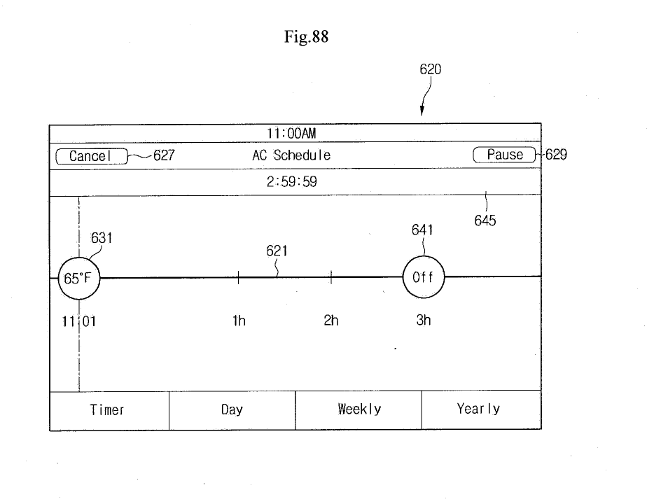

FIG. 88 illustrates a screen displayed when the timer setting is completed. Referring to FIG. 88, when the timer setting is completed, the screen 620 may display the display region 631 at the present time of the time axis 621 and the first setting region 641 at the time when the event occurs.

Further, the screen 620 may display a time button 645 for notifying that the timer is in progress. A time displayed in the time button 645 may be decreased as a residual time from the present time up to the event occurrence time. As time elapses, present time information displayed on the screen 620 may vary, and a distance between the display region 631 and the first setting region 641 may be decreased.

The screen 620 may further display a pause button 629.

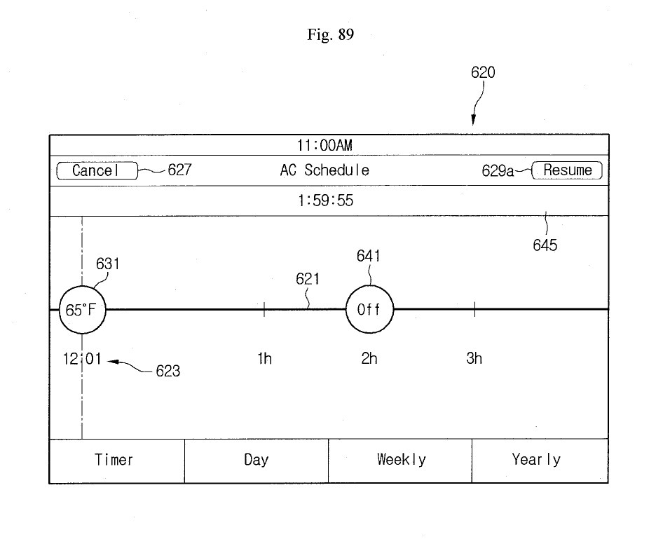

FIG. 89 illustrates a screen displayed when the pause button is selected on the screen of FIG. 88. Referring to FIG. 89, when the pause button is selected on the screen 620 of FIG. 88, the controller 4 may pause actuation of the timer and the screen 620 may display a resume button 629a.

In this case, the present time 623 may be changed on the screen 620, but the residual time may not be decreased at the pause time. Accordingly, a distance between the display region 631 and the first setting region 641 may not be changed before the resume button 629a is selected.

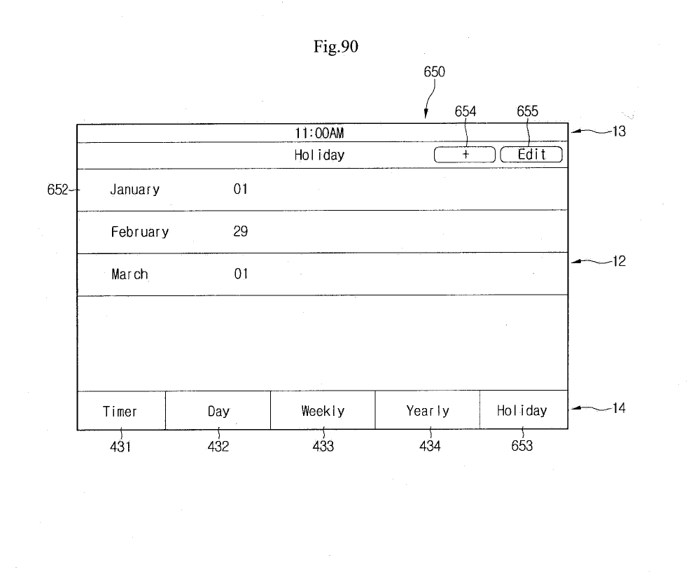

FIGS. 90 to 92 illustrate an example of a screen for setting a holiday.

FIG. 90 illustrates the screen for setting the holiday. Referring to FIG. 90, in some embodiments, a holiday button 653 may be further displayed in the third region of the screen of FIG. 52, in addition to the timer button 431, the daily button 432, the weekly button 433, and the yearly button 434. When the holiday button 653 is selected on the screen of FIG. 52, the controller 52 may display a screen 650 for setting the holiday on the touch screen display 3.

The screen 650 may include a first region 12, a second region 13, and a third region 14. The screen 650 may display a holiday display button 652 for showing the holiday set in the first region 12. The third region 14 may display the timer button 431, the daily button 432, the weekly button 433, the yearly button 434, and the holiday button 653.

The screen 650 may display an add button 654 for adding the holiday to the first region 12 and an edit button 655 for deleting or changing the set holiday.

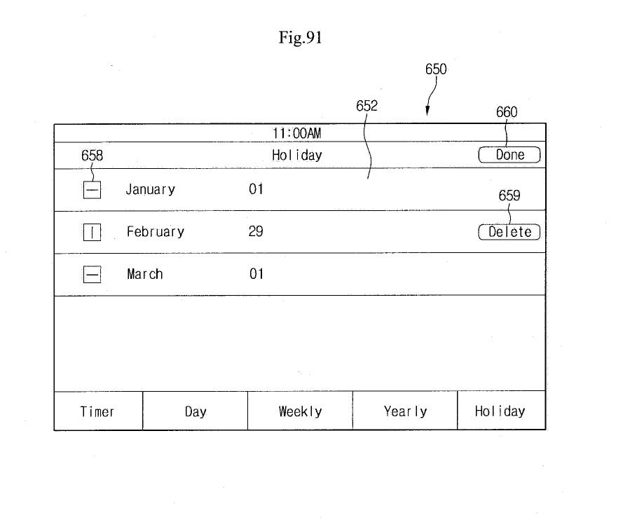

FIG. 91 illustrates a screen displayed when the edit button is selected on the screen of FIG. 90. Referring to FIG. 91, when the edit button 655 is selected on the screen 650 of FIG. 90, the screen 650 may display a select button 658 for selecting each holiday in the holiday display button 652. Further, the screen 650 may display a done button 660 in the first region 12.

When the user selects the select button 658 of a holiday to be deleted, a delete button 659 may be displayed in a holiday display button corresponding to the selected holiday. When the user selects the delete button 659, the controller 4 may delete the selected holiday from the memory 5 and remove a holiday display button corresponding to the deleted holiday from the screen 550.

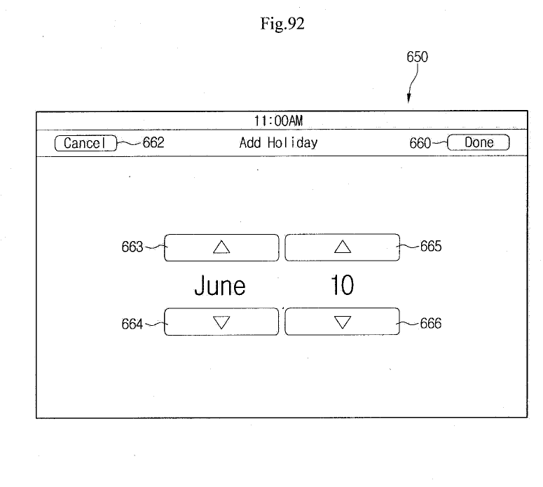

FIG. 92 illustrates a screen displayed when the add button is selected on the screen of FIG. 90. Referring to FIG. 92, when the add button 654 is selected on the screen 650 of FIG. 91, the screen 650 may display buttons 663 and 664 for selecting the month and buttons 665 and 666 for selecting the date. The screen 650 may further include a cancel button 662 and a done button 660.

When one or more components of the HVAC system are turned on in a set holiday, the controller 4 may control the components to be automatically turned off within a predetermined time (for example, 1 hour, but embodiments are not limited thereto).

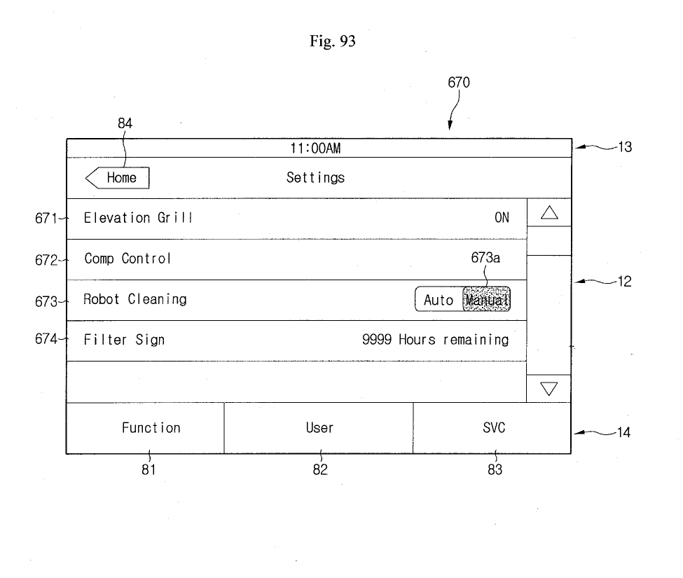

FIGS. 93 to 110 illustrate an example of a screen for setting an additional function.

FIGS. 93 to 95 illustrate the screen for setting the additional function. First, referring to FIG. 93, when a set-up button 65 is selected on any one screen of screens including the set-up button 65, the controller 4 may display a screen 670 for setting the additional function on the touch screen display 3. The screen 670 may include a first region 12, a second region 13, and a third region 14. The screen 670 may display an elevation grill button 671 for selecting an elevation grill function, a comp control button 672 for selecting comp control, a robot cleaning button 673 for selecting robot cleaning, and a filter sign button 674 for displaying a filter state.

The elevation grill button 671 may include on or off information of an elevation function. The controller 4 may display the elevation grill button 671 on the screen 670 when one or more components of the HVAC system include the elevation grill.

The robot cleaning button 673 may include a button 673a for manually or automatically selecting a robot cleaning function. The filter sign button 674 may include residual time information for filter changing.

When all of the buttons are not displayed in the first region 12, the first region 12 may display a scroll button or a scroll bar for the non-displayed button. The third region 14 may include a function button 81, a user button 82, and a service button 83. The screen 670 may further include a home button 84.

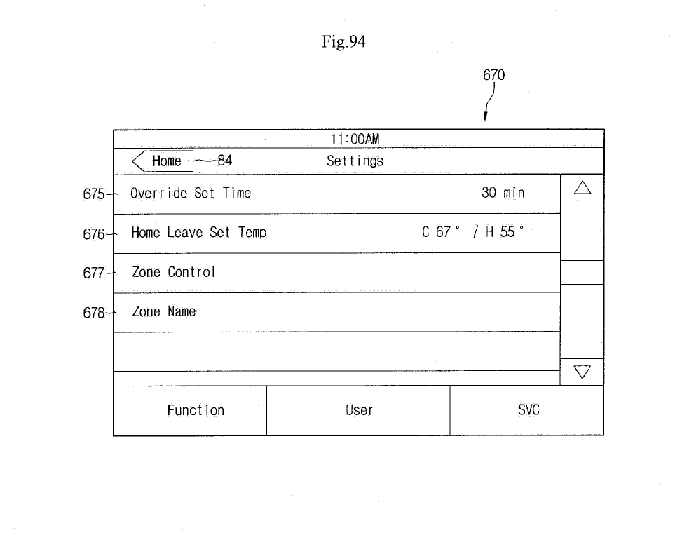

Next, referring to FIG. 94, when the button is moved by selecting the scroll button or the scroll bar, the screen 670 may display an override setting time button 675 for setting an override time, a home leave setting temperature button 676 for setting a home leave temperature, a zone control button 677 for selecting a zone control function, and a zone name button 678 for setting a zone name. The override time button 675 may include set time information. The home leave setting temperature button 676 may include a set cooling and/or heating temperature.

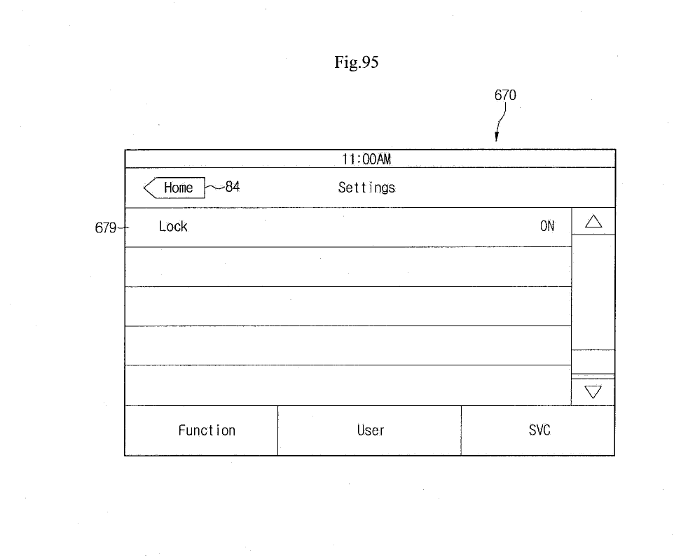

Next, referring to FIG. 95, when the button is moved by selecting the scroll button or the scroll bar, the screen 670 may display a locking button 679 for selecting or setting a locking function. The locking function button 679 may display on or off information of the locking function.

The first region 12 of FIGS. 93 to 95 may be displayed on the screen 670 when the function button 81 is selected, for example.

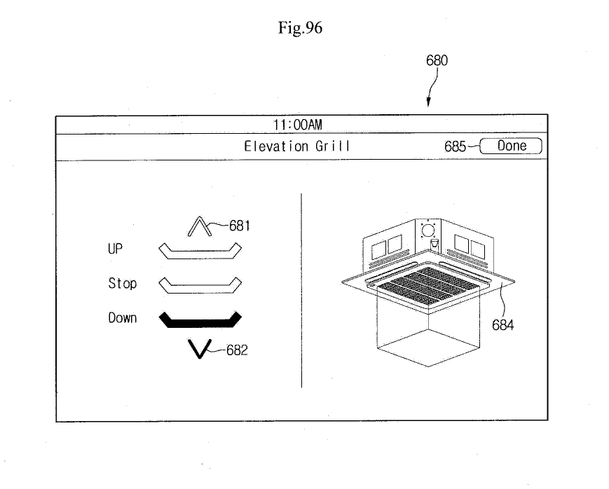

FIG. 96 illustrates a screen displayed when the elevation grill button is selected in FIG. 93. Referring to FIG. 96, when the elevation grill button 671 is selected on the screen 670 of FIG. 93, the controller 4 may display a screen 680 for controlling elevation of a grill on the touch screen display 3.

The screen 680 includes an up button 681 and a down button 682 selected to control a height of the elevation grill. Further, the screen 680 may display an icon 684 having a shape of one or more elements of the elevation grill.

When the user selects the up button 681, the elevation grill may move up and when the down button 681 is selected, the elevation grill may move up. Further, the elevation grill may be stopped by using the up button 681 or the down button 682.

Further, the screen 680 may include a done button 685.

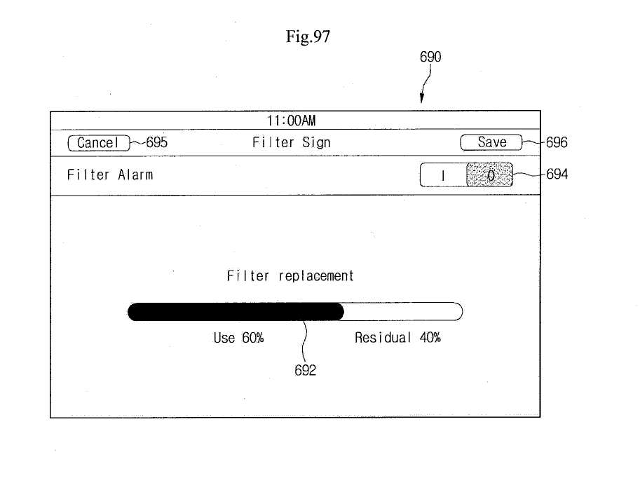

FIG. 97 illustrates an example of a screen displayed when the filter sign button is selected in FIG. 93. Referring to FIG. 97, when the filter sign button 674 is selected in FIG. 93, the controller 4 may display a screen 690 for controlling the filter state on the touch screen display 3.

The screen 690 may include a button 694 for turning on or off a filter alarm function. The screen 690 may include an image 692 displaying the filter state. The image 692 may display both a filter usage time and a residual time for filter changing, for example. For example, the image 692 may display the usage time on a bar and display the usage time and the residual time as a ratio. The usage time displayed on the bar may have different colors according to a ratio of a present usage time to a total usage time.

The screen 690 may further include a cancel button 695 and a save button 696.

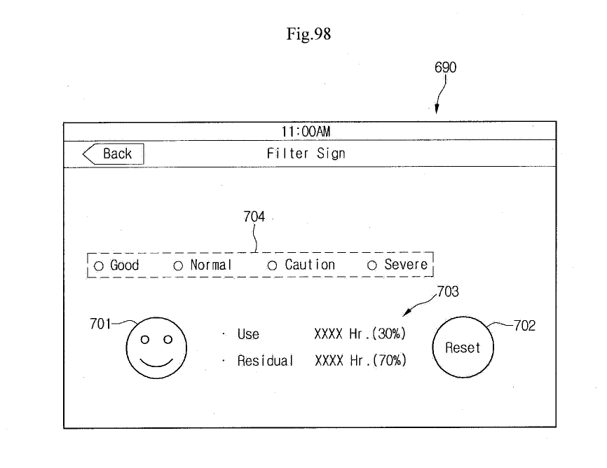

FIG. 98 illustrates another example of a screen displayed when the filter sign button is selected in FIG. 93. Referring to FIG. 98, the screen 690 for showing the filter state may create a comparison result by comparing the present usage time to the total usage time, and display the comparison result.

The comparison result may be an icon 701, for example. The icon 701 may have different shapes, forms, or colors according to the filter usage time. For example, the icon may have a smiling face shape or a frowning face shape.

The screen 690 may include description information 704 for describing the color of the icon 701. The description information 704 may include good, normal, caution, and severe, for example. In addition, good, normal caution, and severe may have different colors.

The screen 690 may display an image 703 including both the filter usage time and the residual time for filter changing. The image 703 may include an actual filter usage time and the residual time, and a ratio of the usage time and the residual time.

Further, the screen 690 may include a reset button 702 for resetting the filter usage time. When the user selects the reset button 702, the filter usage time may be reset to 0. When the filter usage time is reset, the screen 690 may change the icon 701 and the image 703.

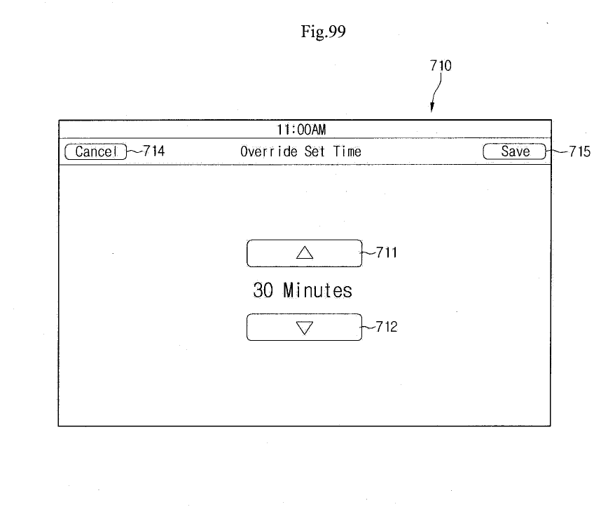

FIG. 99 illustrates an example of a screen displayed when the override setting time button is selected in FIG. 94. Referring to FIG. 99, when the override setting time 675 is selected on the screen 670 of FIG. 94, the controller 4 may display a screen 710 for setting the override time on the touch screen display 3.

The screen 710 may include an up button 711 and a down button 712 as a set-up button for setting the override time. For example, when the up button or the down button may be selected once, the time is changed at an interval of 30 minutes.

The screen 710 may further include a cancel button 714 and a save button 715.

As a state switching done time described in FIG. 29, a one-time override done time may be set when the override button 233 is selected. In contrast, on the screen 710 of FIG. 99, a fixed override switching done time may be set and when the user does not input the state switching done time in FIG. 29, a time set through the screen 710 of FIG. 99 may become the state switching done time.

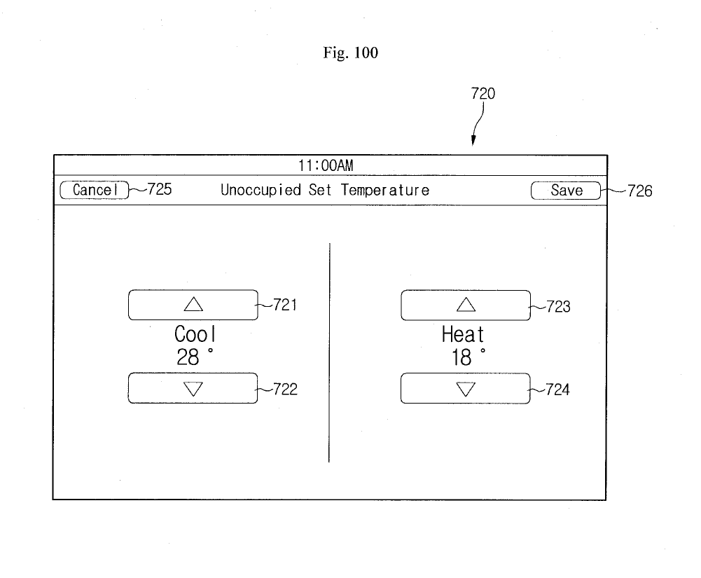

FIG. 100 illustrates a screen displayed when The home leave setting temperature button is selected in FIG. 94. Referring to FIG. 100, when the home leave setting temperature button 676 is selected on the screen 670 of FIG. 94, the controller 4 may display a screen 720 for setting the cooling temperature and the heating temperature when unoccupied is selected on the touch screen display 3.

The screen 720 may include an up button 721 and a down button 722 as set-up buttons for setting the cooling temperature and an up button 723 and a down button 724 as set-up buttons for setting the heating temperature.

In the case where there is no schedule to be referred to when the override function is selected or unoccupied is selected, the controller 4 may control one or more components of the HVAC system so as to satisfy the cooling temperature or the heating temperature set through the screen 720.

The screen 920 may further include a cancel button 725 and a save button 726.

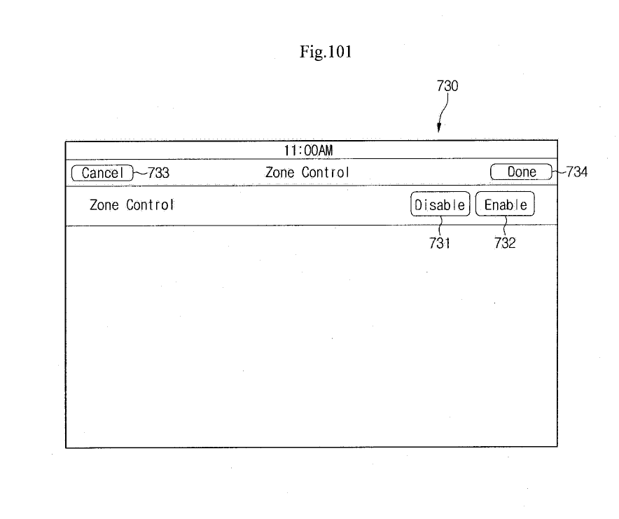

FIG. 101 is a screen displayed when the zone control button is selected on the screen of FIG. 94. Referring to FIG. 101, when the zone control button 677 is selected on the screen 670 of FIG. 94, the controller 4 may display a screen 730 for selecting the zone control function on the touch screen display 3.

The screen 730 may include a disable button 731 and an enable button 732 for turning on or off the zone control function. Further, the screen 730 may further include a cancel button 733 and a done button 734.

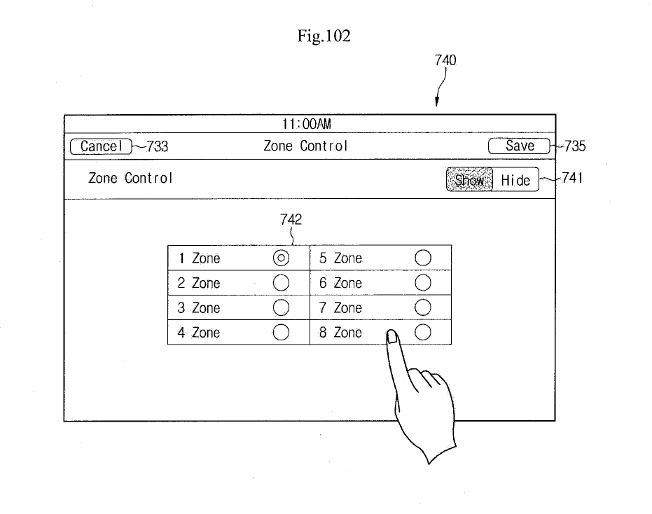

FIG. 102 illustrates a screen displayed when the enable button is selected on the screen of FIG. 101. Referring to FIG. 102, when the enable button 732 is selected on the screen 730 of FIG. 101, the controller 4 may display a screen 740 for selecting individual zones among a plurality of zones on the touch screen display 3.

The screen 740 may include a button 741 for selecting whether the zone control is to be displayed on the home screen 10. The screen 740 may include a zone selection block 742 for selecting a zone for the zone control among the plurality of zones.

The zone selection block 742 may be divided into a plurality of blocks as many as the zones and the user may select the zone by selecting respective divided blocks.

The controller 4 may receive information on a number of zones supported by one or more components of the HVAC system and display the zones as many as the number corresponding to the information on the received number of zones in the zone selection block 742. The zone control function as a function to individually control dampers provided in a plurality of ducts connected to one or more components of the HVAC system may integrally turn on or off dampers corresponding to the selected zones.

The number of the selected zones on the screen 740 may be displayed on the zone button (see reference numeral 43 of FIG. 5) displayed on the home screen 10 of FIG. 4 or 5. For example, when four zones are selected among eight zones, the zone button (see reference numeral 43 of FIG. 5) may be displayed as “ 4/8”.

The screen 740 may further include a cancel button 733 for cancelling setting and a save button 735 for saving setting.

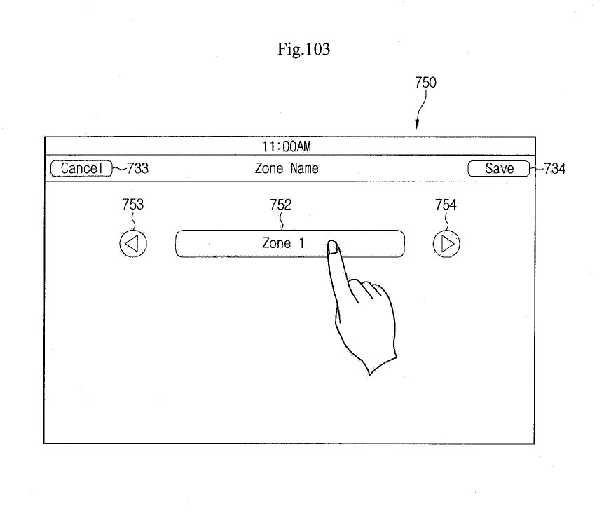

FIG. 103 illustrates a screen displayed when the zone name button is selected on the screen of FIG. 94. Referring to FIG. 103, when the zone name button 677 is selected on the screen 670 of FIG. 94, the controller 4 may display a screen 750 for inputting or changing a zone name on the touch screen display 3.

The screen 750 may include a zone name display 752 and select buttons 753 and 754 for selecting the zone. If the zone name is not changed, the zone names may be set in a form, such as zone 1, and zone, 2, for example. When the user intends to change the zone name, the zone name display 752 may be selected.

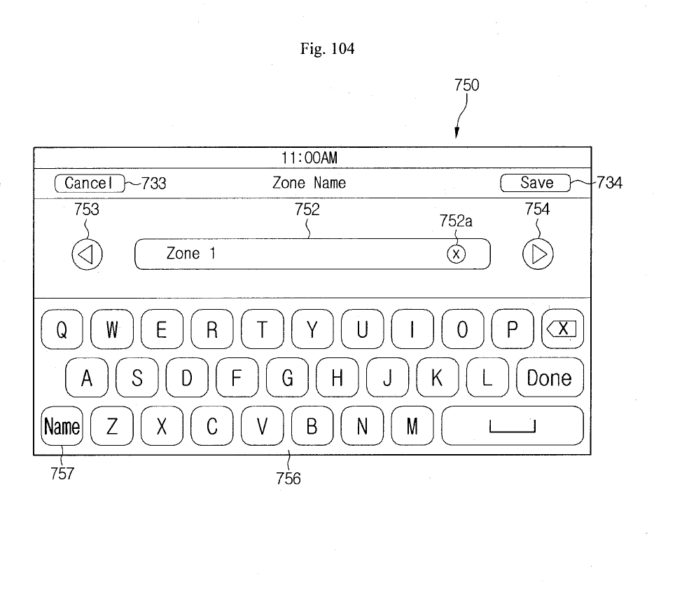

FIG. 104 illustrates a screen displayed when the zone name display is selected on the screen of FIG. 103. Referring to FIG. 104, when the zone name display is selected on the screen of FIG. 103, the screen 750 may display a keypad 753 to input the zone name. Further, the screen 750 may include a zone name display 752 and select buttons 753 and 754 for selecting the zone.

The zone name input through the keypad 753 may be displayed in the zone name display 752, and the zone name display 752 may include a delete button 752a for deleting the displayed zone name. The keypad 756 may include a name button 757 for selecting a name categorized without inputting the zone name.

The screen 750 may further include a cancel button 733 for cancelling setting and a save button 734 for saving setting.

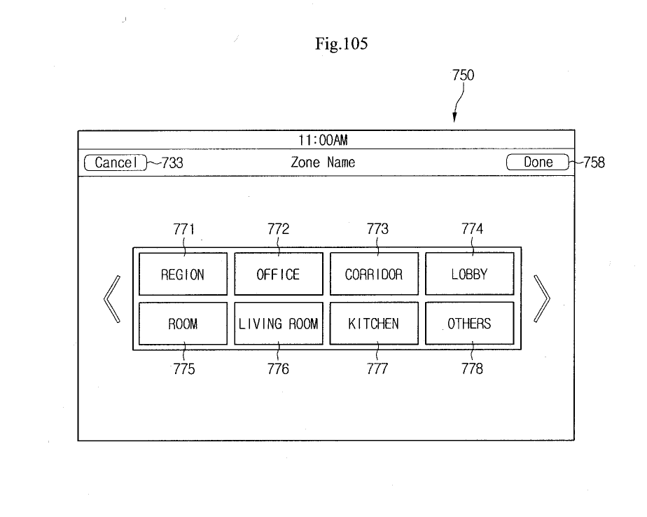

FIG. 105 illustrates a screen displayed when the name button is selected on the screen of FIG. 104. Referring to FIG. 105, when the name button 757 is selected on the screen 750 of FIG. 104, the screen 750 may display the categorized name. The categorized name may include a region 711, an office 772, a corridor 773, a lobby 774, a room 775, a living room 776, a kitchen 777, and others 778; however, embodiments are not limited thereto.

When the user selects any one of the categorized names, the selected name may be displayed in the zone name display 752. In addition, when the user selects the save button 734, changing of the zone name may be done.

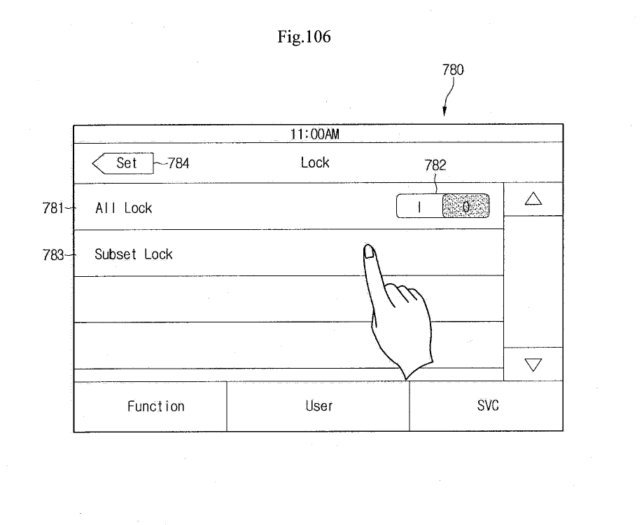

FIG. 106 illustrates a screen displayed when the locking button is selected on the screen of FIG. 95. Referring to FIG. 106, when the locking button 679 is set on the screen 670 of FIG. 95, the controller 4 may display a screen 780 for setting the locking function on the touch screen display 3.

The screen 780 may include an all lock button 781 for locking all functions and a subset lock button 782 for setting locking for each function. Further, the screen 780 may include a set button 784 for returning to the previous screen (for example, the screen of FIG. 95). The all lock button 781 may include a button 782 for selecting whether all functions are locked.

When all lock is selected, the controller 4 may disregard an input command at the time of selecting remaining buttons other than a button to be selected to display the screen 780 of FIG. 106 and display information for notifying the locking state on the home screen 10 of FIG. 4 or 5. That is, the controller 4 may lock a button which needs to be selected in order to display the screen 780 of FIG. 106. Further, the controller 4 may switch the screen 780 for setting the locking function on the home screen 10 of FIG. 4 or 5 when the locked button is selected.

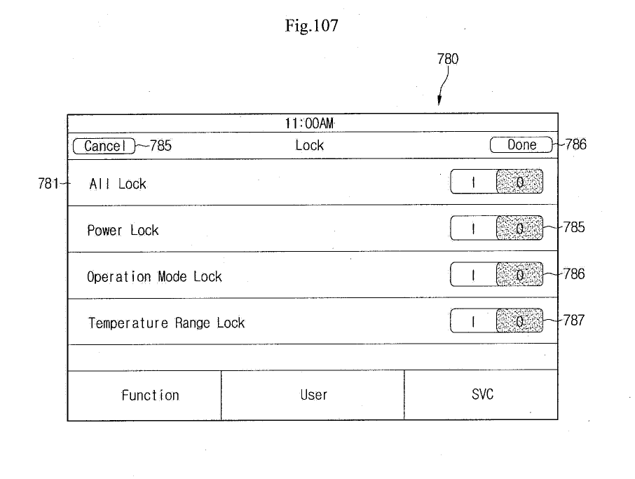

FIG. 107 illustrates a screen displayed when the subset lock button is selected on the screen of FIG. 106. Referring to FIG. 107, when the subset lock button 783 is selected on the screen 780 of FIG. 106, the screen 780 may include a button 785 for locking or unlocking operation on/off, a button 786 for locking or unlocking mode selection, and a button 787 for locking or unlocking a temperature range.

A function described in FIG. 107 may exemplarily enable various functions to be locked or unlocked.

The controller 4 may display an icon, a button, or a region subjected to a locking function with a color different from an icon, a button, or a region not subjected to the locking function on the screen of FIG. 4 or 5, or deactivate, or delete the icon, button, or region from the screen. Further, the controller 4 may display information for notifying the locking state when the button subjected to the locking function is selected on the screen of FIG. 4 or 5.

When the operation on/off function is subjected to the locking, the controller 4 may restrict the operation on/off of one or more components of the HVAC system. When the mode selection is subjected to the locking, the controller 4 may restrict selection of a mode other than present mode of one or components of the HVAC system.

When the temperature range is subjected to the locking, the controller 4 may set the temperature within a limited temperature range. That is, the controller 4 may enable the temperature to be changed by selecting the button when the cooling or heating temperature set on the screen of FIG. 4 or 5 is within the temperature setting range and restrict the change of the temperature in spite of selecting the button when the set cooling or heating temperature is out of the temperature setting range. However, the controller 4 may display information for notifying whether the temperature setting range is limited on the screen of FIG. 4 or 5.

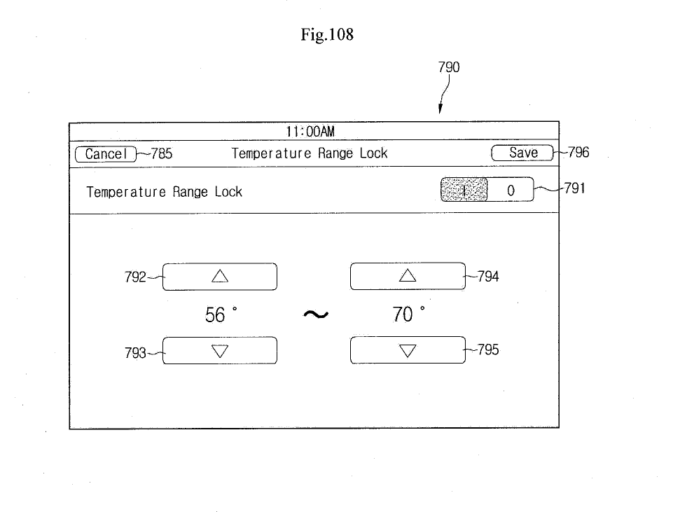

FIG. 108 illustrates a screen displayed when locking a temperature range is selected on the screen of FIG. 107. Referring to FIG. 108, when the locking of the temperature range is selected on the screen 780 of FIG. 107, the controller 4 may display a screen 790 for setting the temperature range on the touch screen display 3.

The screen 790 may include an up button 792 and a down button 793 as set-up buttons for setting a lowest temperature. Further, the screen 790 may include an up button 794 and a down button 795 as set-up buttons for setting a highest temperature.

The controller 4 may enable a target temperature to be set within a range between the lowest temperature and the highest temperature set on the screen 790.

The screen 790 may further include a button 791 to lock or unlock the temperature range, a cancel button 785 to cancel a setting, and a save button 796 to save a setting.

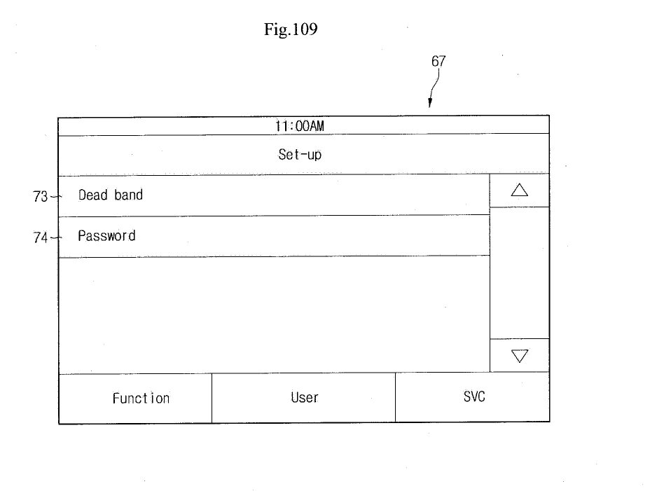

FIG. 109 illustrates a screen displayed when a button is moved by selecting the scroll button or the scroll bar on the screen of FIG. 6. Referring to FIG. 109, when the button is moved by selecting the scroll button or the scroll button on the screen 67, the screen 67 may display a deadband button 73 and a password button 74.

When the deadband button 73 is selected, the controller 4 may set a difference value of a deadband between a target cooling temperature and a target heating temperature in a case where the HVAC controller 1 is in a thermostat mode and the operation mode of one or more components of the HVAC system is automatic. When the password button 74 is selected, the controller 4 may change or set a password.

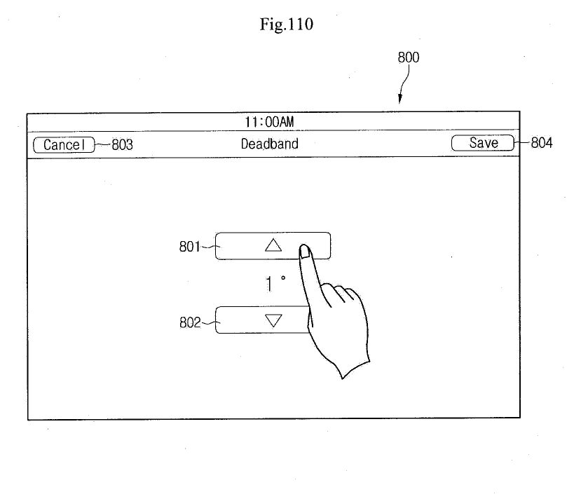

FIG. 110 illustrates a screen displayed when the deadband button is selected on the screen of FIG. 109. Referring to FIG. 110, when the deadband button 73 is set on the screen 67 of FIG. 109, the controller 4 may display a screen 800 for setting the deadband on the touch screen display 3.

The screen 800 may include an up button 801 and a down button 802 as set-up buttons for setting the deadband. Further, the screen 800 may include a cancel button 803 to cancel a setting and a save button 804 to save setting.

A relationship between the temperature change and the deadband in the case where the HVAC controller 1 is in the thermostat mode and the operation mode of one or more components is automatic will be described. In the case where the set deadband is approximately 3° C. and a difference of the target cooling temperature and a set target heating temperature is less than approximately 3° C. when the user selects the up button to increase the target heating temperature, the controller 4 may automatically increase the target cooling temperature without the change of the cooling temperature by the user.

Further, when the user selects the down button to increase the target cooling temperature, in the case where the difference between the target heating temperature and the set target cooling temperature is less than approximately 3° C., the controller 4 may automatically decrease the target heating temperature without the change of the heating temperature by the user.

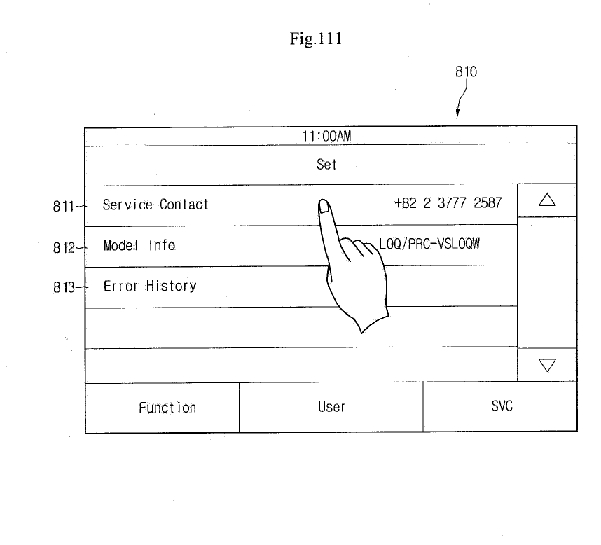

FIG. 111 illustrates a screen displayed when a service button is selected on a screen including the service button. Referring to FIG. 111, when a service button 83 is selected on any one screen of screens including the service button 83, the controller 4 may display a screen 810 to provide service information on the touch screen display 3.

The screen 810 may include a service contact button 811 to provide service center information, a model information button 812 to provide model information of one or more components of the HVAC system, and an error history button 813 to provide a past error history.

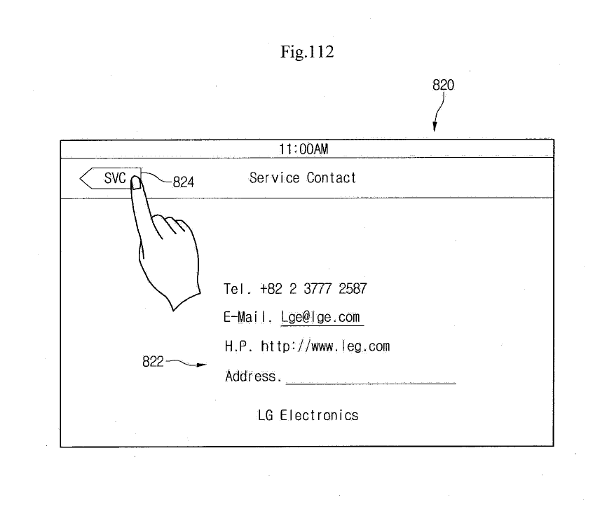

FIG. 112 illustrates a screen displayed when a service contact button is selected on the screen of FIG. 111. Referring to FIG. 112, when the service contact button 811 is selected on the screen 820 of FIG. 111, the controller 4 may display a screen 820 to provide service center information 822 on the touch screen display 3.

The service center information 822 may include a telephone number, an e-mail, a homepage, an address, or a location, a company name, for example. When a plurality of service center is present, one of the plurality of service centers may be selected. Further, the information displayed on the screen 820 may be added or changed by the user. The screen 820 may include a service button 824 to return to the previous screen (the screen of FIG. 110).

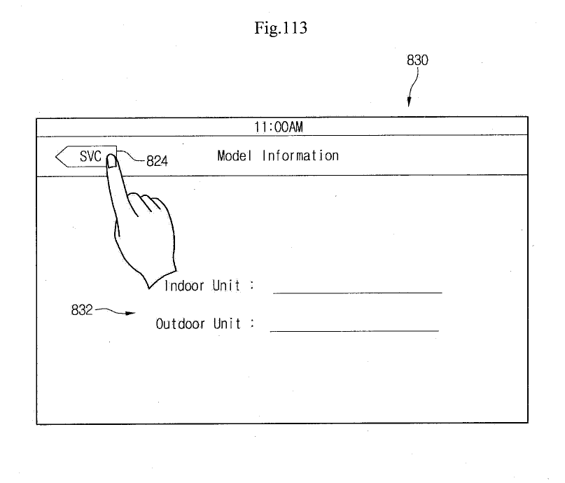

FIG. 113 illustrates a screen displayed when a model information button is selected on the screen of FIG. 111. Referring to FIG. 113, when the service contact button 812 is selected on the screen 820 of FIG. 111, the controller 4 may display a screen 832 to provide model information 830 on the touch screen display 3.

The model information 832 may include information on one or more components of the HVAC system connected with the HVAC controller 1. When the one or more components are the air conditioner, the model information 832 may include information on each of an indoor unit or device and an outdoor unit or device.

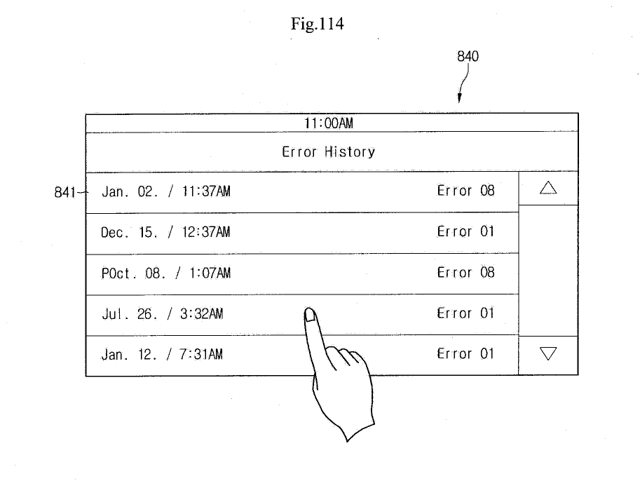

FIG. 114 illustrates a screen displayed when an error history button is selected on the screen of FIG. 111. Referring to FIG. 114, when the error history button 813 is selected on the screen 820 of FIG. 111, the controller 4 may display a screen 841 to provide error history information 841 on the touch screen display 3.

The error history information 841 may include an error occurrence day and an error occurrence time, and an error content (for example, an error code) in one or more components of the HVAC system connected with the HVAC controller 1. In this case, the error history information 841 may include a specific number of error histories which occur during a specific period. The error history information 841 may be arranged in the order of the error content or the error occurrence day.

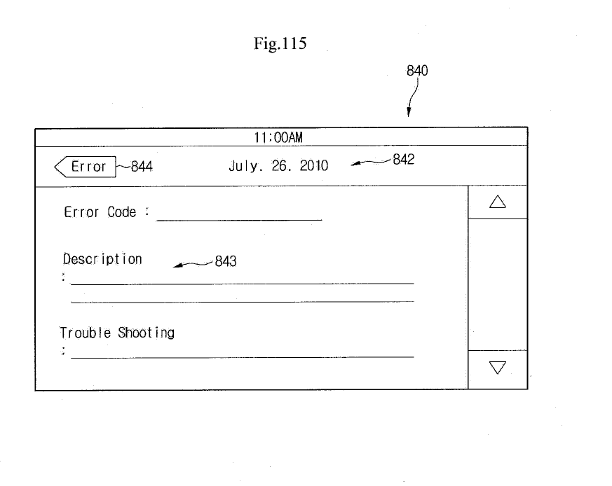

FIG. 115 illustrates a screen displayed when error history information is selected on the screen of FIG. 114. Referring to FIG. 115, when any one information of the plurality of displayed error history information 841 is selected on the screen 840 of FIG. 114, the screen 840 may display error occurrence day information 842 and detailed information 843 of the selected error history information. The detailed information 843 may include an error code, an error information description, and/or an error solving method, for example.

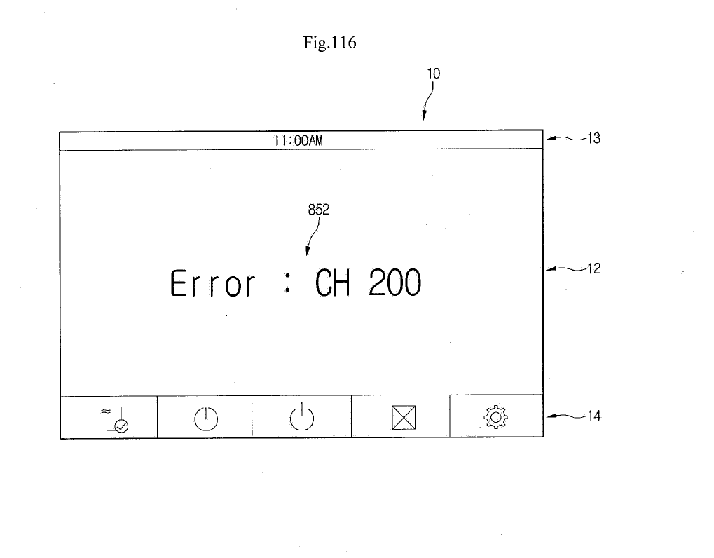

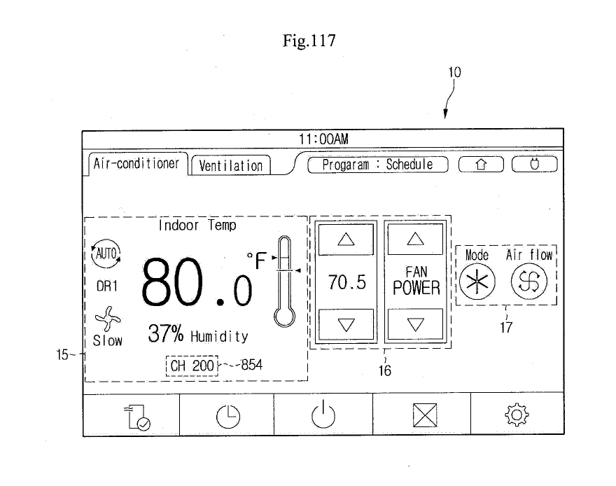

FIGS. 116 and 117 illustrate an example of a screen displayed on a home screen when an error occurs. FIG. 116 illustrates a home screen displayed when one component is connected to the HVAC controller 1, and FIG. 117 illustrates a home screen displayed when a plurality of components is connected to the HVAC controller 1.

First, referring to FIG. 116, while the home screen 10 of FIG. 4 or 5 is displayed on the touch screen display 3, the first region 12 of the home screen 12 may display error information 852 when an error occurs in one or more components of the HVAC system. The error information 852 may automatically disappear within a predetermined time after the error information 852 is displayed or disappear when the user touches the home screen 10.

Next, referring to FIG. 117, when the plurality of components is connected to the HVAC controller 1, although the error occurs in a specific component, remaining components are normal, and as a result, a normal component control needs to be performed. Accordingly, when the error occurs in one or more components of the HVAC system, the controller 4 may display the error information 854 in a monitoring region 15 of the home screen 10.

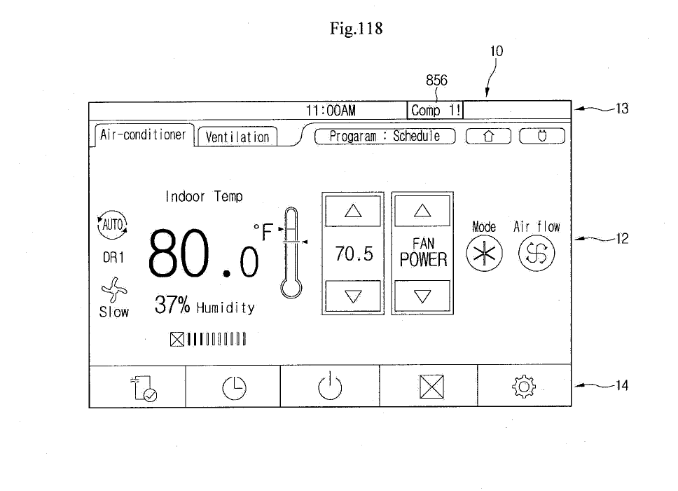

FIG. 118 illustrates an example of a screen displayed on the home screen when a compressor error occurs. Referring to FIG. 118, in the case where the component connected to the HVAC controller 1 includes a plurality of compressors, the home screen 10 may display compressor error information 856 in the second region 13. The compressor error information 856 may include a compressor number, for example.

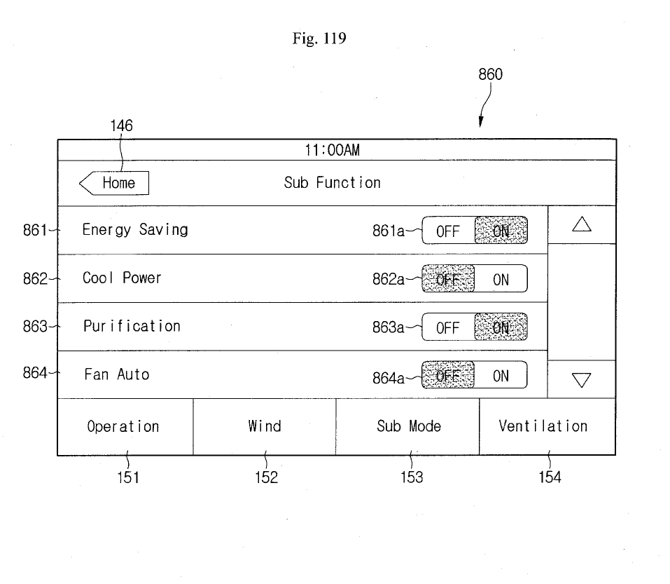

FIGS. 119 to 121 illustrate a screen displayed when a sub mode button is selected on a screen including a sub mode button. Referring to FIG. 119, when a sub mode button 153 is selected on any one screen (as one example, the screen of FIG. 22) among screens including the sub mode button 153, the controller 4 may display a screen 860 to select a sub function on the touch screen display 3.

The screen 860 may include an energy saving button 861 to select energy saving cooling, a cool power button 862 to select power cooling, a purification button 863 to select purification, and a fan auto button 864 to select a fan auto function. The energy saving button 861 may include a button 861a to turn on or off energy saving cooling function, and the cool power button 862 may include 862a to turn on or off the power cooling. The purification button 863 may include a button 863a to turn on or off a purification function, and the fan auto button 864 may include 862a to turn on or off the fan auto function.

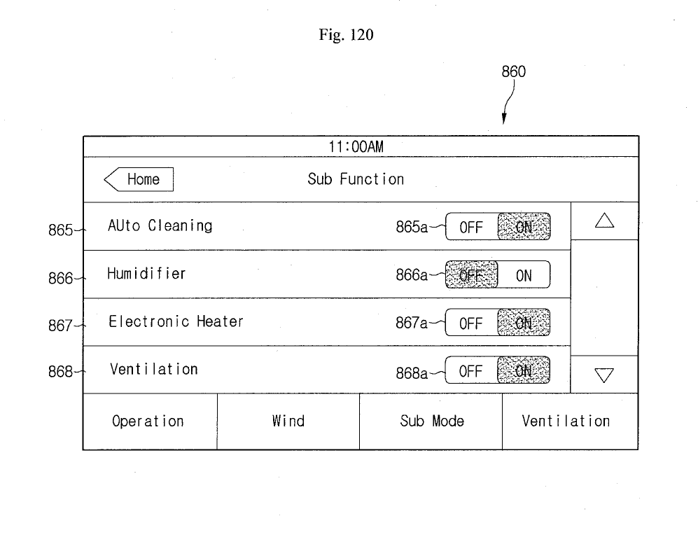

Next, referring to FIG. 120, when the button is moved by selecting the scroll button or the scroll bar on the screen 860 of FIG. 119, the screen 860 may include an automatic drying button 865 to select an automatic drying function of one or more components of the HVAC system, a humidifying button 867 to select a humidifying function of one or more components of the HVAC system, an electric heater button 867 to set turning on/off of a heater provided in one or more components of the HVAC system, and a ventilation button 868 to turn on or off the ventilation device. The automatic drying button 865 may include a button 865a to turn on or off the automatic drying function, and the humidifying button 867 may include a button 866a to turn on or off the humidifying function. The electric heater button 867 may include a button 867a to turn on or off the electric heater, and the ventilation button 868 may include a button 864a to turn on or off the ventilation device.

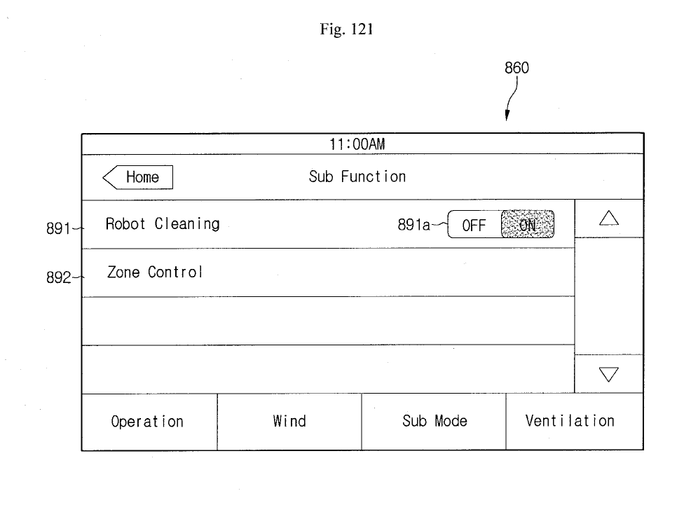

Next, referring to FIG. 121, when the button is moved by selecting the scroll button or the scroll bar on the screen 860 of FIG. 120, the screen 860 may include a robot cleaner button 891 to turn on or off a robot cleaning apparatus provided in one or more components of the HVAC system, and a zone control button 892 to select the zone control function. The robot cleaner button 891 may include a button 891a to turn on or off the robot cleaning apparatus.

When the zone control button 892 is selected, the screen 730 of FIG. 101 or the screen 740 of FIG. 102 may be displayed on the touch screen display 3, although embodiments are not limited thereto.

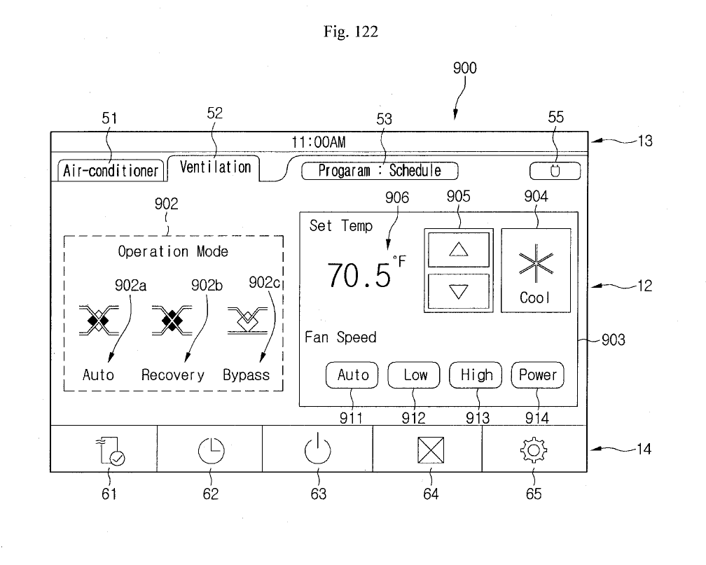

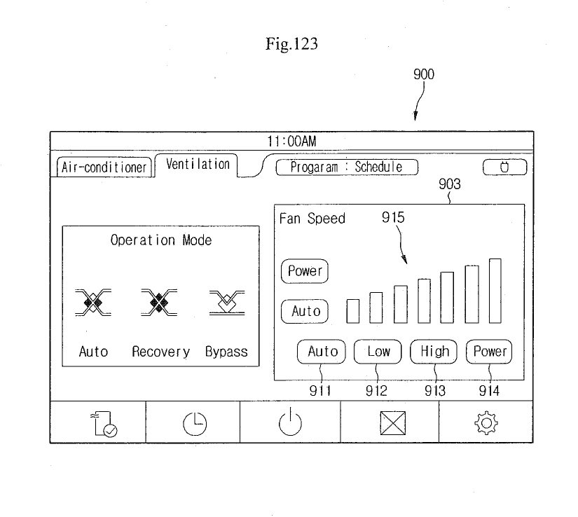

FIGS. 122 and 123 illustrate an example of a home screen which can be displayed in the HVAC controller. FIGS. 122 and 123 illustrate a screen displayed when a ventilation button 52 of a navigation bar 18 is selected.

FIG. 122 may be displayed in the case where the HVAC controller is connected with the ventilation device including a cooling function or connected with the indoor unit or device of the air conditioner including a ventilation function, and FIG. 123 may be displayed in the case where the HVAC controller is connected with the ventilation device without the cooling function. Accordingly, the HVAC controller may acquire type information of the connected ventilation device and a configuration of the screen displayed on the touch screen display may vary depending on a type of the ventilation device.

Referring to FIG. 122, a home screen 900 may include a first region 12, a second region 13, and a third region 14. The home screen 900 and the home screen 10 may be different from each other in information displayed in the first region 12, and not different from each other in information displayed in remaining regions, and as a result, a description of the remaining regions refers to the previous description, and repetitive description has been omitted.

The first region 12 may include a first input region 902 to display and input a ventilation mode, and a second input region 903 to input a temperature or a fan speed. The first input region 902 may display an automatic mode 902a, a recovery mode 902b, and a general or bypass mode 902c as a type of the ventilation mode, and a presently selected ventilation mode may be displayed to be distinguished from an unselected mode. The recovery mode may be a mode that allows air discharged to the outside in the ventilation device and air introduced to the inside to exchange heat with each other and the general or bypass mode is a mode in which the air discharged to the outside and the air introduced into the inside flow without heat exchange.

The second input region 903 may include a temperature set-up block 905 to set the cooling or heating temperature, a temperature 906 set by the temperature set-up block 905, and an air conditioning mode display 904 to display a type of an air conditioning mode. The air conditioning mode display 904 may display heating or cooling. The user may select the heating mode or the cooling mode by selecting the air conditioning mode display 904.

The user may select each of the ventilation mode and the air conditioning mode. For example, when the recovery mode is selected in the ventilation mode and the cooling mode is selected as the air conditioning mode, one or more components of the HVAC system may operate in the cooling mode while operating in the recovery mode. The second input region 903 may include an auto button 911, a low button 912, a high button 913, and a power button 914 as set-up buttons to set fan speed.

Further, the second input region 903 may further include an image 915 to show the set fan speed stepwise. The user may intuitively verify the fan speed by the image 915.

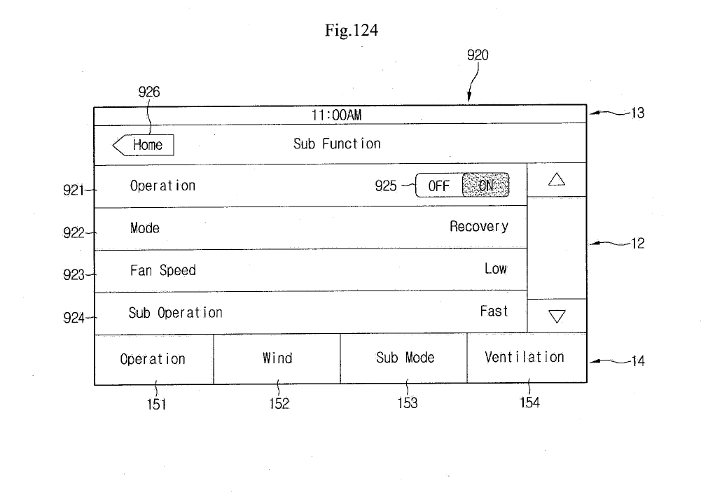

FIG. 124 illustrates a screen displayed when a main button is selected on the home screen in FIG. 122 or 123. Referring to FIG. 124, when a main button 51 is selected on the home screen 900, the controller 4 may display a screen 920 to select a sub function on the touch screen display 3.

The screen 920 may include a first region 12, a second region 13, and a third region 14. The screen 920 may include an operation on/off button 921 to select on/off of one or more components of the HVAC system, a mode button 922 to select the ventilation mode, a fan speed button 923 to select the fan speed, and a sub operation button 924 to select a sub operation. The operation on/off button 921 may include a button 925 to select on/off.

The third region 14 may include an operation button 151, a wind button 152, a sub mode button 153, and a ventilation button 154. The first region 12 may further include a home button 926 to return to a previous screen.

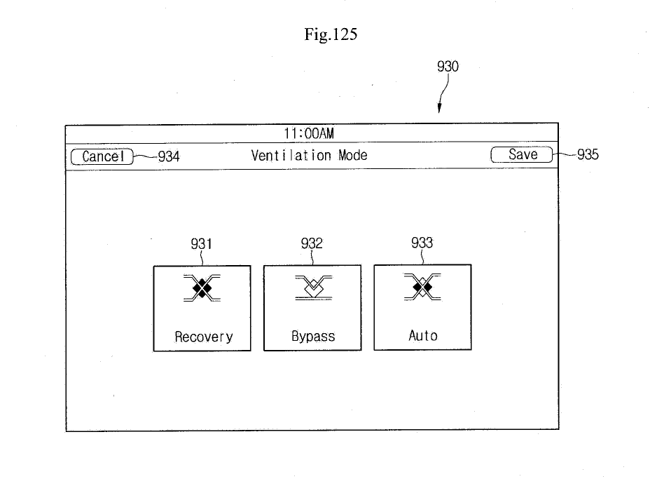

FIG. 125 illustrates a screen displayed when a mode button is selected on the screen of FIG. 124. Referring to FIG. 125, when a mode button 922 is selected on the screen 920 of FIG. 124, the controller 4 may display a screen 930 to select the ventilation mode on the touch screen display 3. The screen 930 may include an auto mode button 931, a recovery mode button 932, and a general mode button 933. Further, the screen 930 may include a cancel button 934 to cancel a setting and a save button 935 to save a setting.

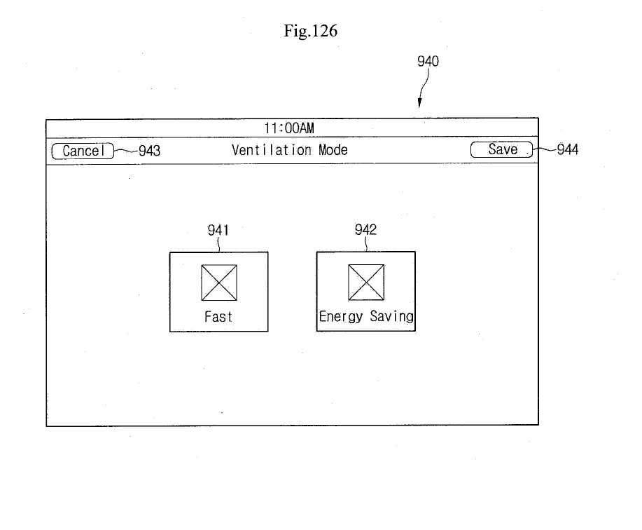

FIG. 126 illustrates a screen displayed when a sub operation button is selected on the screen of FIG. 124. Referring to FIG. 126, when a sub operation button 924 is selected on the screen 920 of FIG. 124, the controller 4 may display a screen 940 to select a sub operation type on the touch screen display 3.

The screen 940 may include a rapid button 941 and an energy saving button 942 to turn on/off the ventilation function. Further, the screen 940 may include a cancel button 943 to cancel a setting and a save button 944 to save a setting.

In the above description, as schedule setting in the ventilation device is the same as schedule setting in the air conditioner, detailed description thereof has been omitted.

According to embodiments disclosed herein, when the touch screen display 3 receives a control parameter of one or more components of the HVAC system among parameter setting values, the HVAC controller 1 may transmit a setting value of the received control parameter to one or more components of the HVAC system.

Further, when the control parameter of one or more components of the HVAC system is changed, the HVAC controller 1 may receive the changed control parameter value from one or more components of the HVAC system to store the changed control parameter value in the memory 5 and reflect the value on the screen of the touch screen display 3.

In one embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The controller may display a first image having one or more parameters for monitoring in a monitoring region on the screen and a second image having one or more parameters for setting in a main input region on the screen. The controller may further display a parameter selected on the touch screen display or delete the parameter by a user's selection on the touch screen display.

In another embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The controller may display a first image having one or more parameters for monitoring in a monitoring region on the screen and a second image having one or more parameters for setting in a main input region on the screen, and a display mode of the touch screen may include a first display mode and a second display mode. The controller may allow a user to select any one of the first display mode or the second display mode, and types or a number of the parameters may vary depending on a selected display mode.

In another further embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The controller may display one or more parameters for setting in a main input region on the screen, and one or more parameters for setting in a sub input region on the screen, and a display mode of the touch screen may include a first display mode and a second display mode. The controller may allow a user to select one of the first display mode or the second display mode, and change the parameters displayed in the main input region or the parameters displayed in the sub input region depending on a selected display mode.

In another still further embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The controller may display a first image having one or more parameters for monitoring in a monitoring region on the screen, and a second image having one or more parameters for setting in a main input region on the screen. The controller may display a device button for selecting types of components on the screen when the HVAC system includes a plurality of components.

In another further embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The screen may include a first region that displays a parameter for monitoring or a parameter for setting, a second region located at one side of the first region, and a third region located at another side of the first region. The controller may remove the third region and extend the first region during setting the parameter.

In another further embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The screen may include a first region that displays a parameter for monitoring or a parameter for setting, a second region located at one side of the first region, and a third region located at another side of the first region. The controller may display a plurality of buttons in the third region, present time information in the second region, and displays a parameter selected by a user.

In another further embodiment, a heating, ventilation, or air conditioning (HVAC) controller for controlling one or more components of a HVAC system or monitoring a state thereof may include a touch screen display in which a parameter setting command may be input by a user's touch, and a controller connected with the touch screen display to display a screen on the touch screen display. The screen may include a first region that displays an image including a parameter, a second region located at one side of the first region, and a third region located at another side of the first region. A display mode of the touch screen may include a first display mode and a second display mode, and the controller may allow a user to select one of the first display mode or the second display mode and change an image displayed in the first region depending on a selected display mode.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the controller displays a first image having one or more parameters to be monitored in a monitoring region on the screen and displays a second image having one or more parameters to be set in a main input region on the screen, and wherein the controller displays a parameter selected on the touch screen display or deletes the parameter in response to a user's selection on the touch screen.

2. The HVAC controller of claim 1, wherein the one or more parameters displayed in the first image includes main information and sub information, and wherein the sub information is deleted from or added to the first image.

3. The HVAC controller of claim 2, wherein the main information includes at least one of a mode of one or more components of the HVAC system, temperature information, or energy usage information.

4. The HVAC controller of claim 3, wherein the controller compares a target energy usage amount stored in a memory and actual energy usage amounts of one or more components of the HVAC system, and displays the energy usage information in the monitoring region as a comparison result.

5. The HVAC controller of claim 3, wherein the sub information includes at least one of humidity, a fan speed, or energy saving operation information.

6. The HVAC controller of claim 3, wherein the temperature information includes an indoor temperature, and an image for comparison of a target temperature and a present temperature.

7. The HVAC controller of claim 6, wherein the image for the comparison includes at least one of a first mark that displays a cooling temperature or a second mark that displays a heating temperature, and wherein the first mark and the second mark are different in form, size, or color.

8. The HVAC controller of claim 7, wherein the image for the comparison displays any one of the first mark, the second mark, or both marks.

9. The HVAC controller of claim 2, wherein the first image displays event information when a specific event occurs.

10. The HVAC controller of claim 1, wherein the second image includes an up button and a down button to set the one or more parameters, and wherein the controller changes at least one of the one or more parameters displayed in the first image when any one of the up button or the down button is selected.

11. The HVAC controller of claim 1, wherein a display mode of the touch screen includes a first display mode and a second display mode, and wherein the controller controls the touch screen display such that the second image in the first display mode and the second image in the second display mode are different from each other.

12. The HVAC controller of claim 11, wherein in the first display mode, the second image includes a temperature set-up block to set a cooling or heating temperature and a fan speed set-up block to control a fan speed, and wherein in the second display mode, the second image includes a cooling temperature set-up block to set the cooling temperature, a heating temperature set-up block to set the heating temperature, and a fan speed control block to control the fan speed.

13. The HVAC controller of claim 12, wherein each set-up block includes an up button and a down button.

14. The HVAC controller of claim 11, wherein the controller further displays a third image to set one or more parameters of one or more components of the HVAC system in a sub input region on the screen.

15. The HVAC controller of claim 14, wherein the third image includes a mode button or a wind direction button to select a cooling mode or a heating mode in the first display mode.

16. The HVAC controller of claim 15, wherein when any one button of the mode button or the wind direction button is selected, the controller displays a screen including a plurality of buttons to set parameters on the touch screen display, and controls an array method when the plurality of buttons is odd and an array method when the plurality of buttons is even to be different from each other.

17. The HVAC controller of claim 16, wherein the controller vertically locates a plurality of option buttons in a plurality of rows when a plurality of buttons to be displayed is even, but locates an even number of buttons in each row.

18. The HVAC controller of claim 17, wherein the controller provides a plurality of even rows.

19. The HVAC controller of claim 16, wherein the controller vertically locates a plurality of option buttons in a plurality of rows when a plurality of buttons to be displayed is odd, but places an odd number of buttons in each row.

20. The HVAC controller of claim 19, wherein the controller provides a plurality of odd rows.

21. The HVAC controller of claim 14, wherein in the second display mode, the third image includes a zone button including a number of zones which are zone-controlled.

22. The HVAC controller of claim 1, wherein the screen includes a first region having the monitoring region and the main input region, a second region located at a first side of the first region, and a third region located at a second side of the first region.

23. The HVAC controller of claim 22, wherein at least a present time or state information of one or more components of the HVAC system are displayed in the second region.

24. The HVAC controller of claim 23, wherein the state information includes error information.

25. The HVAC controller of claim 22, wherein the controller controls the touch screen display such that the third region disappears on the screen and the second region is extended.

26. The HVAC controller of claim 22, wherein the controller determines a number of or types of one or more components of the HVAC system, and controls an image displayed on the screen according to the determination.

27. The HVAC controller of claim 26, wherein when the HVAC system includes two or more components, the controller displays a device selection button on the screen.

28. The HVAC controller of claim 22, wherein the controller displays a navigation bar having one or more buttons to select a menu in the first region.

29. The HVAC controller of claim 22, wherein the controller displays a plurality of set-up buttons in the third region.

30. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the controller displays a first image having one or more parameters to be monitored in a monitoring region on the screen, and a second image having one or more parameters to be set in a main input region on the screen, wherein a display mode of the touch screen includes a first display mode and a second display mode, wherein the controller allows a user to select any one of the first display mode or the second display mode, and wherein types or number of the parameters vary depending on a selected display mode.

31. The HVAC controller of claim 30, wherein when the first display mode is selected, a set-up block to set one type of temperature parameter is displayed in the second image, and when the second display mode is selected, a set-up block to set two or more types of temperature parameters is displayed in the second image.

32. The HVAC controller of claim 30, wherein the second image displays a button to set a cooling temperature and a button to set a heating temperature in the first and second display modes, wherein only one of the button to set the cooling temperature or the button to set the heating temperature is activated in the first display mode, and wherein all of the respective buttons are activated in the second display mode.

33. The HVAC controller of claim 32, wherein the first image includes mode information to notify a user that any one mode of the first display mode or the second display mode is selected.

34. The HVAC controller of claim 30, wherein in the first display mode, the controller further displays a third image having a mode button to select a cooling mode or a heating mode on the screen.

35. The HVAC controller of claim 30, wherein types and a number of the parameters displayed in the first image vary depending on the first display mode and the second display mode.

36. The HVAC controller of claim 30, wherein the first image includes temperature information, and wherein the temperature information includes a present temperature and a target heating temperature or a target cooling temperature in the first display mode, and the temperature information includes the present temperature and the target heating temperature or the target cooling temperature in the second display mode.

37. The HVAC controller of claim 36, wherein the controller displays a fan speed set-up block in the second image regardless of the display mode.

38. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the controller displays one or more parameters to be set in a main input region on the screen, and one or more parameters to be set in a sub input region on the screen, wherein a display mode of the touch screen includes a first display mode and a second display mode, and wherein the controller allows a user to select one of the first display mode or the second display mode, and changes the parameters displayed in the main input region or the parameters displayed in the sub input region depending on the selected display mode.

39. The HVAC controller of claim 38, wherein the main input region displays a fan speed set-up button regardless of the display mode.

40. The HVAC controller of claim 38, wherein in the first display mode, the main input region displays a set-up block to set one type of temperature parameter, and in the second display mode, the main input region displays a set-up block to set two or more types of temperature parameters.

41. The HVAC controller of claim 38, wherein in the first display mode, the sub input region displays a mode button to set modes of one or more components of the HVAC system, and when the second display mode is selected, the sub input region deletes or deactivates the mode button.

42. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the controller displays a first image having one or more parameters to be monitored in a monitoring region on the screen, displays a second image having one or more parameters to be set in a main input region on the screen, and displays a device button to select types of components on the screen when the HVAC system includes a plurality of components.

43. The HVAC controller of claim 42, wherein the screen includes a first region having the monitoring region and the main input region, a second region located at a first side of the first region, and a third region located at a second side of the first region, and wherein the controller changes an image of the first region depending on a type of a component selected by the device button.

44. The HVAC controller of claim 43, wherein the controller displays a plurality of set-up buttons in the third region.

45. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the screen includes a first region that displays a parameter to be monitored or a parameter to be set, a second region located at a first side of the first region, and a third region located at a second side of the first region, and wherein the controller removes the third region and extends the first region during setting of the parameter.

46. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the screen includes a first region that displays a parameter to be monitored or a parameter to be set, a second region located at a first side of the first region, and a third region located at a second side of the first region, and wherein the controller displays a plurality of buttons in the third region, present time information in the second region, and a parameter selected by a user in the first region.

47. A heating, ventilation, or air conditioning (HVAC) controller for controlling one or more components of a HVAC system or monitoring a state thereof, the HVAC controller comprising:
a touch screen display configured to receive a parameter setting command input by a user's touch; and
a controller connected with the touch screen display to display a screen on the touch screen display, wherein the screen includes a first region that displays an image including a parameter, a second region located at a first side of the first region, and a third region located at a second side of the first region, wherein a display mode of the touch screen includes a first display mode and a second display mode, and wherein the controller allows a user to select one of the first display mode or the second display mode and changes an image displayed in the first region depending on a selected display mode.
